(19) United States
(12) Patent Application Publication
(10) Pub. No.: US 2022/0326816 A1
(43) Pub. Date: Oct. 13, 2022

(54) Systems, Methods, and User Interfaces for Interacting with Multiple Application Views

(71) Applicant: Apple Inc., Cupertino, CA (US)

(72) Inventors: Brandon M. Walkin, San Francisco, CA (US); Bryant A. Jow, San Mateo, CA (US); Shubham Kedia, San Francisco, CA (US); Stephen O. Lemay, Palo Alto, CA (US)

(21) Appl. No.: 17/714,950

(22) Filed: Apr. 6, 2022

Related U.S. Application Data
(60) Provisional application No. 63/172,543, filed on Apr. 8, 2021.

(51) Int. Cl. G06F 3/0482; G06F 3/04817; G06F 3/04812

(52) U.S. Cl. CPC G06F 3/0482; G06F 3/04817; G06F 3/04812; G06F 2203/04803

(57) ABSTRACT

An example method includes: concurrently displaying: a first view of a first application in a first display mode; and a display mode affordance; while displaying the first view of the first application, receiving a sequence of one or more inputs including a first input selecting the display mode affordance; and in response to detecting the sequence of one or more inputs: ceasing to display at least a portion of the first view of the first application while maintaining display of a representation of the first application; displaying at least a portion of a home screen that includes multiple application affordances, receiving a second input selecting an application affordance associated with a second application; and in response to receiving the second input, concurrently displaying, via the display generation component: a second view of the first application and a first view of the second application.

### RELATED APPLICATIONS

This application claims priority to U.S. Provisional Patent Application Ser. No. 63/172,543, filed on Apr. 8, 2021, entitled “Systems, Methods, and User Interfaces For Interacting With Multiple Application Views,” which is incorporated by reference herein in its entirety.

### TECHNICAL FIELD

The embodiments herein generally relate to electronic devices with touch-sensitive displays and, more specifically, to systems and methods for multitasking on an electronic device with a touch-sensitive display (e.g., a portable multifunction device with a touch-sensitive display).

### BACKGROUND

Handheld electronic devices with touch-sensitive displays are ubiquitous. While these devices were originally designed for information consumption (e.g., web-browsing) and communication (e.g., email), they are rapidly replacing desktop and laptop computers as users' primary computing devices. When using desktop or laptop computers, these users are able to routinely multitask by accessing and using different running applications (e.g., cutting-and-pasting text from a document into an email). While there has been tremendous growth in the scope of new features and applications for handheld electronic devices, the ability to multitask and swap between applications on handheld electronic devices requires entirely different input mechanisms than those of desktop or laptop computers.

Moreover, the need for multitasking is particularly acute on handheld electronic devices, as they have smaller screens than traditional desktop and laptop computers. Some conventional handheld electronic devices attempt to address this need by recreating the desktop computer interface on the handheld electronic device. These attempted solutions, however, fail to take into account: (i) the significant differences in screen size between desktop computers and handled electronic devices, and (ii) the significant differences between keyboard and mouse interaction of desktop computers and those of touch and gesture inputs of handled electronic devices with touch-sensitive displays. Other attempted solutions require complex input sequences and menu hierarchies that are even less user-friendly than those provided on desktop or laptop computers. As such, it is desirable to provide an intuitive and easy-to-use systems and methods for simultaneously accessing multiple functions or applications on handheld electronic devices.

### SUMMARY

The embodiments described herein address the need for systems, methods, and graphical user interfaces that provide intuitive and seamless interactions for multitasking on a handheld electronic device. Such methods and systems optionally complement or replace conventional touch inputs or gestures.

(A1) In accordance with some embodiments, a method for displaying multiple views of one or more applications is performed at an electronic device including a display generation component (e.g., a display, a projector, a heads-up display, etc.) and one or more input devices (e.g., the input devices may include a touch-sensitive surface that is coupled to a separate display, or a touch-screen display that serves both as the display and the touch-sensitive surface). The method includes concurrently displaying, via the display generation component: a first view of a first application in a first display mode; and a display mode affordance; while displaying the first view of the first application, receiving a sequence of one or more inputs including a first input selecting the display mode affordance; and in response to detecting the sequence of one or more inputs: ceasing to display at least a portion of the first view of the first application while maintaining display of a representation of the first application; and displaying, via the display generation component, at least a portion of a home screen that includes multiple application affordances, while continuing to display the representation of the first application and after displaying the portion of the home screen (e.g., while continuing to display both the representation of the first application and the portion of the home screen), receiving a second input selecting an application affordance associated with a second application; and in response to receiving the second input, concurrently displaying, via the display generation component: a second view of the first application and a first view of the second application.

(B1) In accordance with some embodiments, a method is performed at an electronic device including a display generation component (e.g., a display, a projector, a heads-up display, etc.) and one or more input devices (e.g., a camera, a remote controller, a pointing device, a touch-sensitive surface that is coupled to a separate display, or a touch-screen display that serves both as the display and the touch-sensitive surface). The method includes: concurrently displaying, via the display generation component, a first view of a first application, and a second view of a second application, where the second view is overlaid over a portion of the first view, wherein the first view of the first application and the second view of the second application are displayed in a display region that has a first edge and a second edge; while displaying the first view of the first application and the second view of the second application, detecting an input that includes movement in a respective direction; in response to detecting the input: in accordance with a determination that the movement is in a first direction: displaying movement of the second view out of the display region in the first direction toward the first edge; and after the second view of the second application ceases to be displayed, displaying at the first edge of the display region an edge affordance that represents the second view of the second application for at least a first threshold amount of time; and in accordance with a determination that the movement is in a second direction different from the first direction: displaying movement of the second view out of the display region in the second direction toward the second edge; and after a second threshold amount of time, that is shorter than the first threshold amount of time, has passed since the second view of the second application ceased to be displayed, displaying the second edge of the display region without displaying an edge affordance that represents the second view of the second application.

(C1) In accordance with some embodiments, a method is performed at an electronic device including a display generation component (e.g., a display, a projector, a heads-up display, etc.) and one or more input devices (e.g., a keyboard, a remote controller, a camera, a touch-sensitive surface that is coupled to a separate display, or a touch-screen display that serves both as the display and the touch-sensitive surface). The method includes displaying, via the display generation component, an application-selection user interface that includes representations of a plurality of recently used applications, including concurrently displaying, in the application-selection user interface: at a first location, a first set of one or more representations of applications that were last used in a first display mode on the electronic device; and at a second location, a second set of one or more representations of applications that were last used in a second display mode on the electronic device that is different from the first display mode; and while displaying the application-selection user interface, detecting a first input; in response to detecting the first input, moving a representation of a respective view of a first application in the application-selection user interface that was last used in the first view display mode; after moving the representation of the respective view in the application-selection user interface, detecting a second input corresponding to a request to switch from displaying the application-selection user interface to displaying the respective view without displaying the application-selection user interface; and in response to detecting the second input, in accordance with a determination that the first input included movement to the second location in the application-selection user interface that is associated with the second display mode, displaying the first application in the second display mode.

(D1) In accordance with some embodiments, a method is performed at an electronic device including a display generation component (e.g., a display, a projector, a heads-up display, etc.) and one or more input devices (e.g., a camera, a remote controller, a pointing device, a camera, a touch-sensitive surface that is coupled to a separate display, or a touch-screen display that serves both as the display and the touch-sensitive surface). The method includes: while displaying a first user interface, detecting an input corresponding to a request to display a view of a first application, wherein the first user interface does not include a view of the first application; in response to detecting the input corresponding to the request to display the view of the first application, ceasing to display the first user interface and displaying a first view of the first application, including: in accordance with a determination that there are one or more other views of the first application with a saved state, displaying representations of the one or more other views of the first application with the saved state concurrently with the first view of the first application, wherein the representations of the one or more other views of the first application are overlaid on the view of the first application; and in accordance with a determination that there are no other views of the first application with a saved state, displaying the first view of the first application without displaying representations of any other views of the first application.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments section below, in conjunction with the following drawings in which like reference numerals refer to corresponding parts throughout the drawings.

FIG. 1A is a high-level block diagram of a computing device with a touch-sensitive display, in accordance with some embodiments.

FIG. 1B is a block diagram of example components for event handling, in accordance with some embodiments.

FIG. 1C is a schematic of a portable multifunction device having a touch-sensitive display, in accordance with some embodiments.

FIG. 1D is a schematic used to illustrate a computing device with a touch-sensitive surface that is separate from the display, in accordance with some embodiments.

FIG. 2 is a schematic of a touch-sensitive display used to illustrate a user interface for a menu of applications, in accordance with some embodiments.

FIGS. 3A-3C illustrate examples of dynamic intensity thresholds in accordance with some embodiments.

FIGS. 4A1-4A27, 4B1-4B22, 4C1-4C14, 4D1-4D11, and 4E1-4E12 are schematics of a touch-sensitive display used to illustrate user interfaces for simultaneously interacting with multiple application views, in accordance with some embodiments.

FIGS. 5A-5F are a flowchart representation of a method of interacting with multiple display mode affordances, in accordance with some embodiments.

FIGS. 6A-6D are a flowchart representation of a method of providing an edge affordance, in accordance with some embodiments.

FIGS. 7A-7F are a flowchart representation of a method of interacting with a display mode switcher user interface, in accordance with some embodiments.

FIGS. 8A-8F are a flowchart representation of a method of interacting with a view-selector shelf user interface, in accordance with some embodiments.

### DESCRIPTION OF EMBODIMENTS

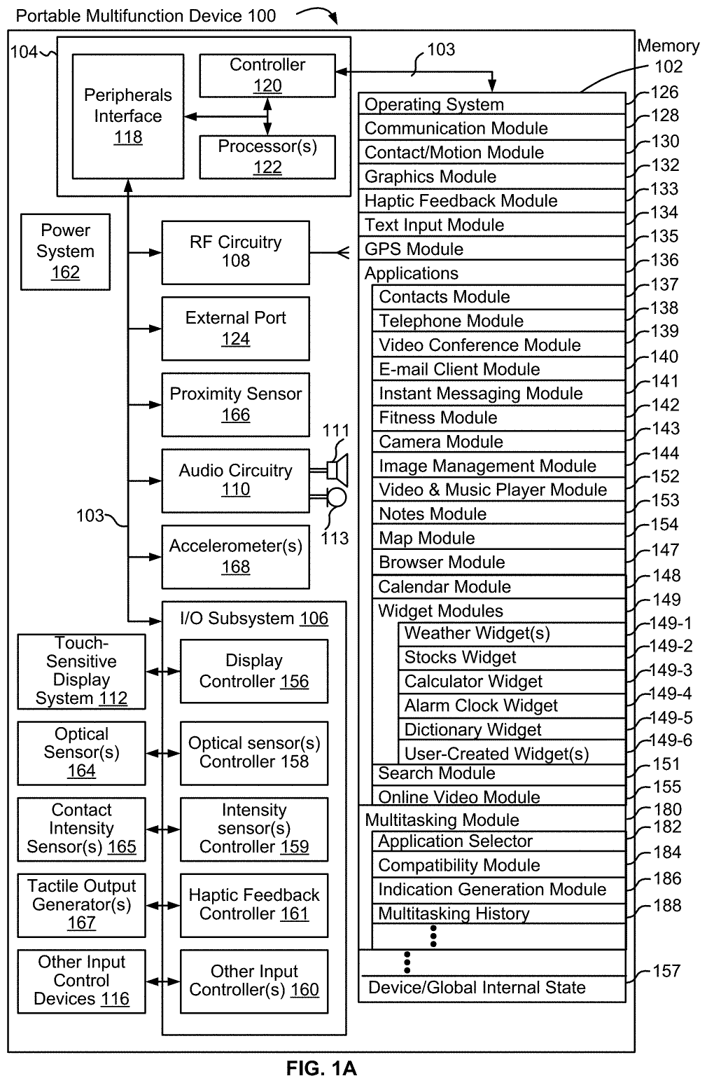

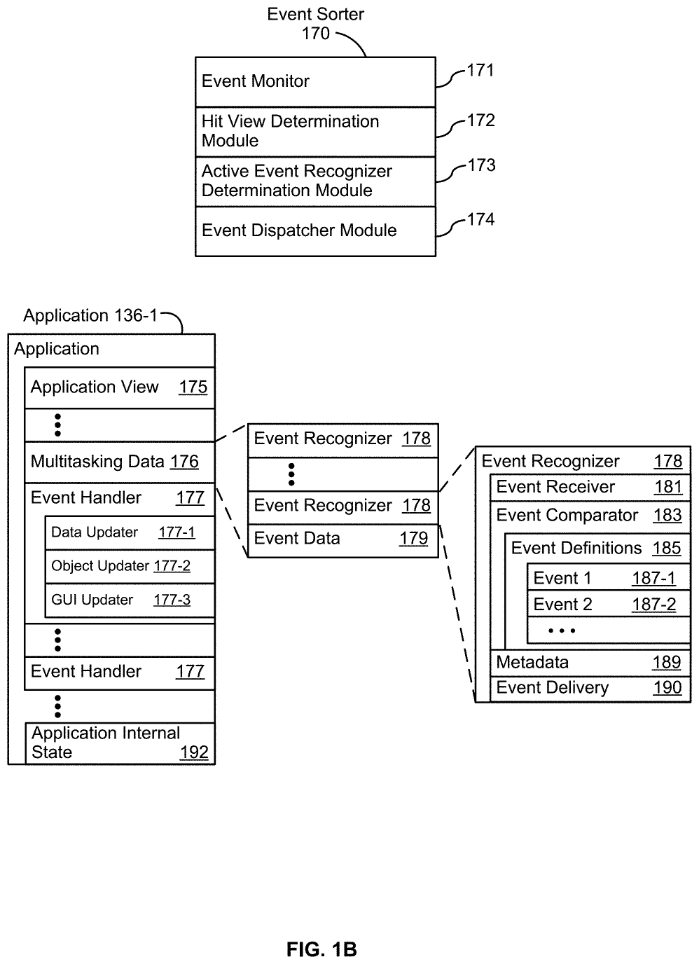

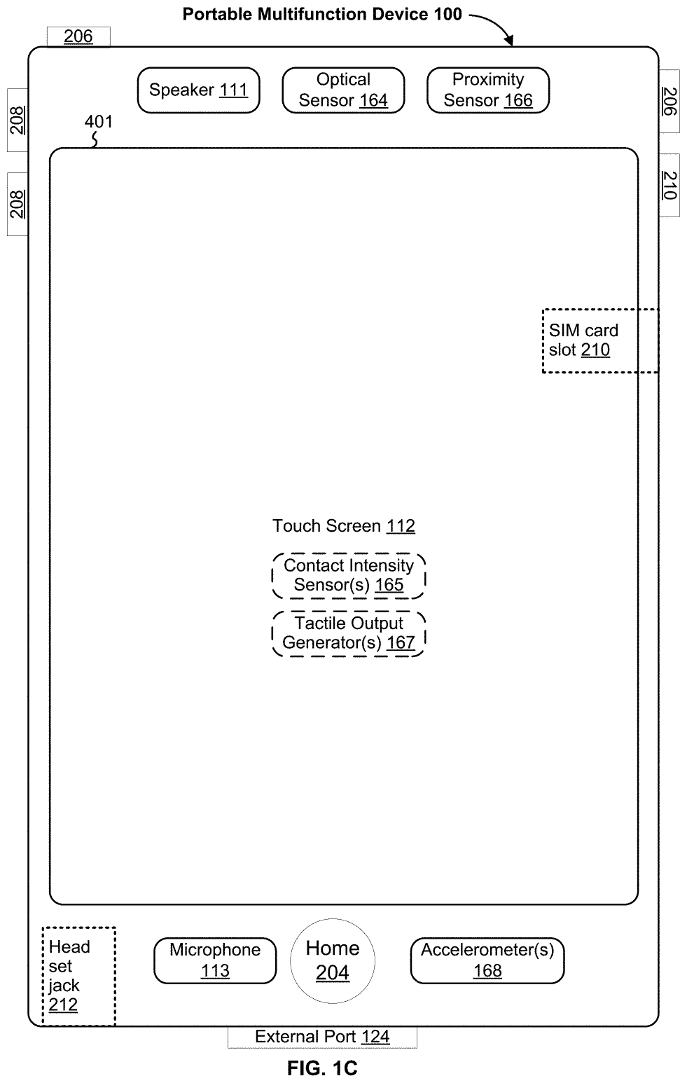

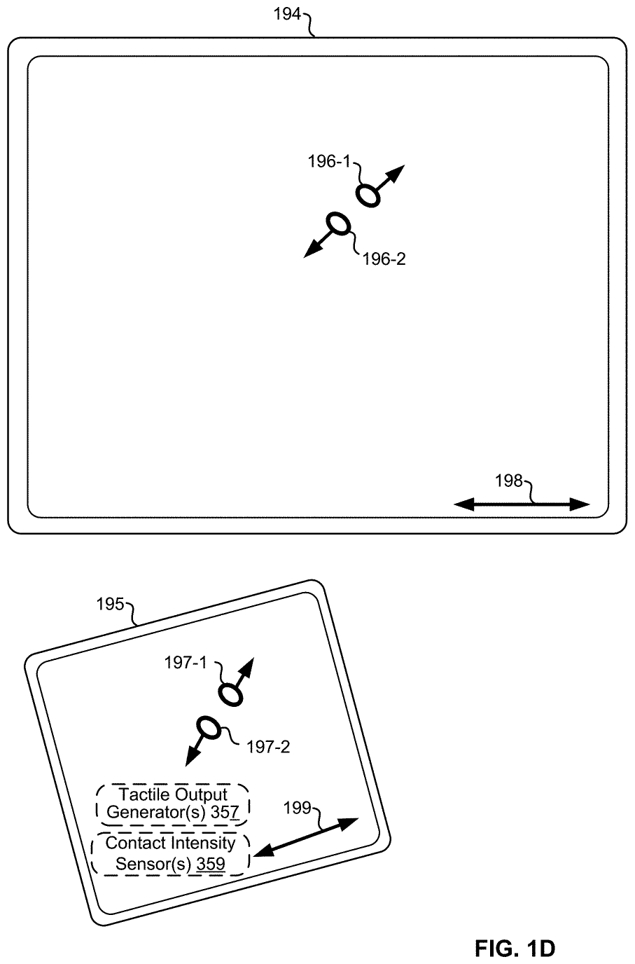

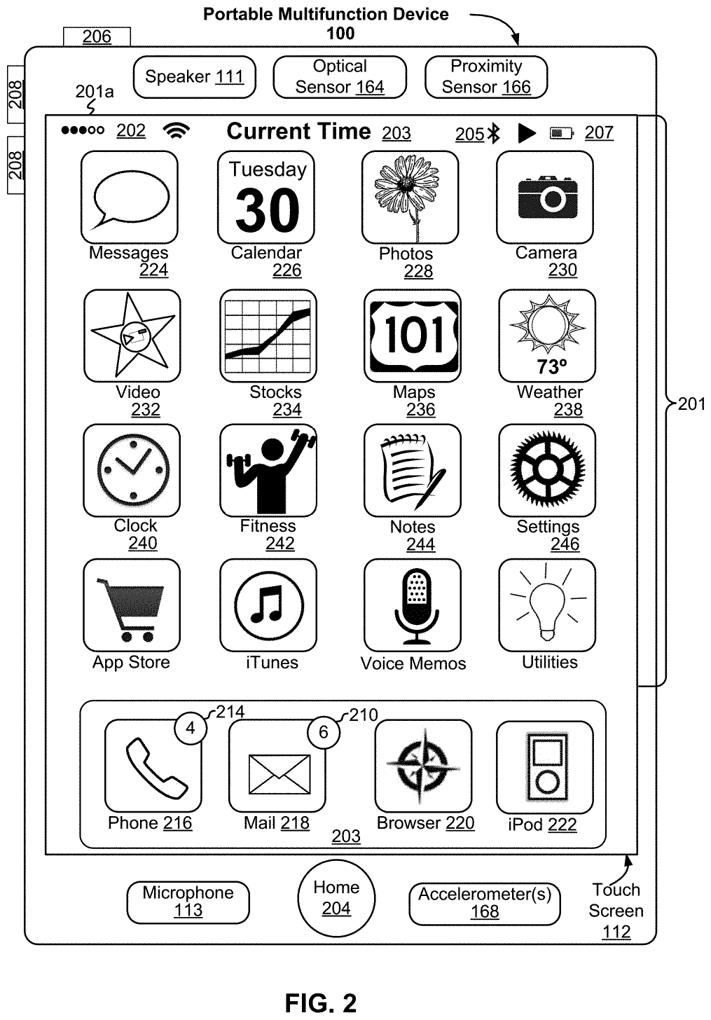

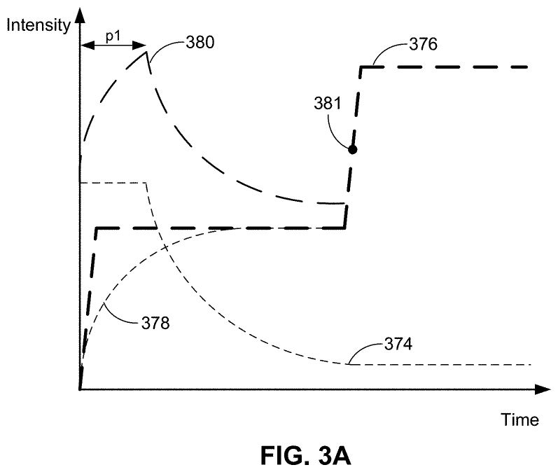

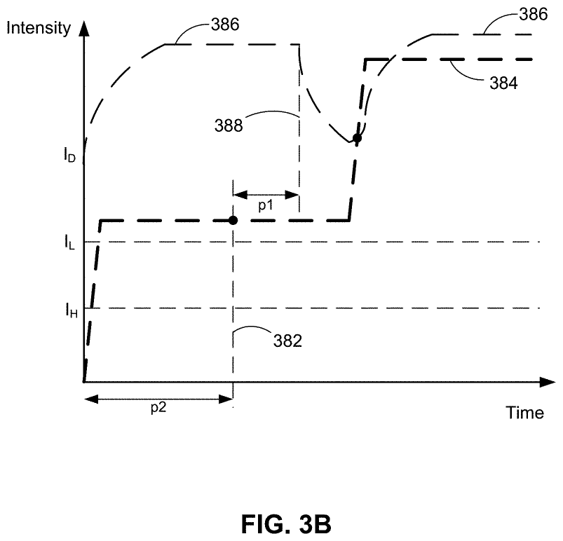

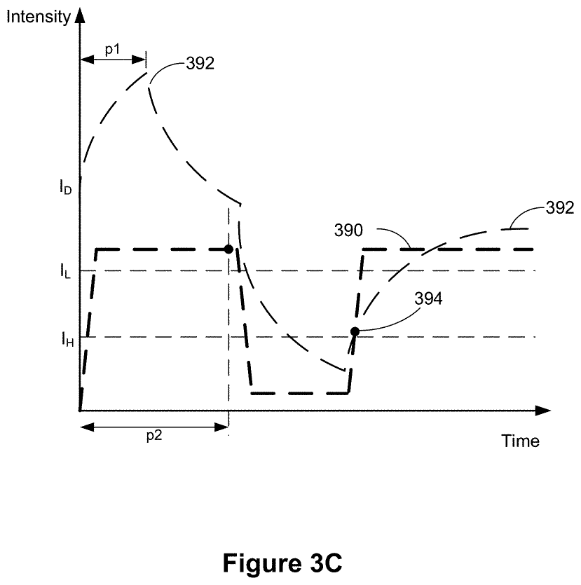

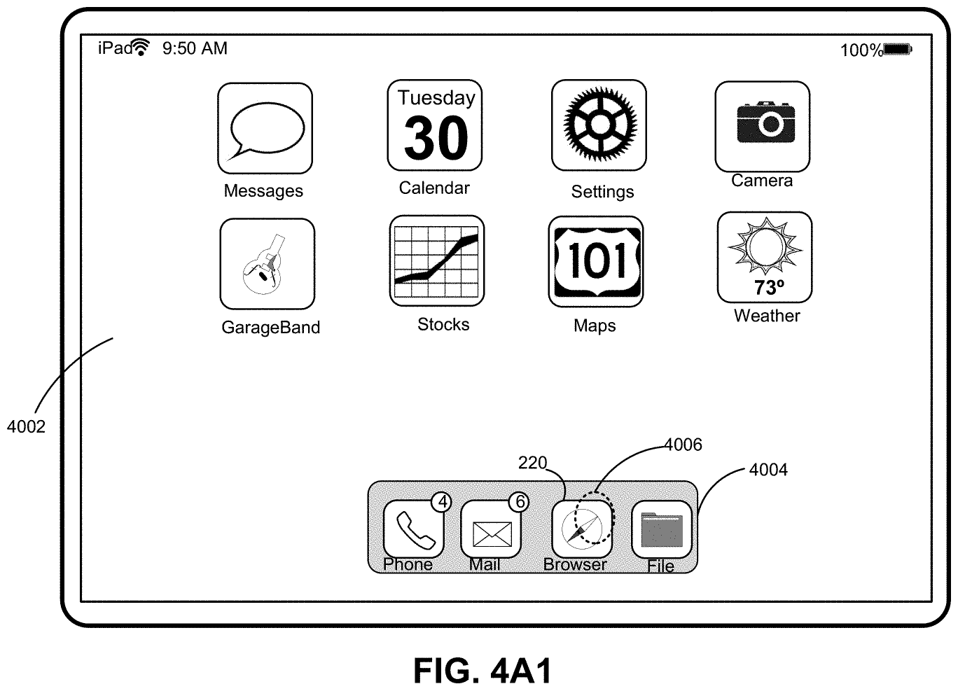

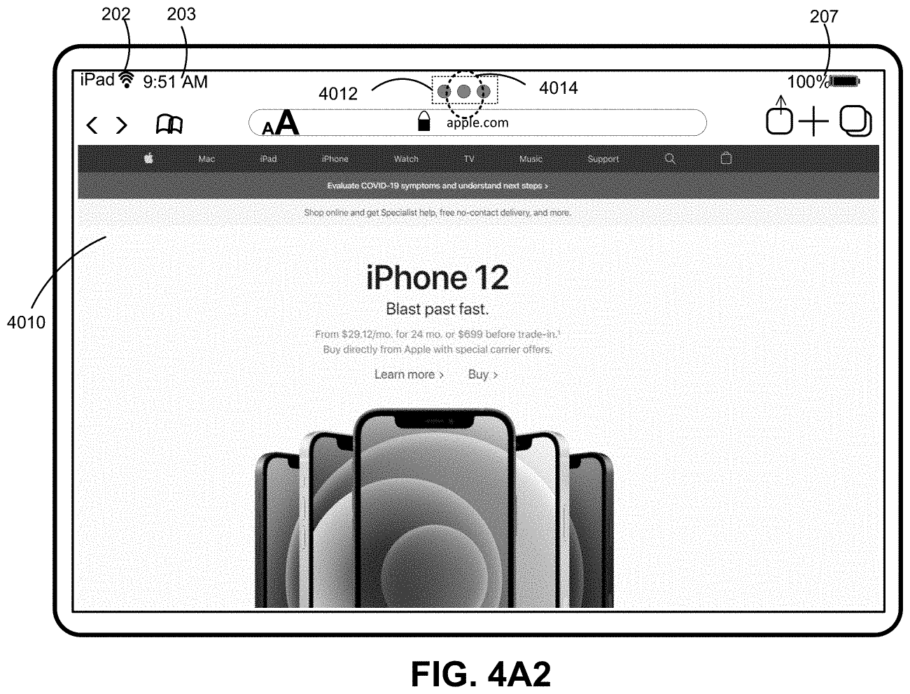

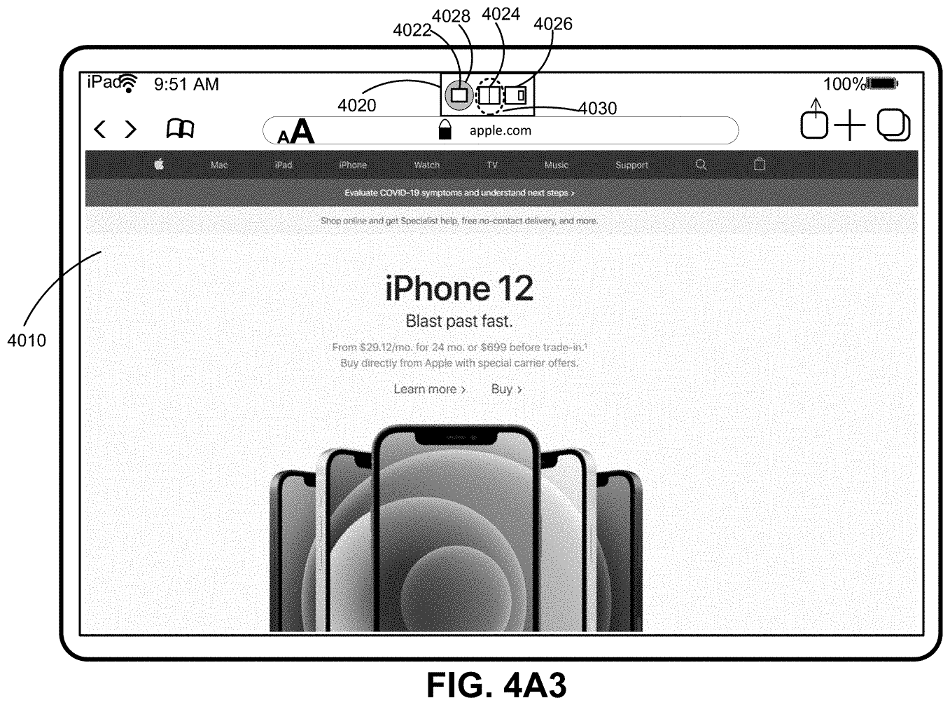

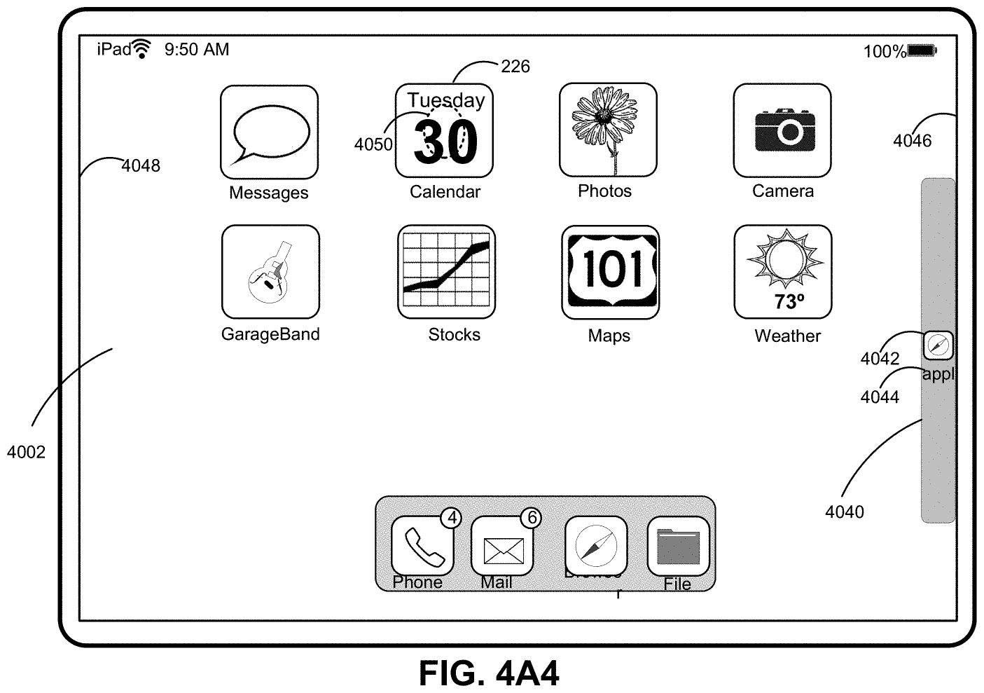

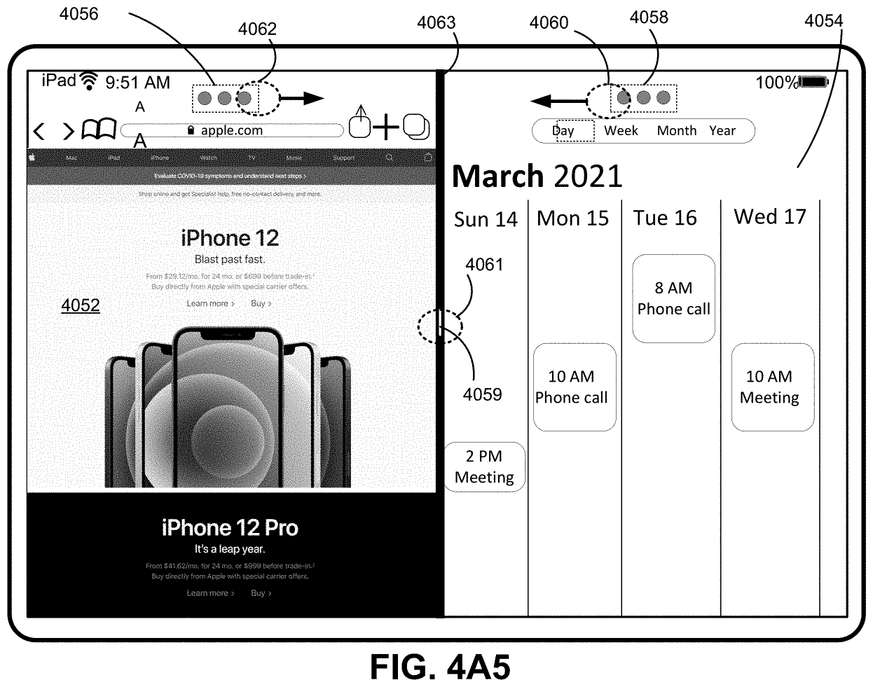

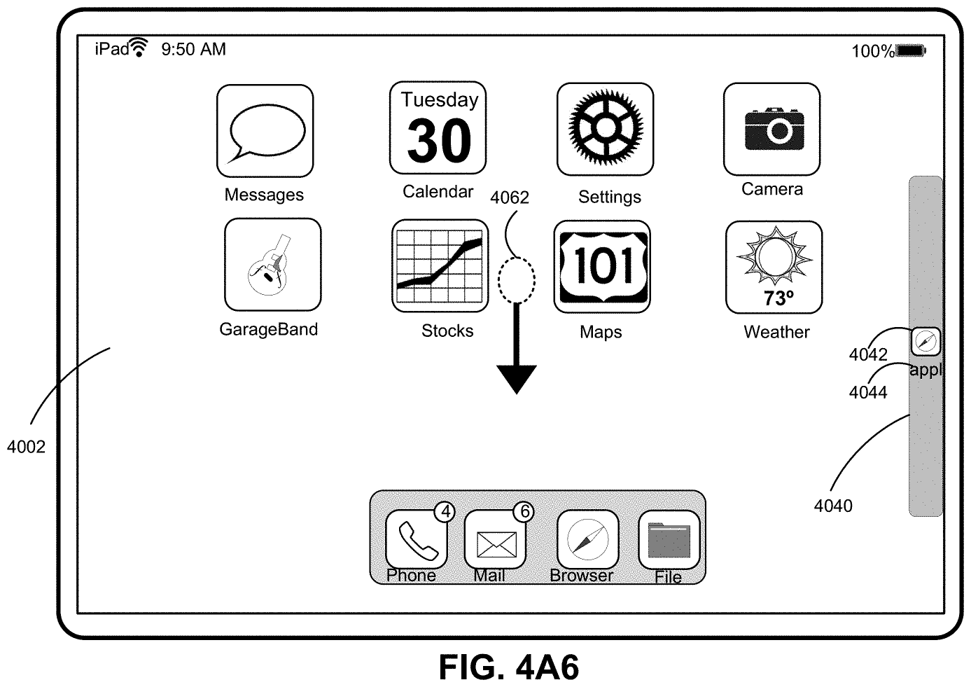

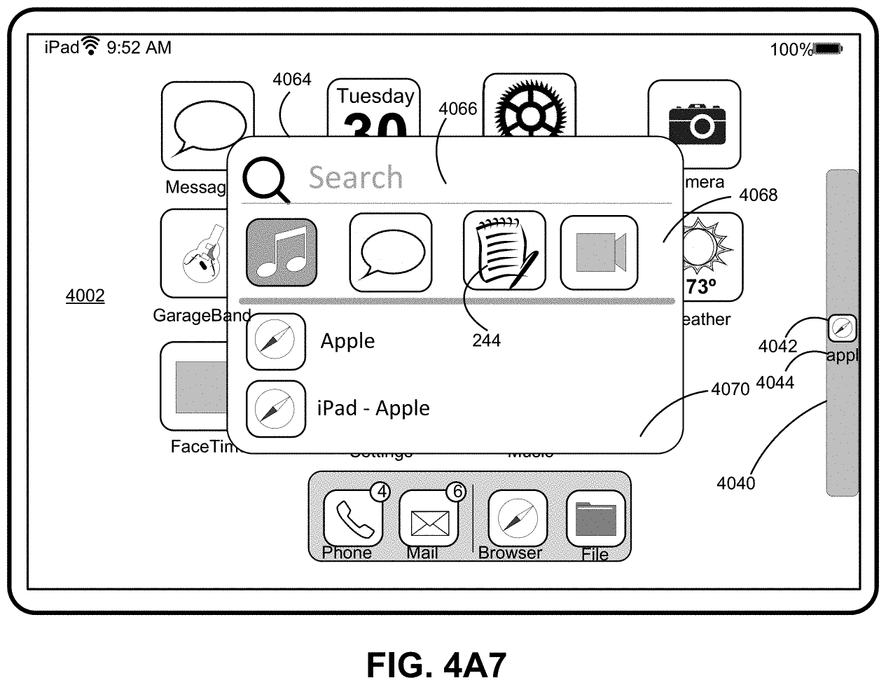

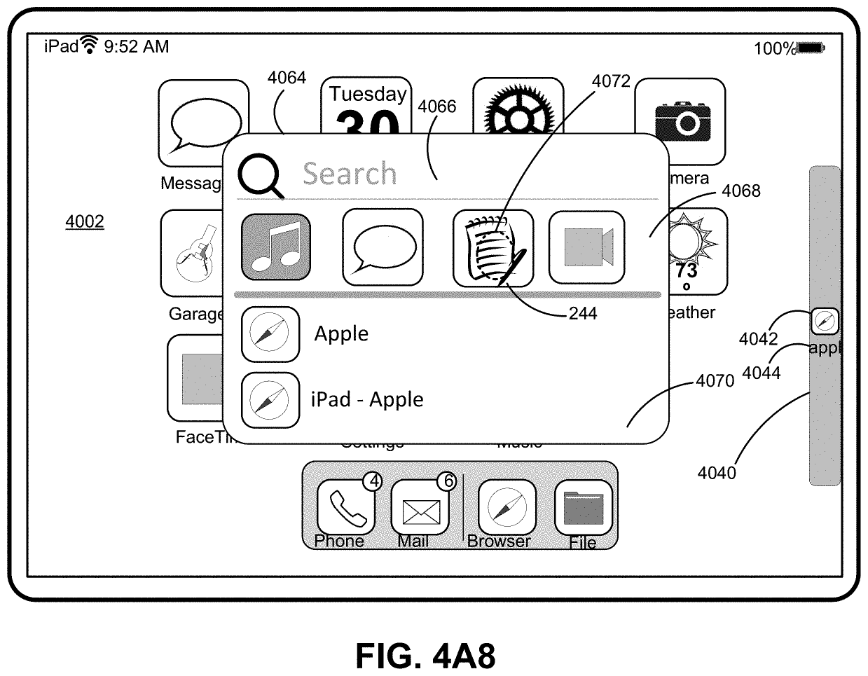

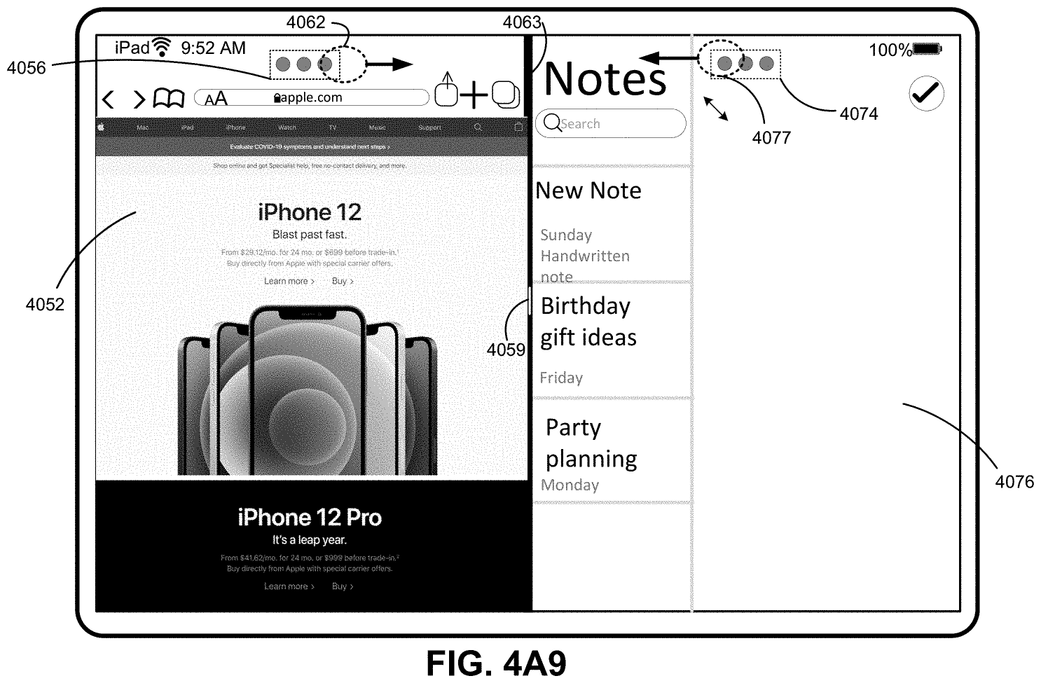

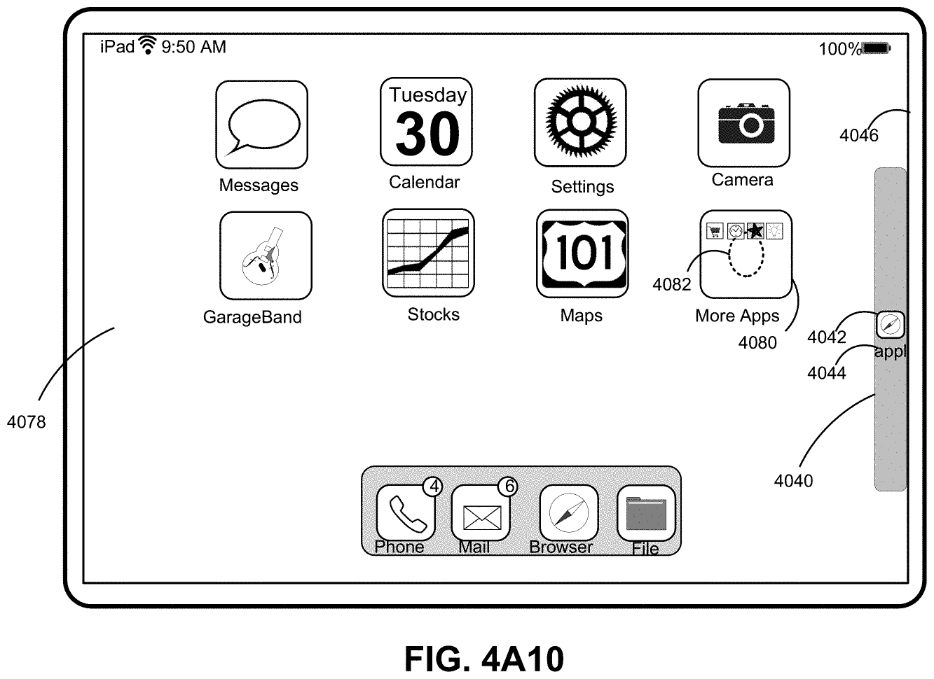

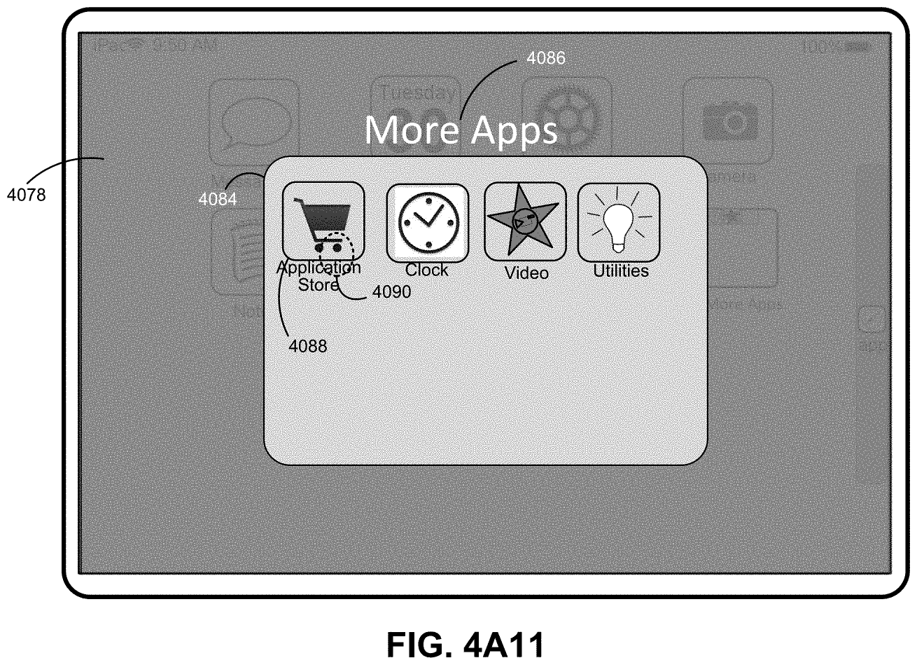

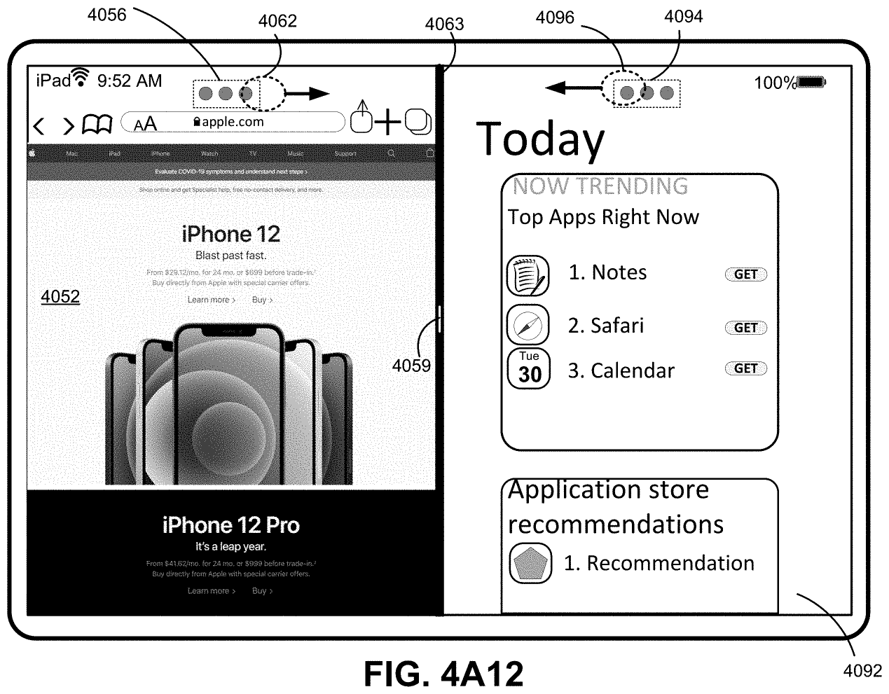

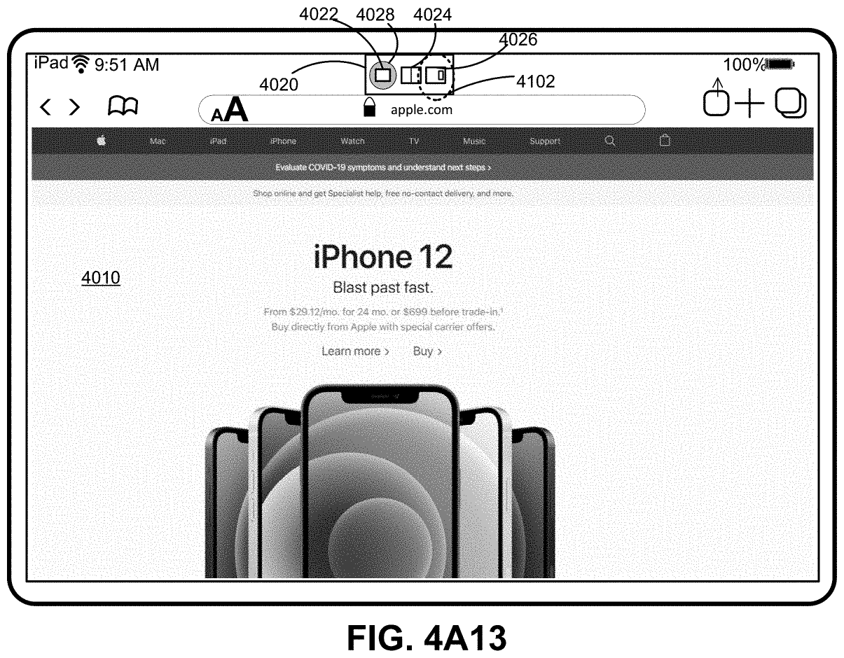

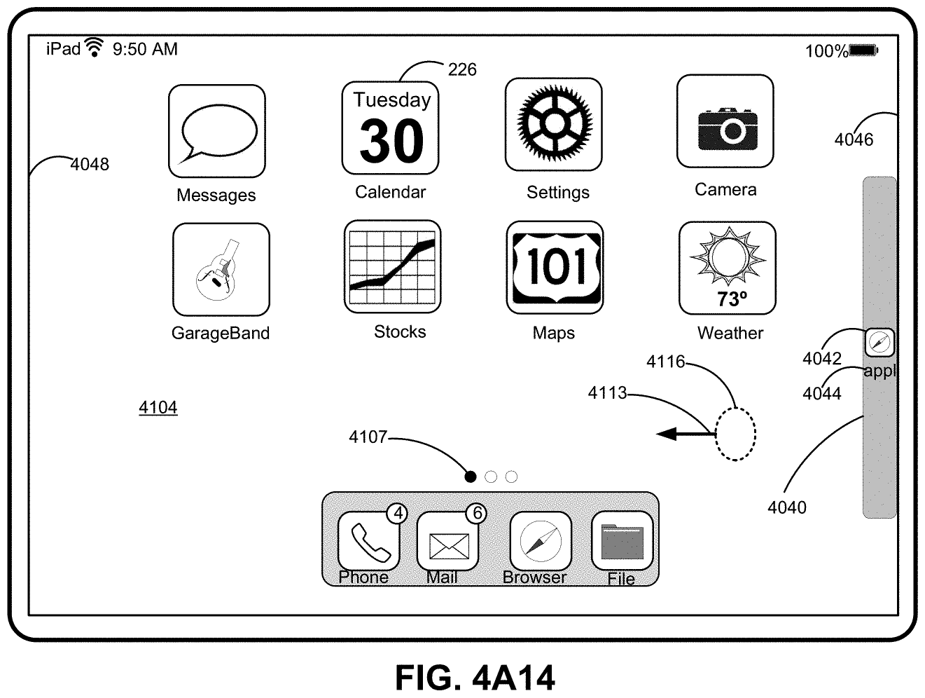

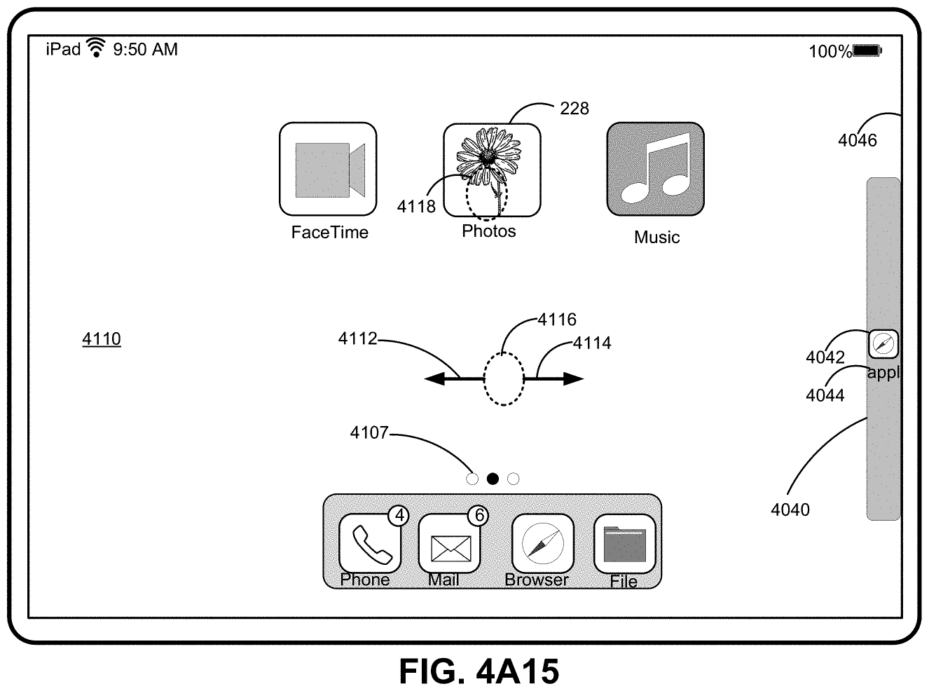

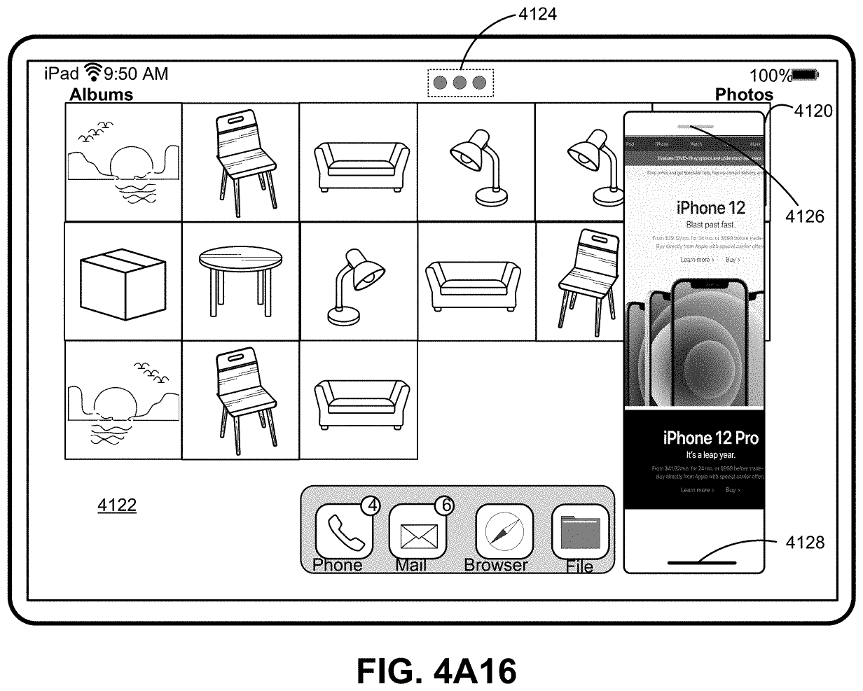

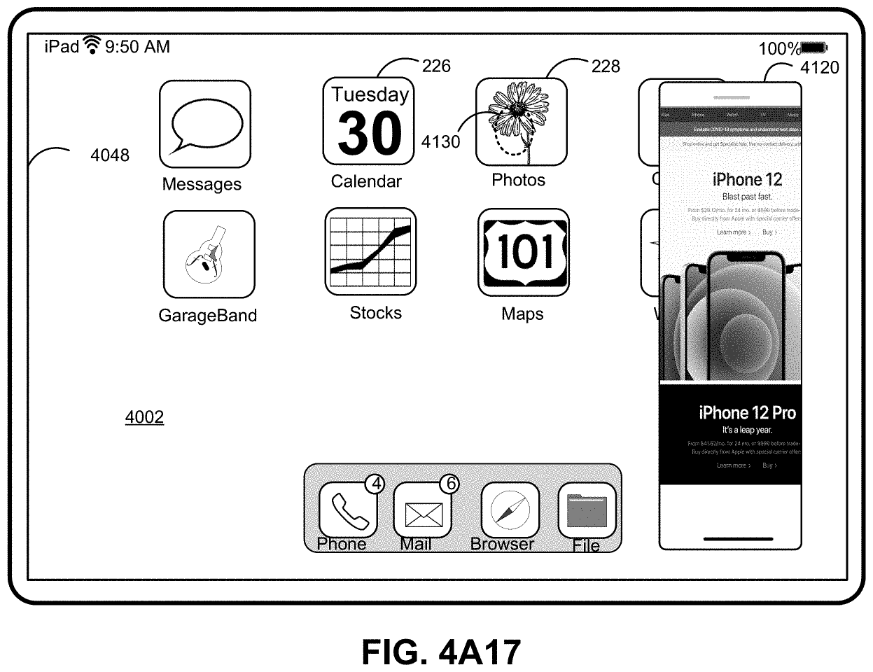

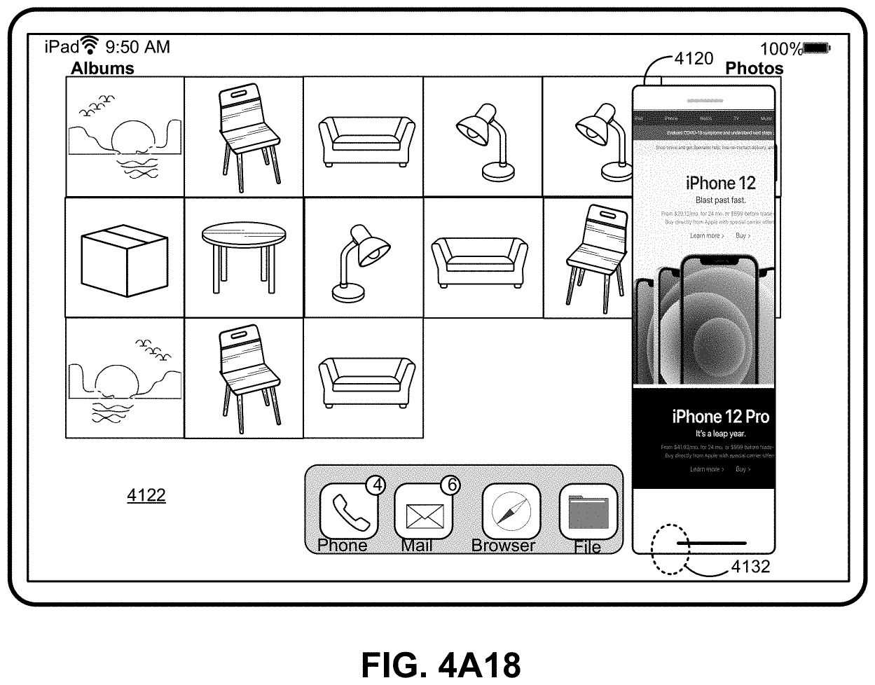

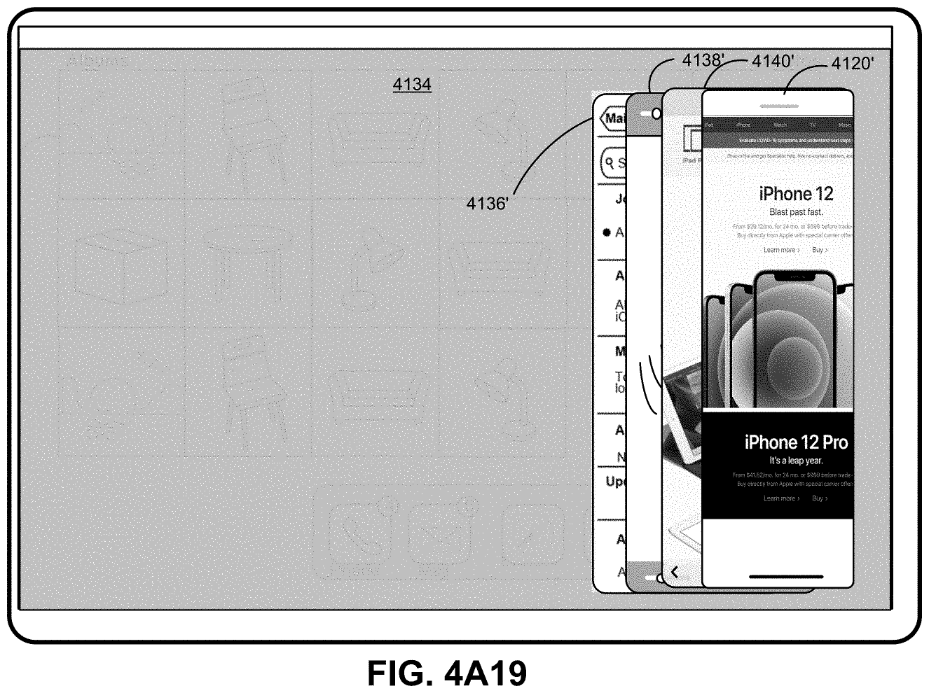

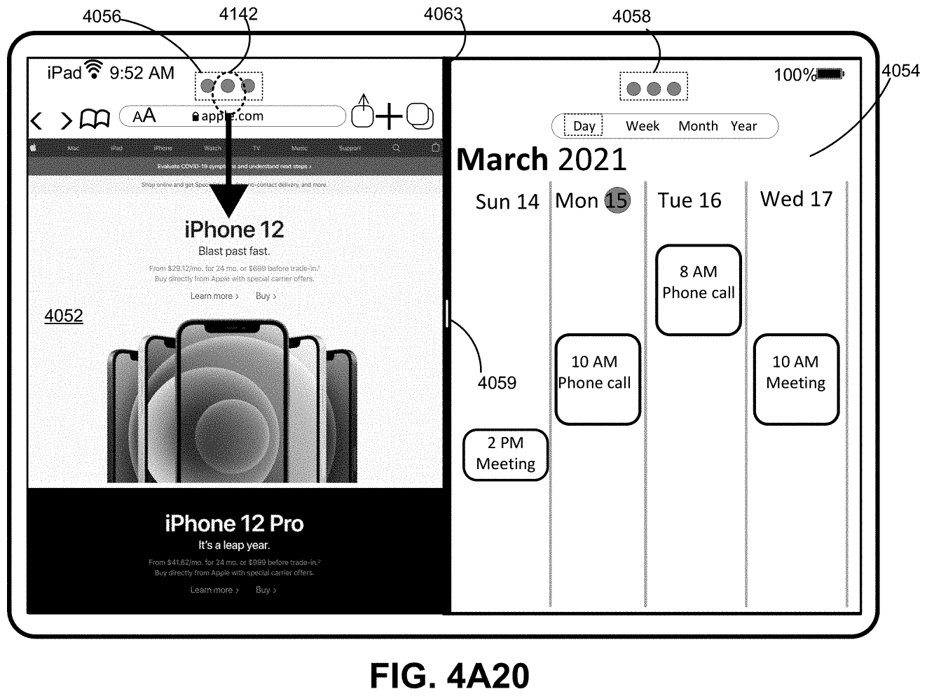

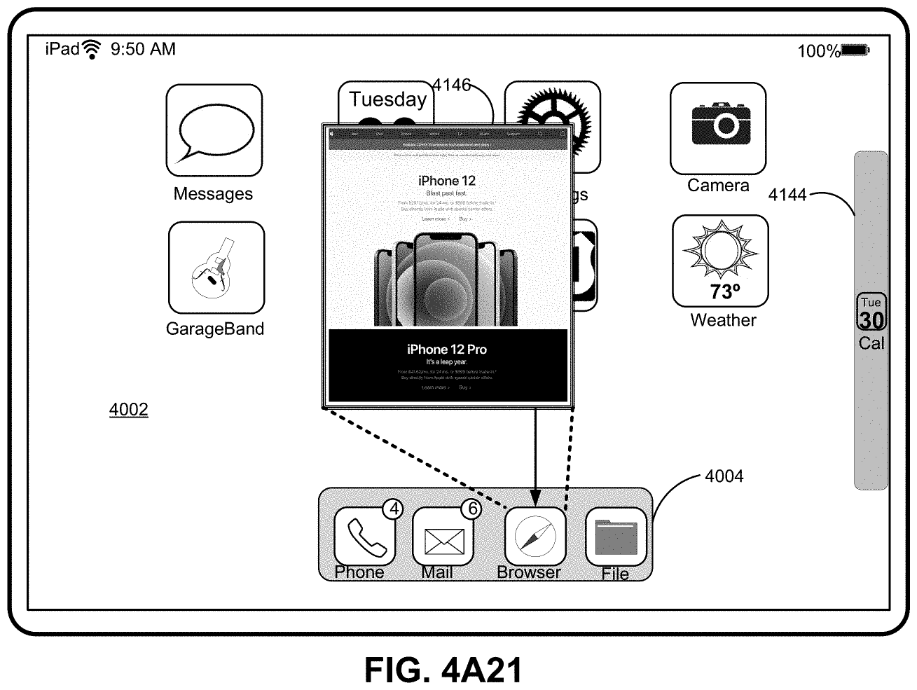

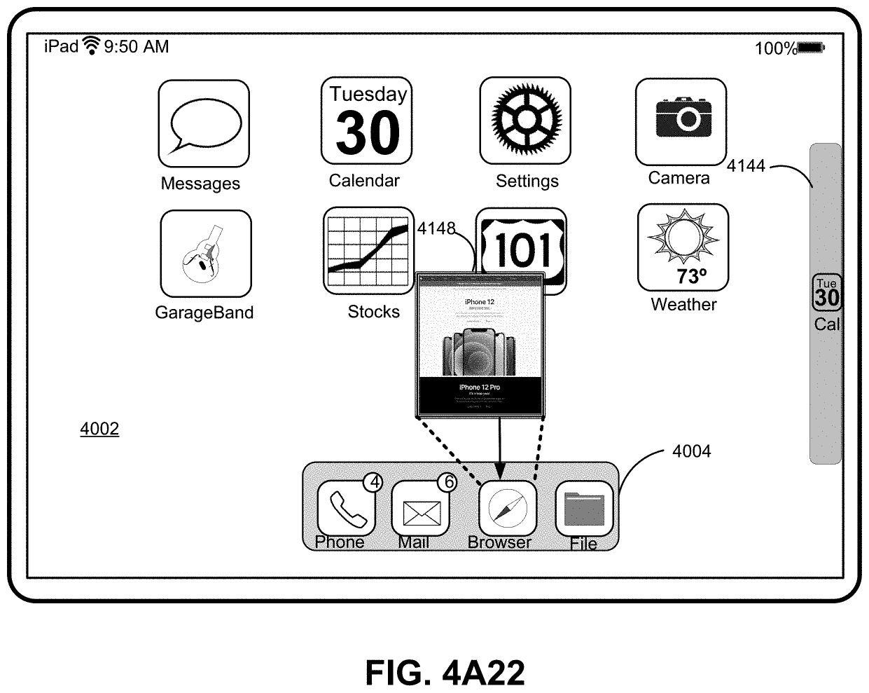

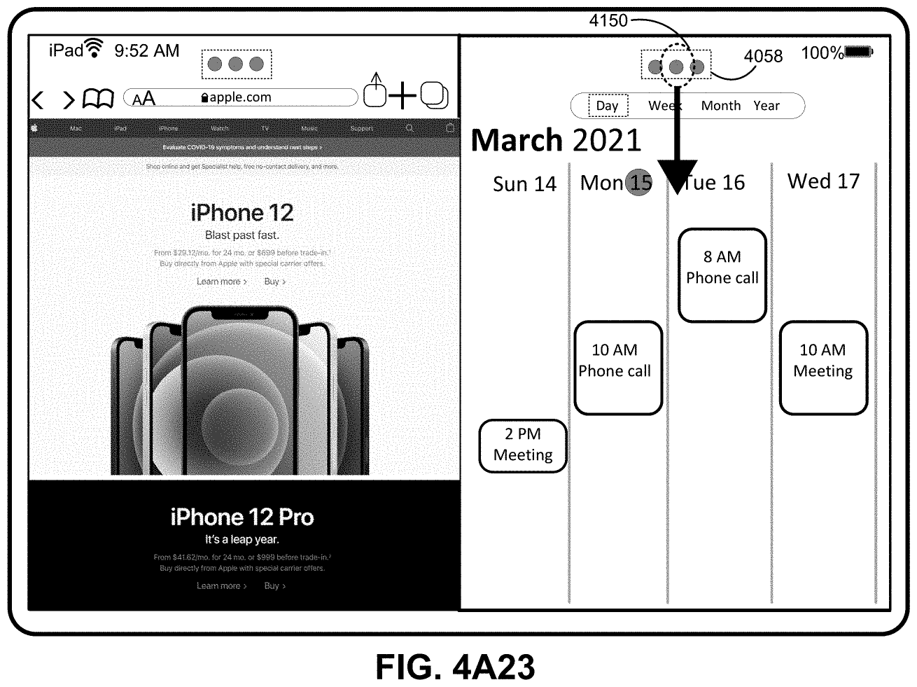

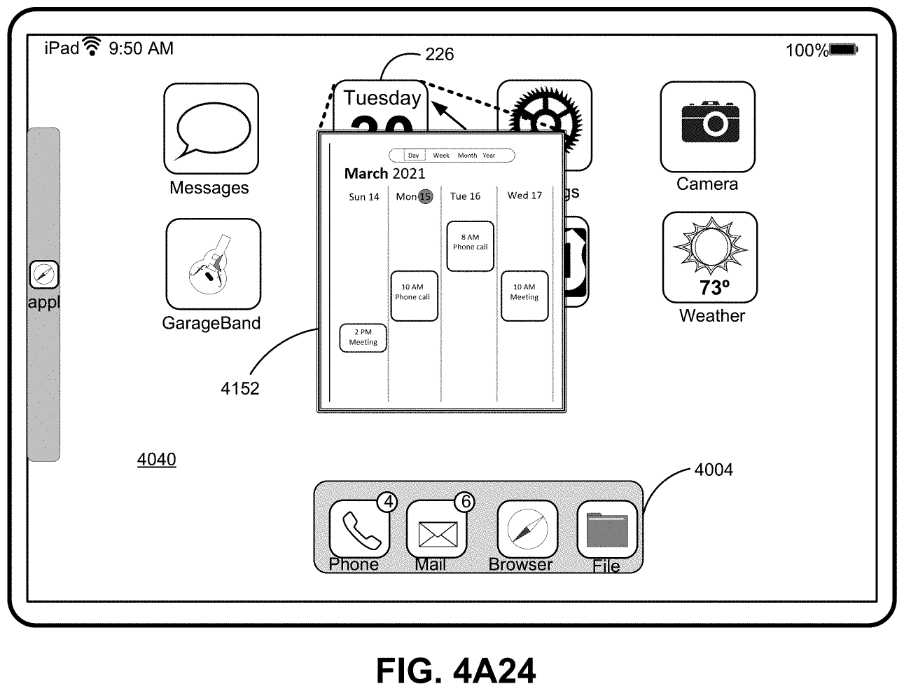

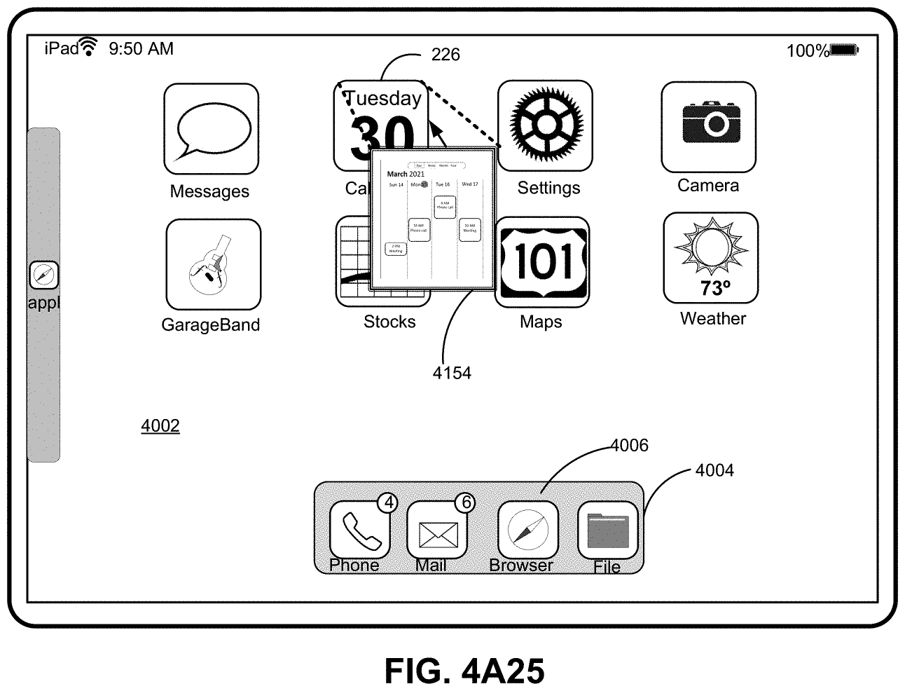

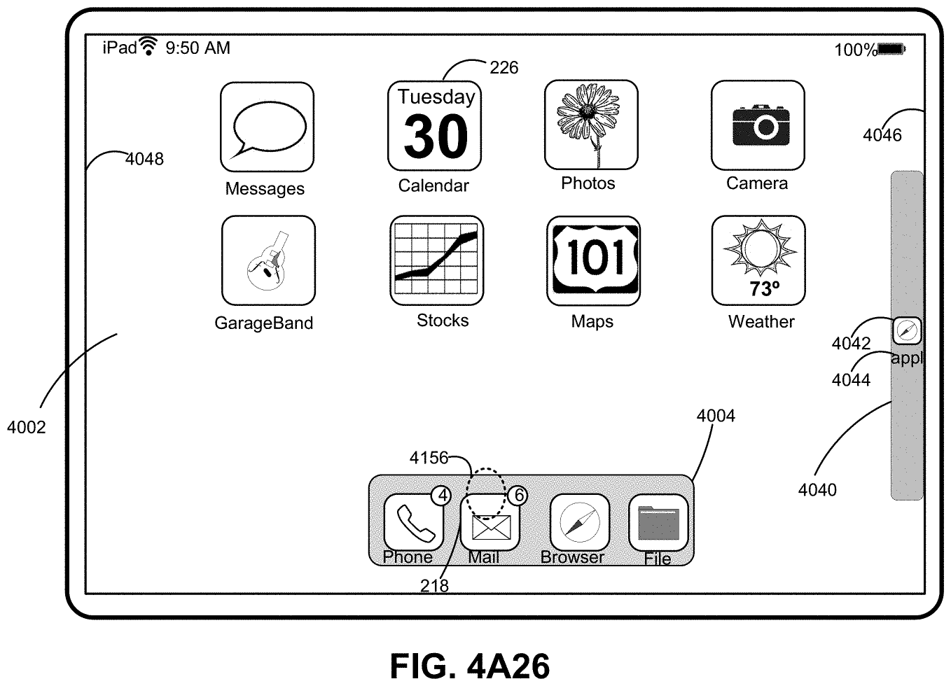

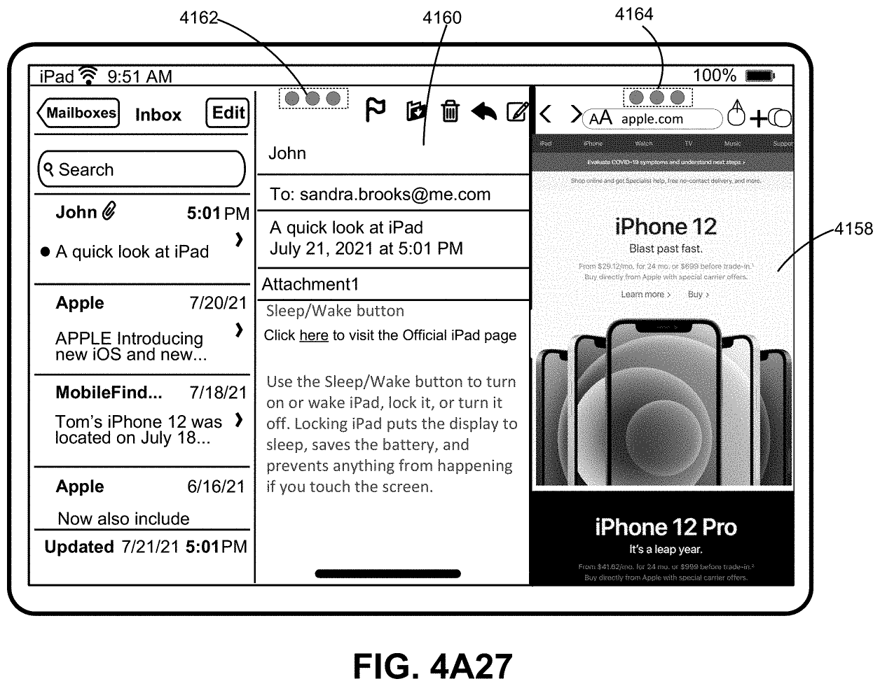

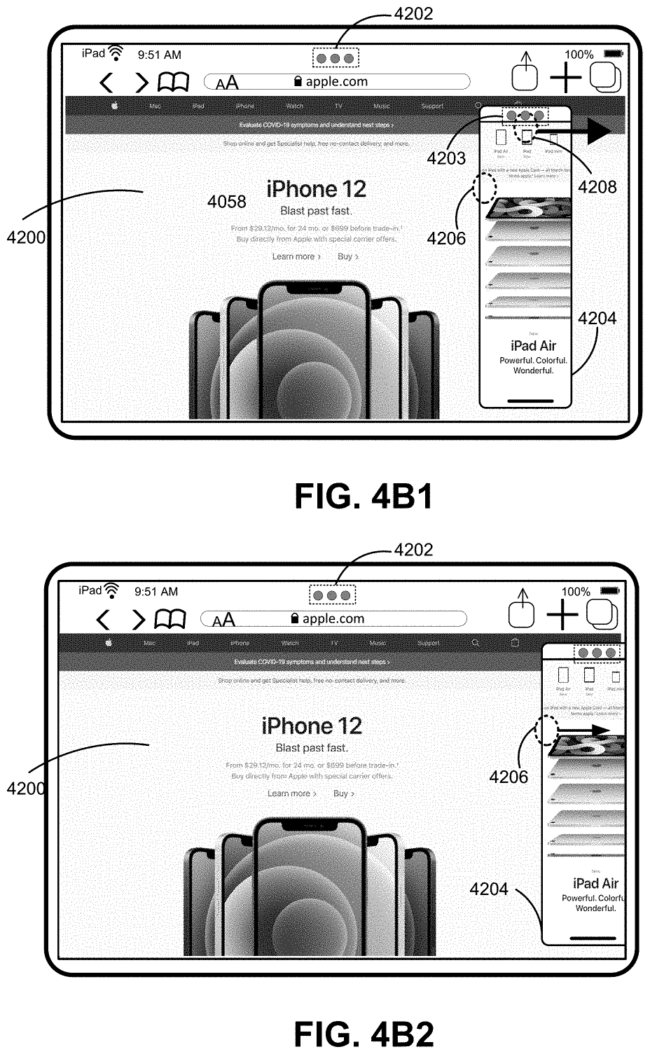

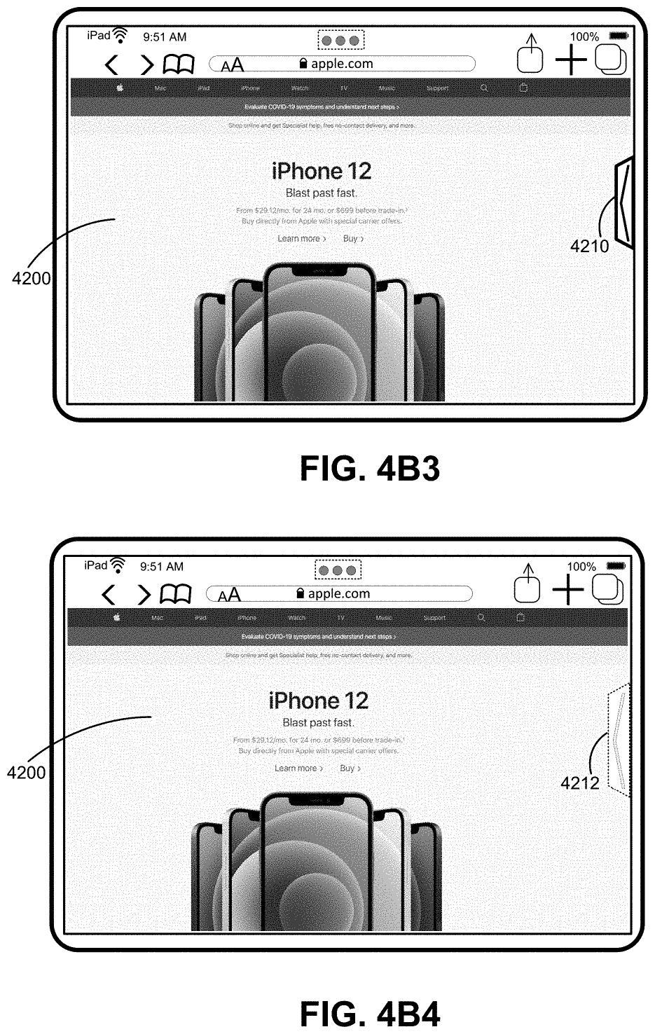

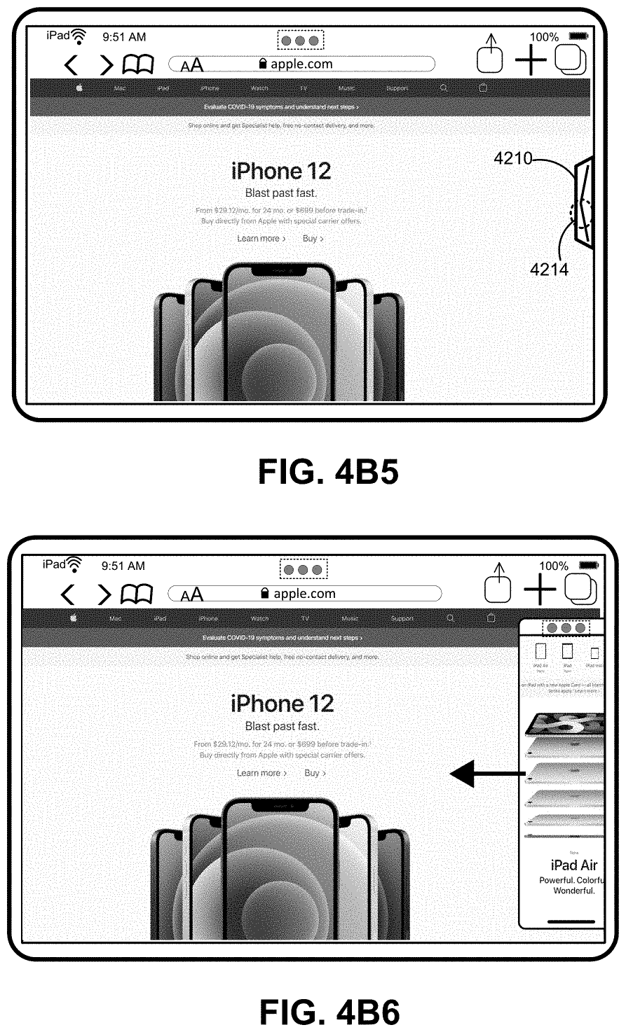

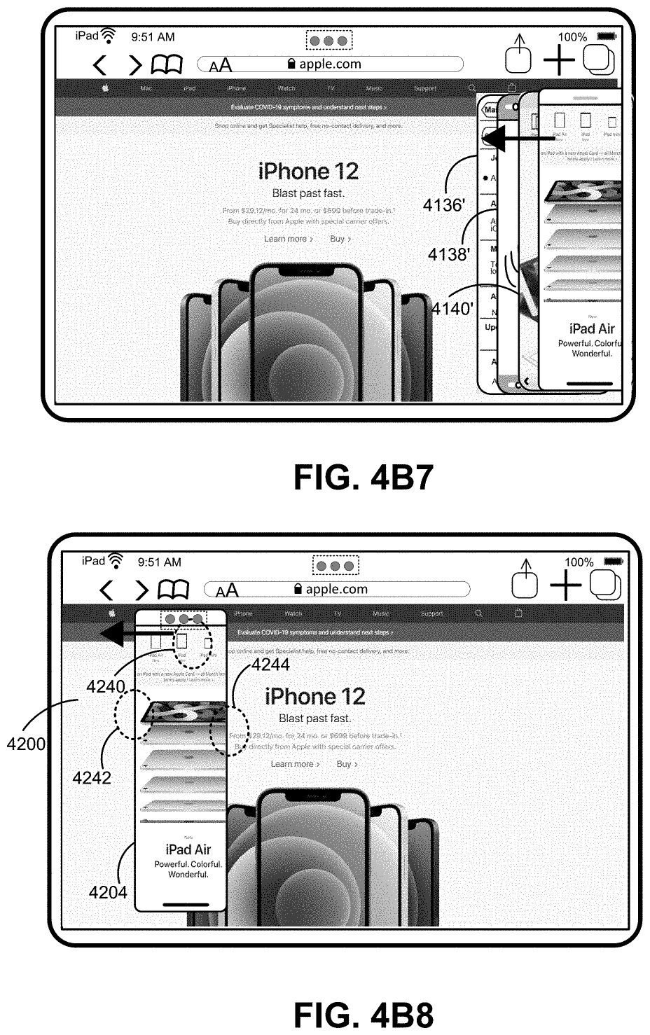

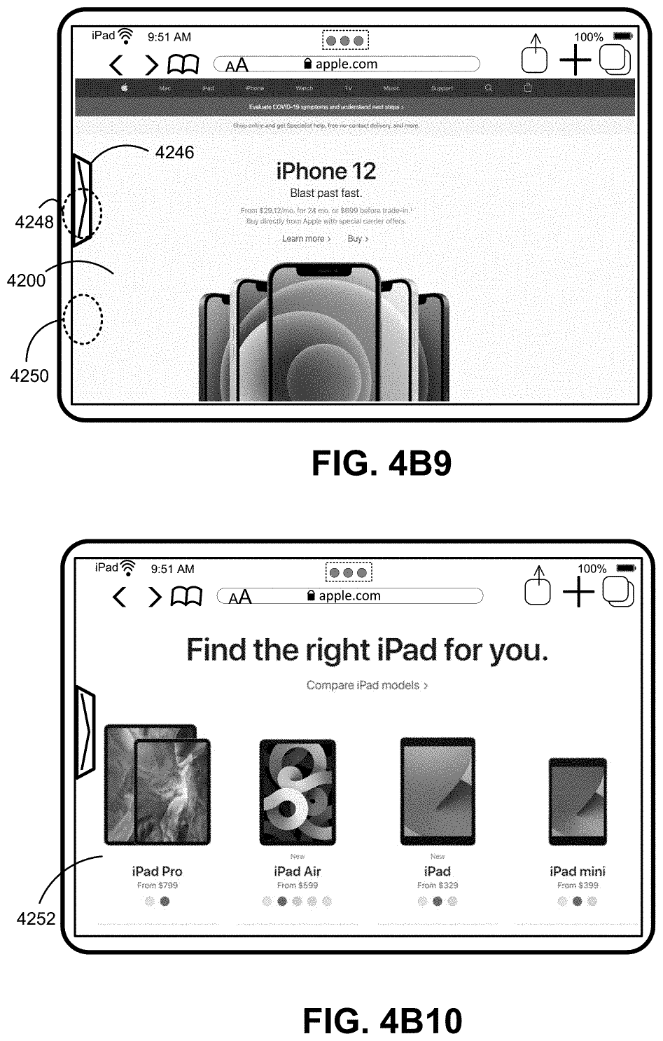

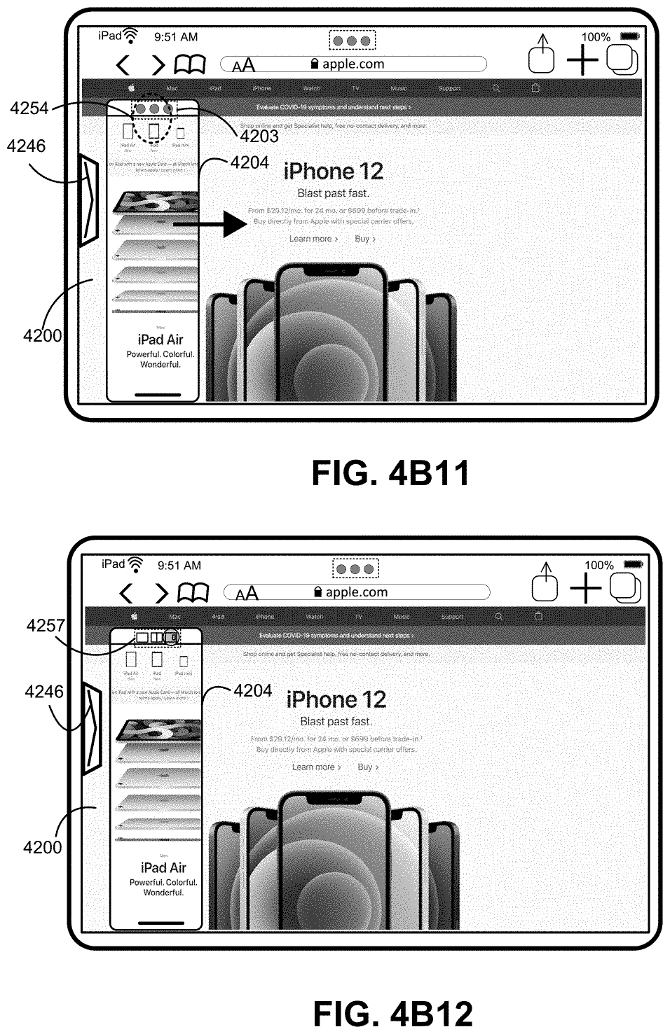

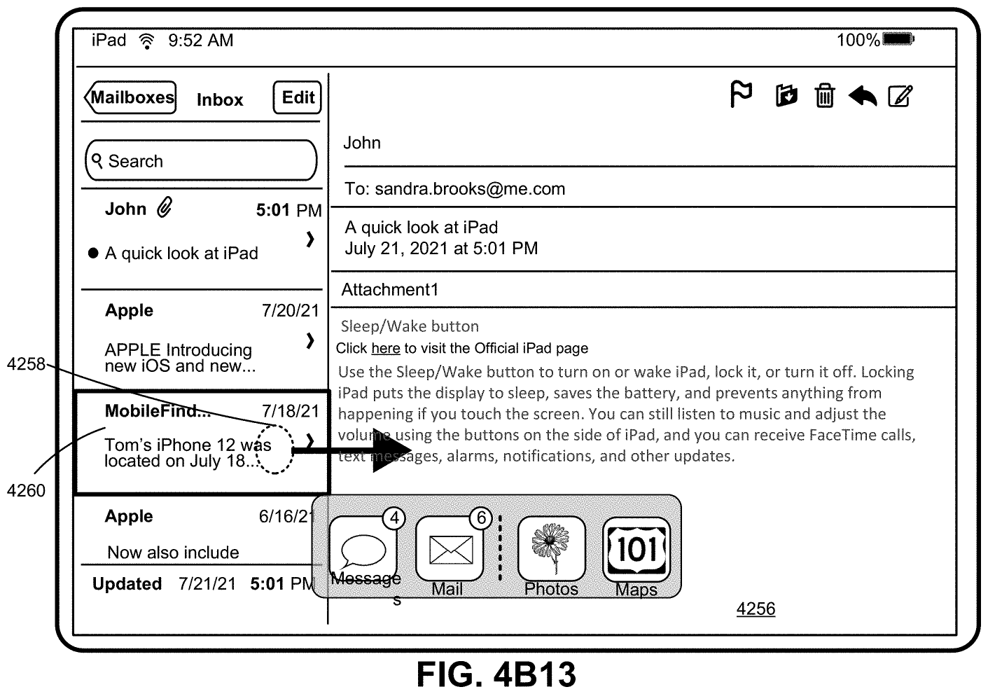

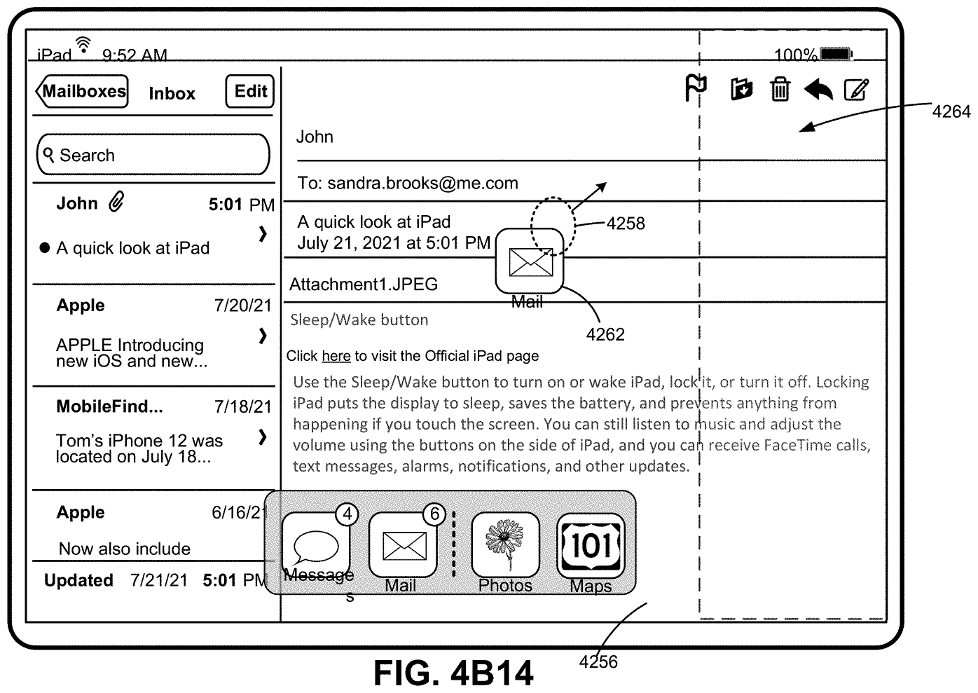

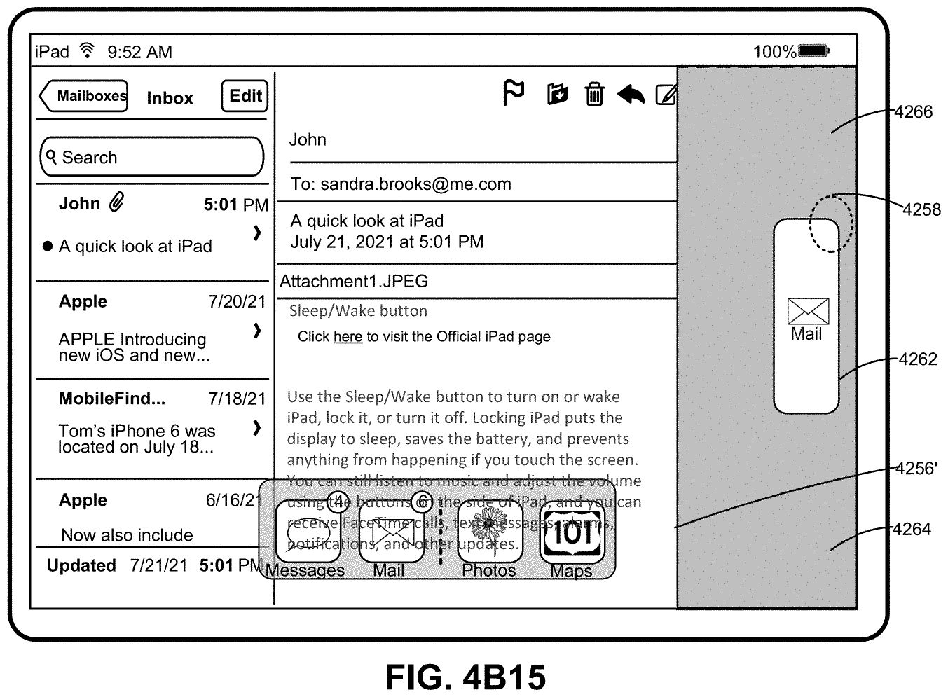

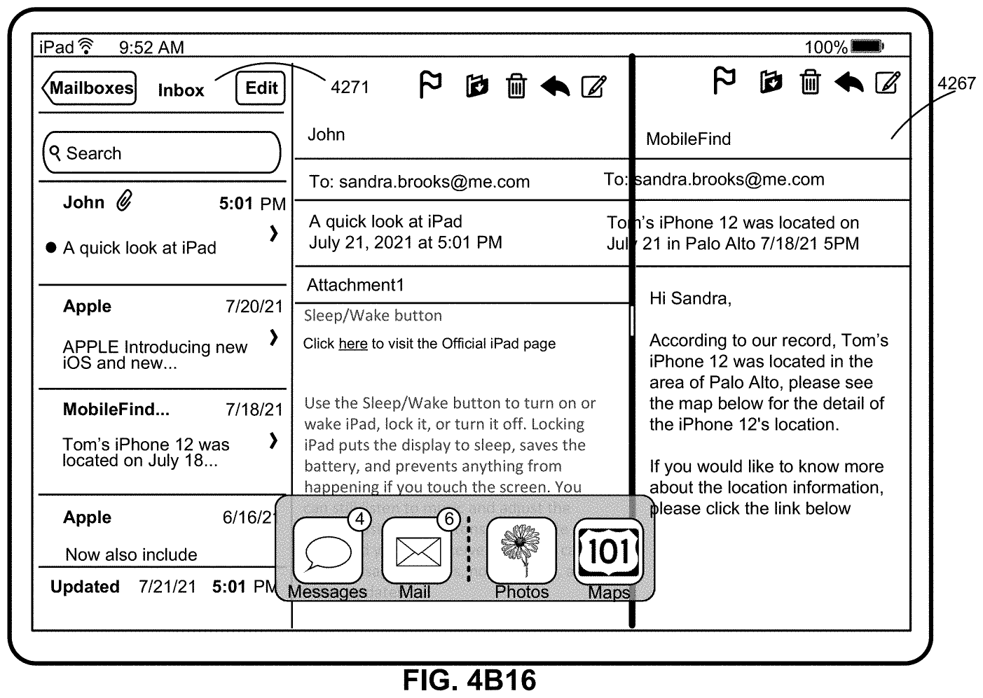

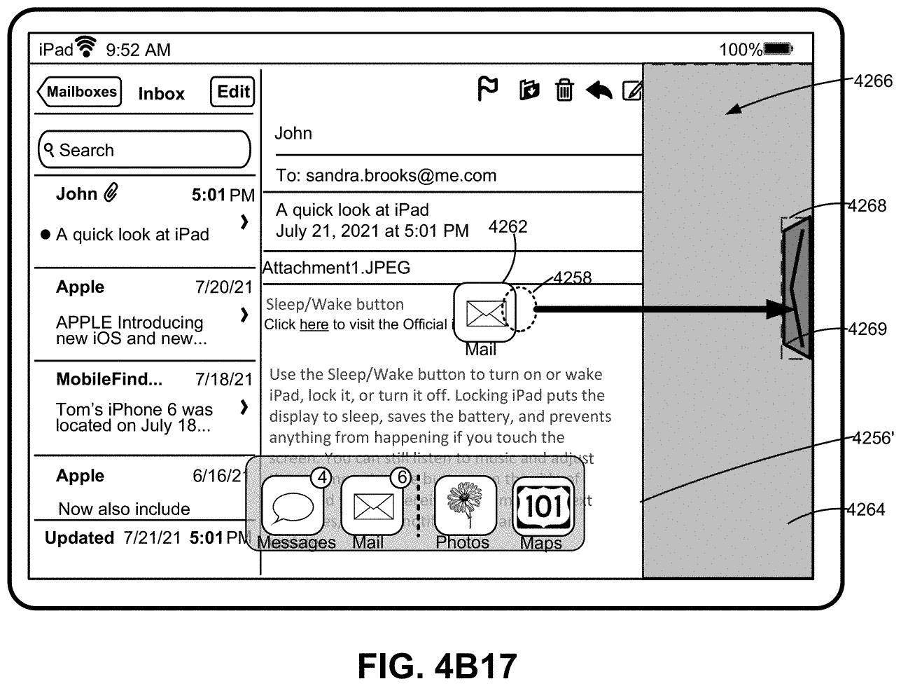

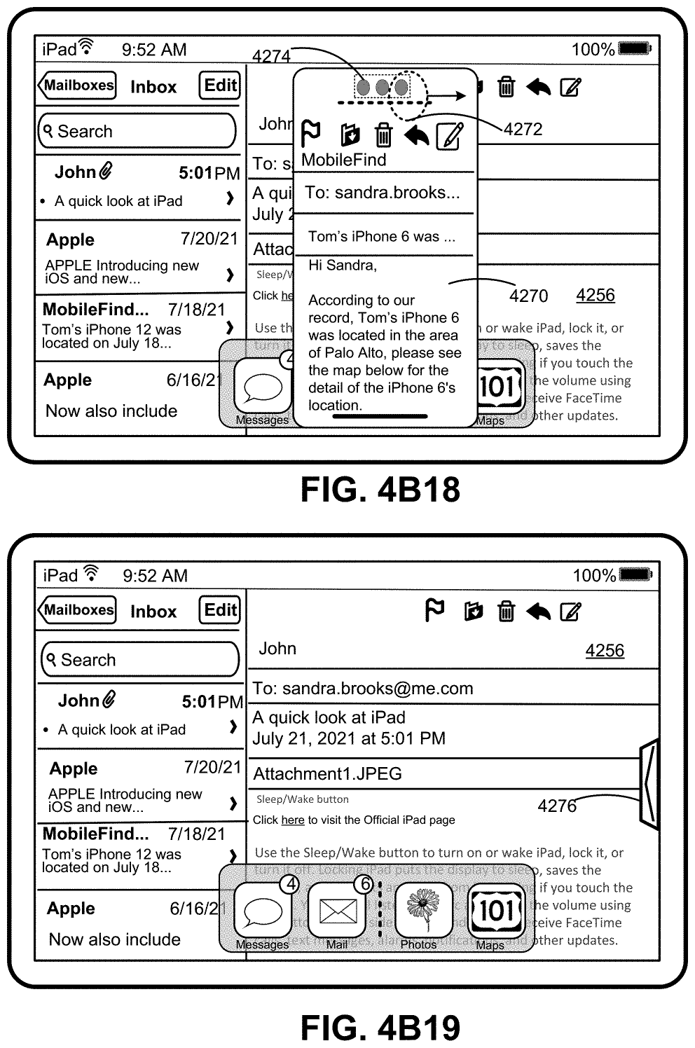

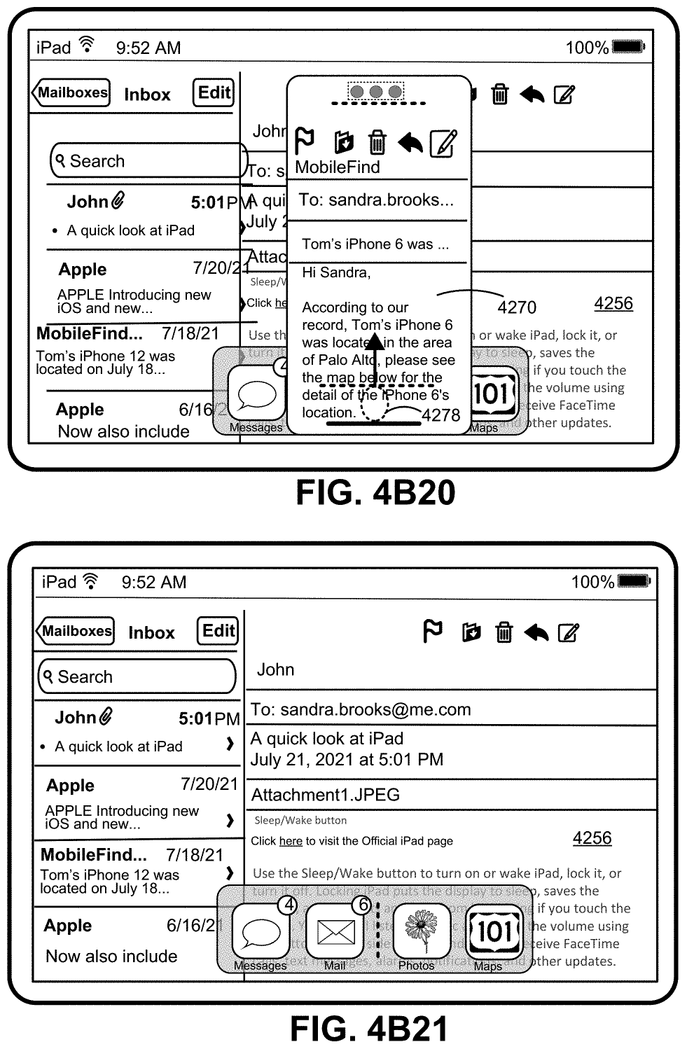

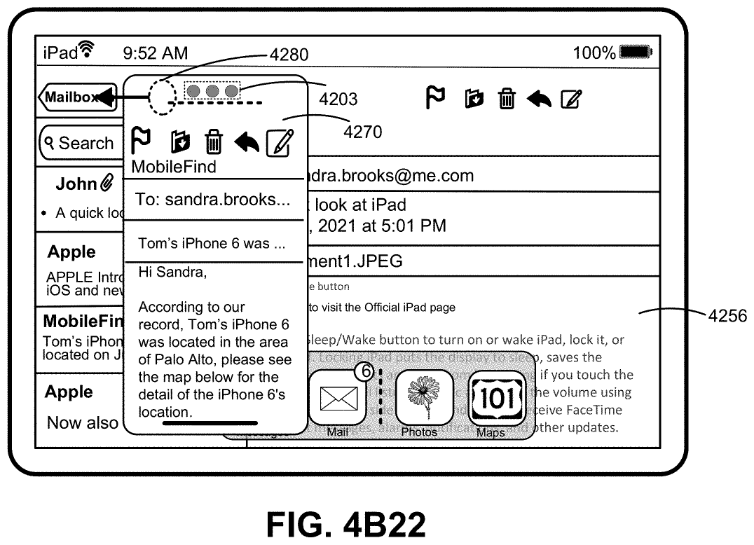

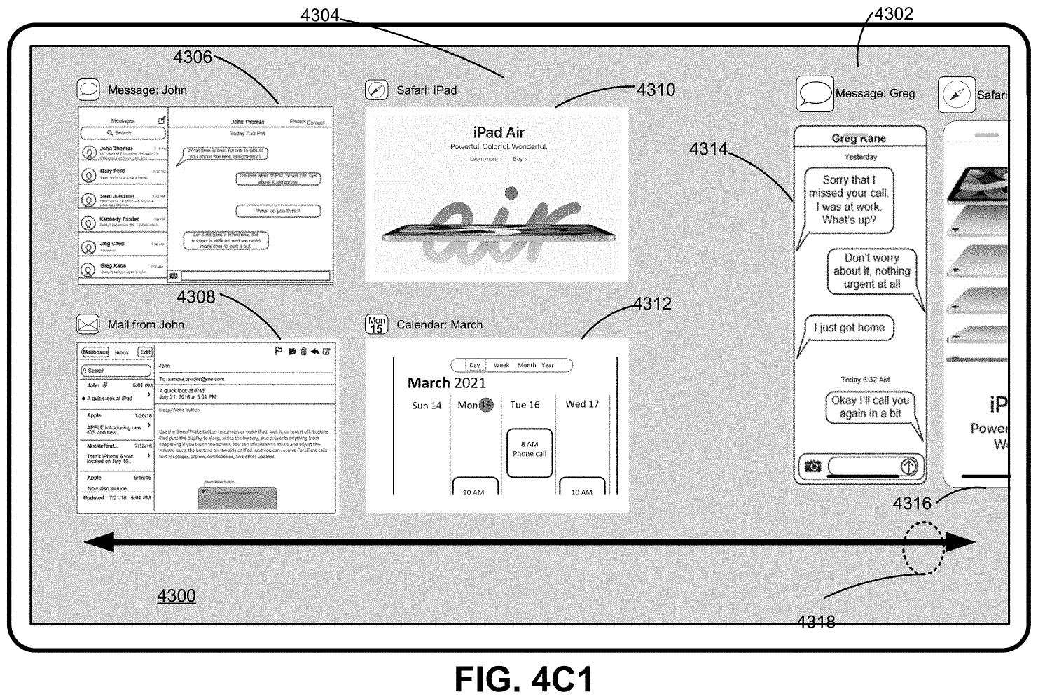

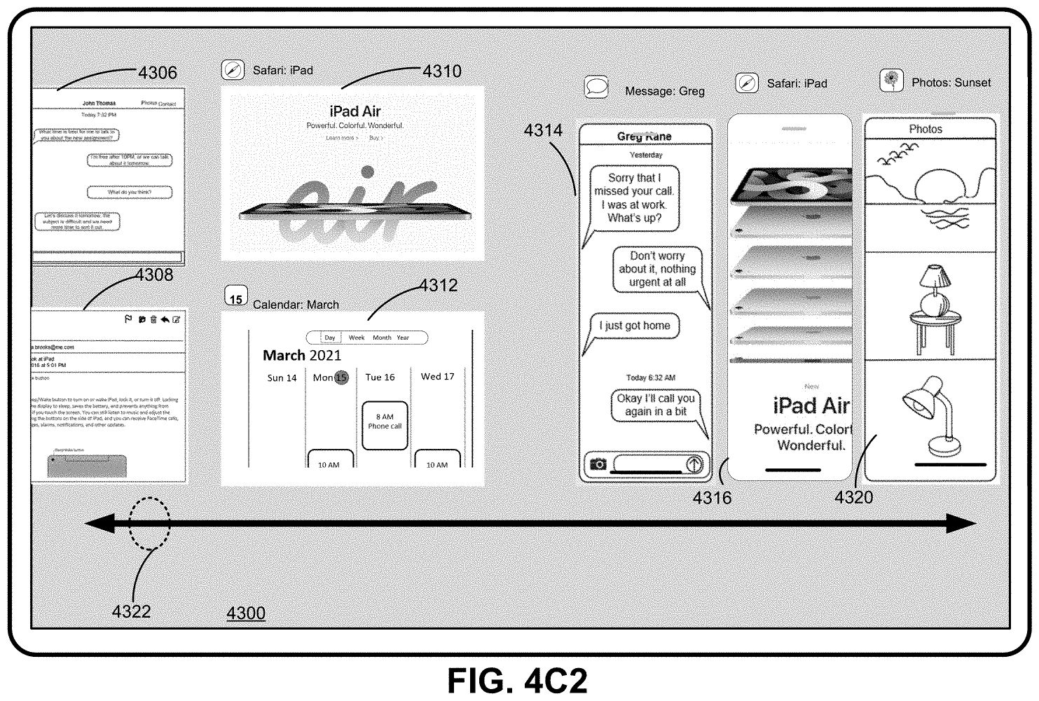

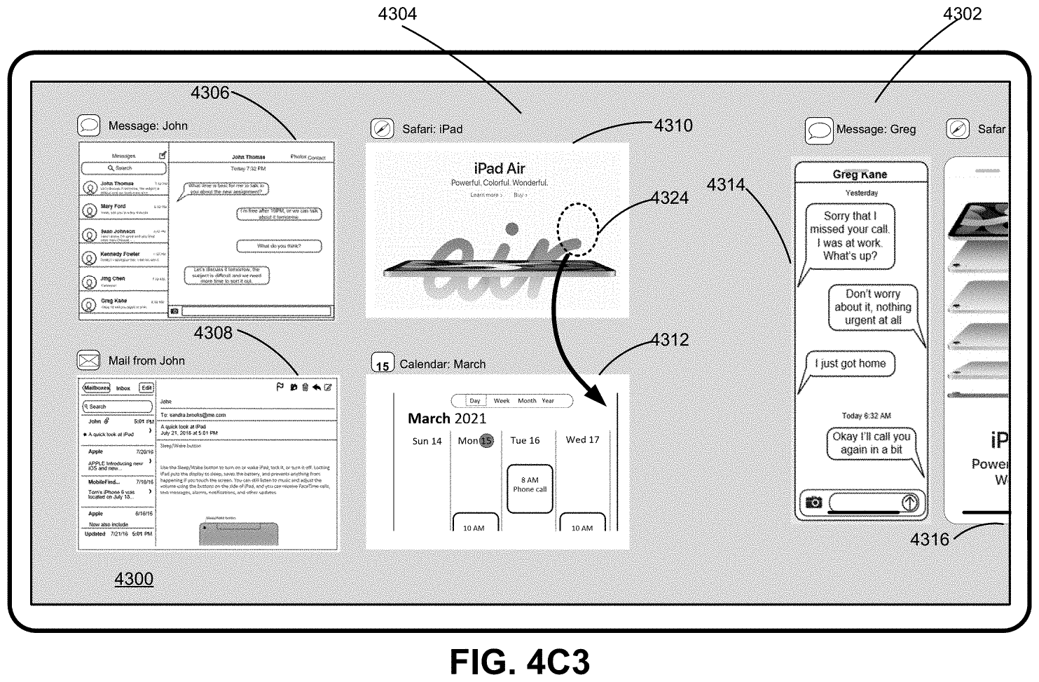

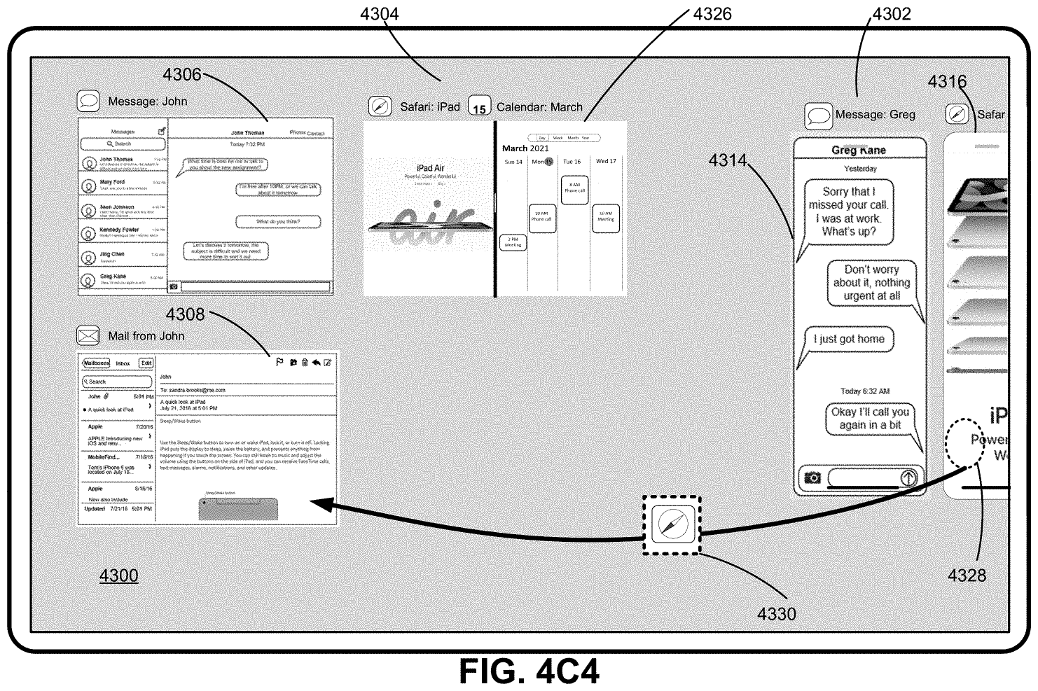

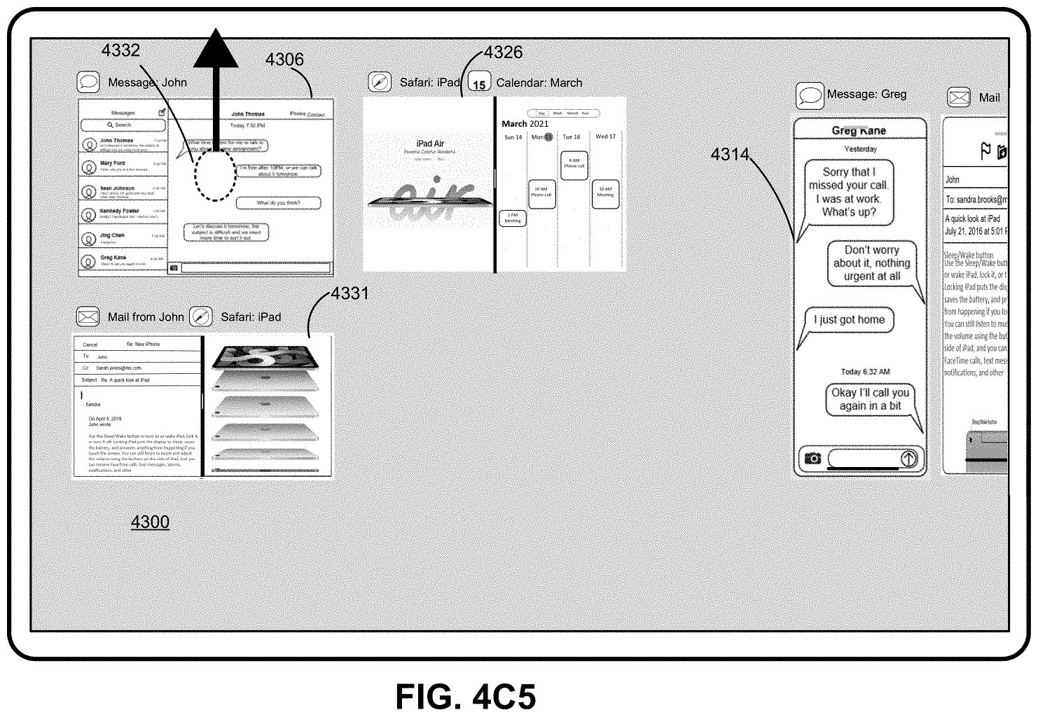

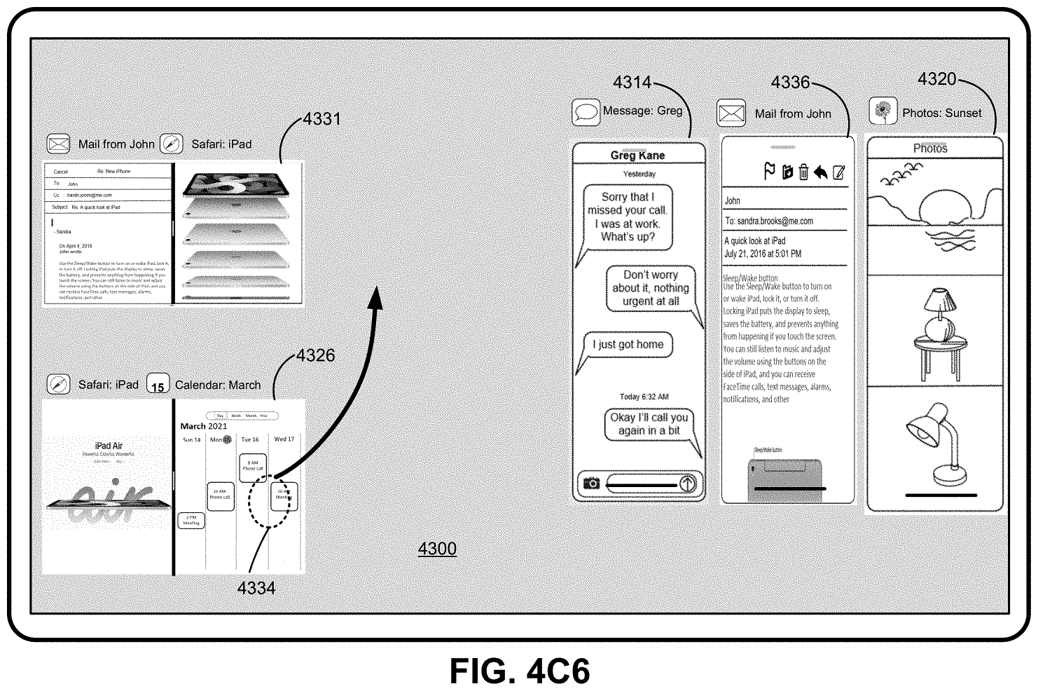

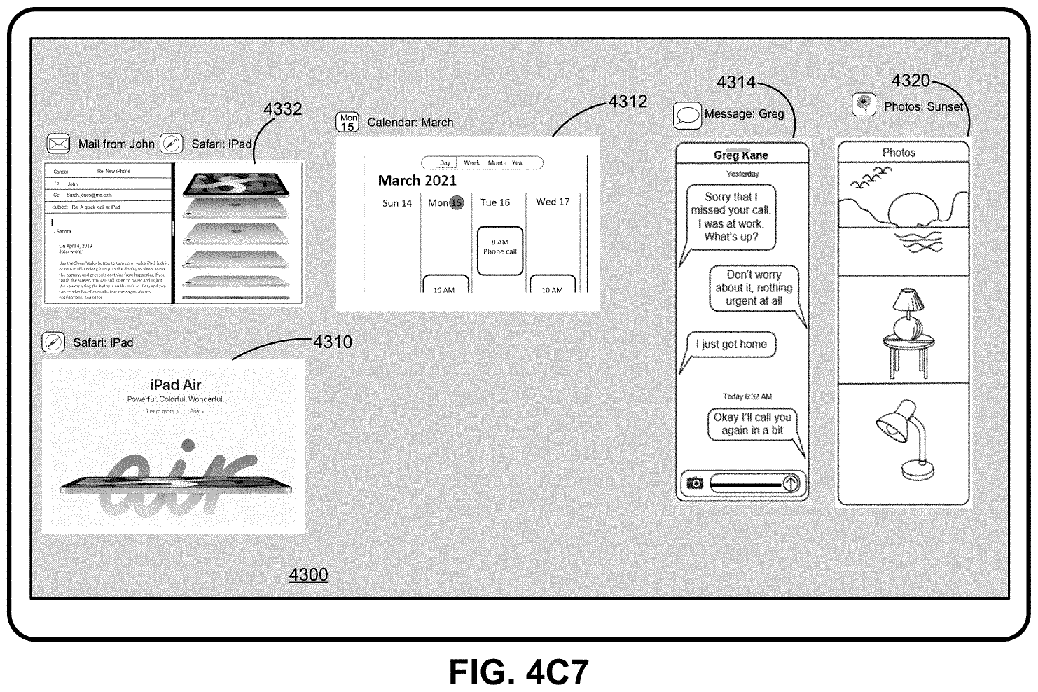

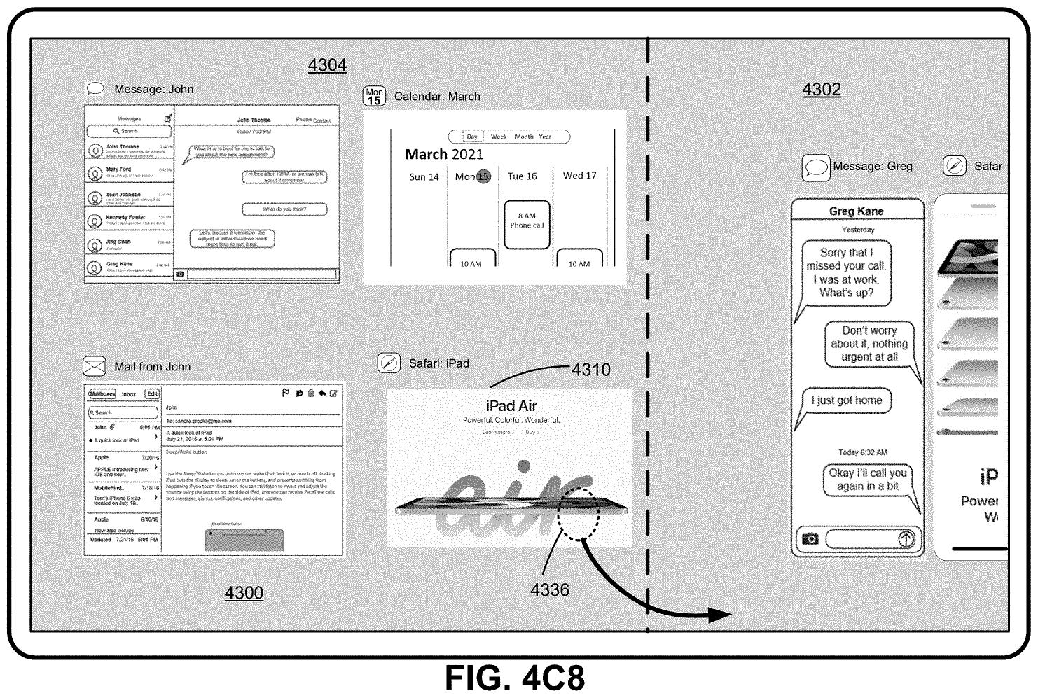

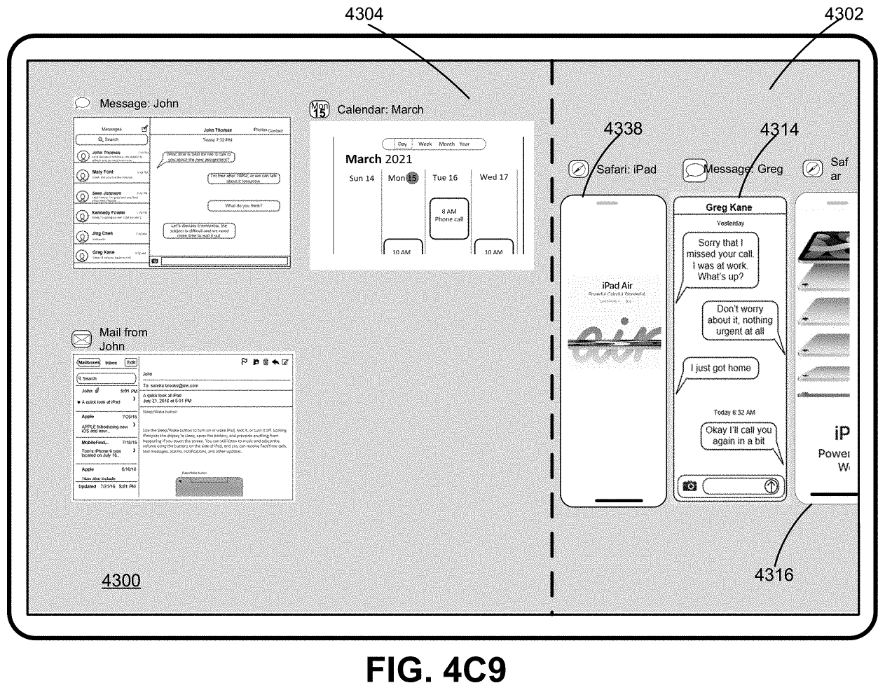

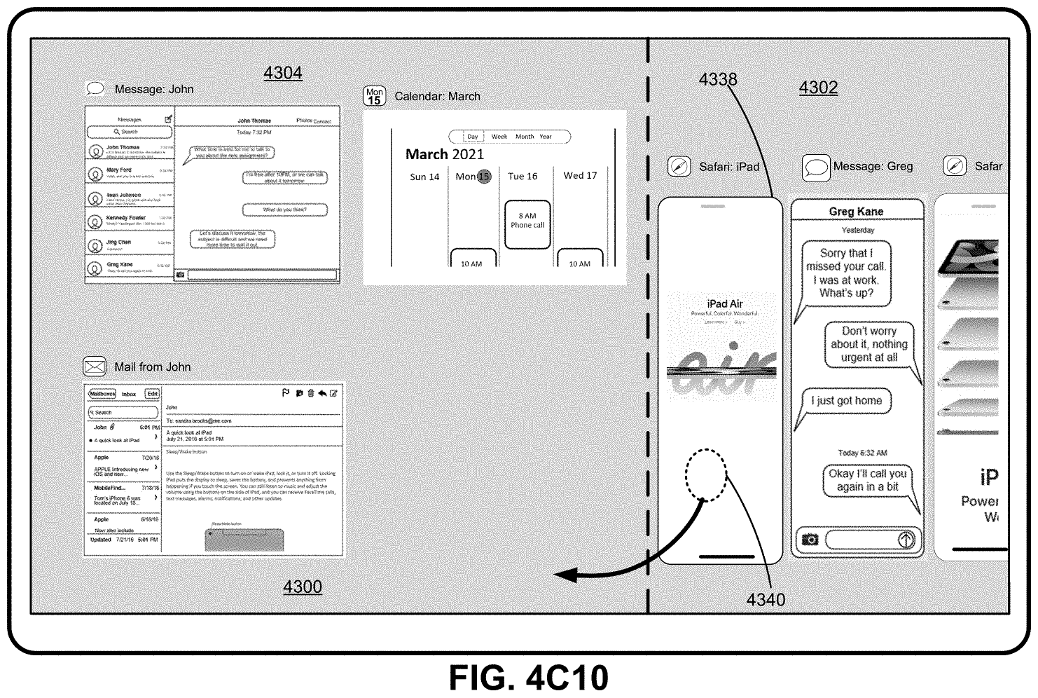

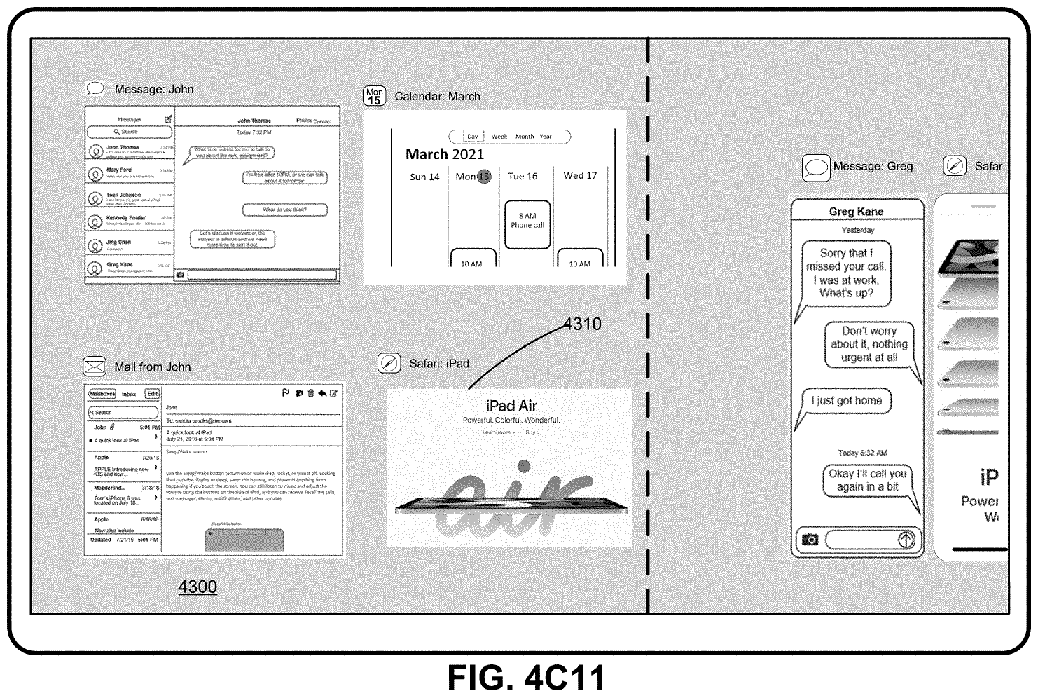

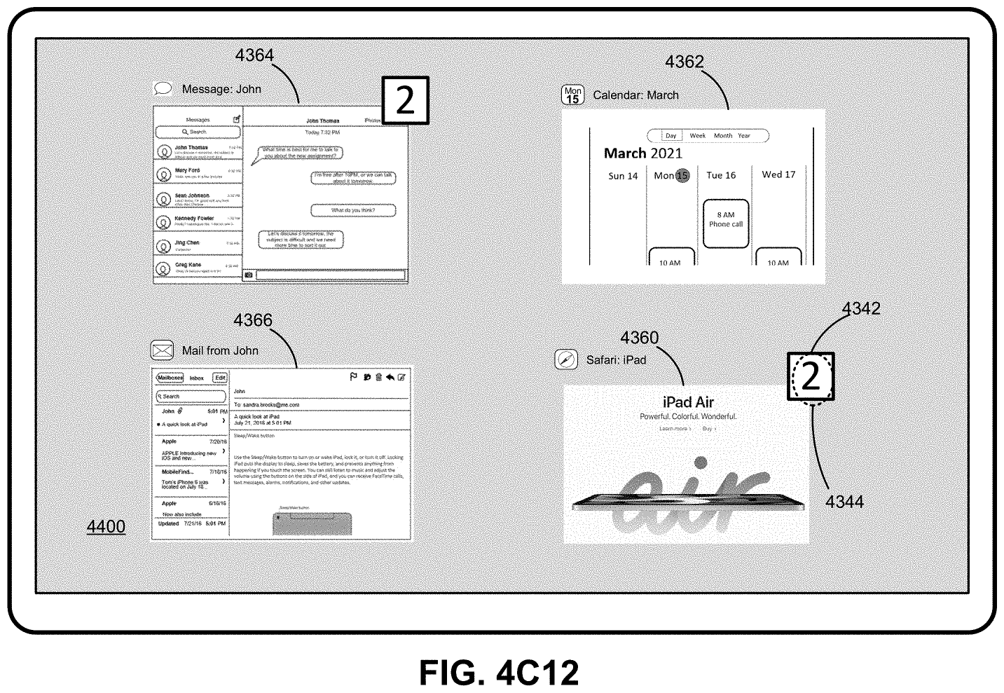

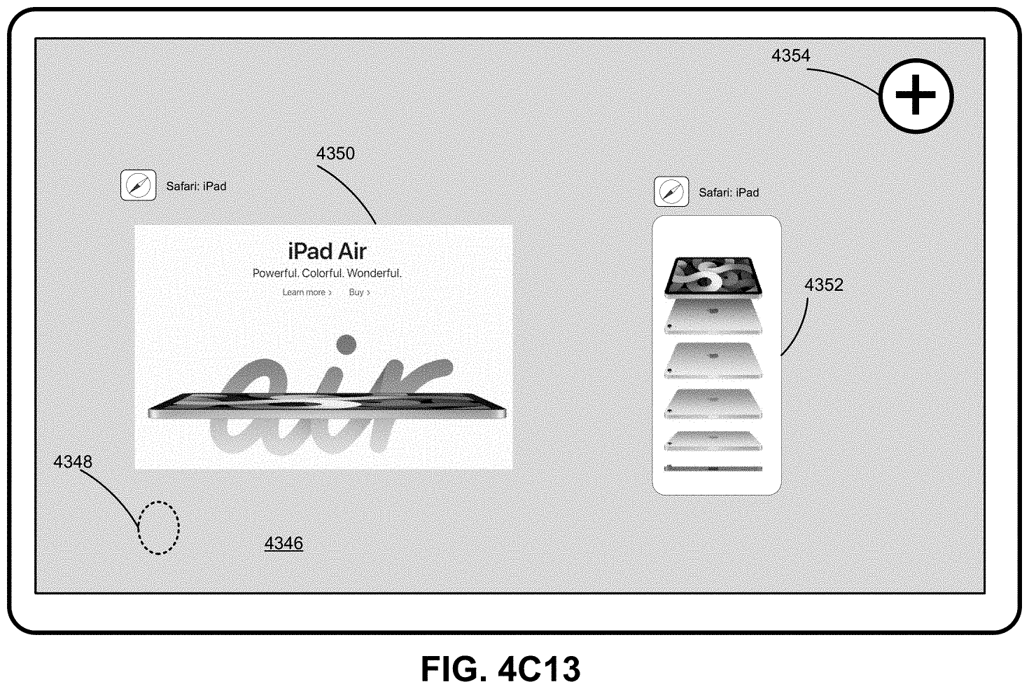

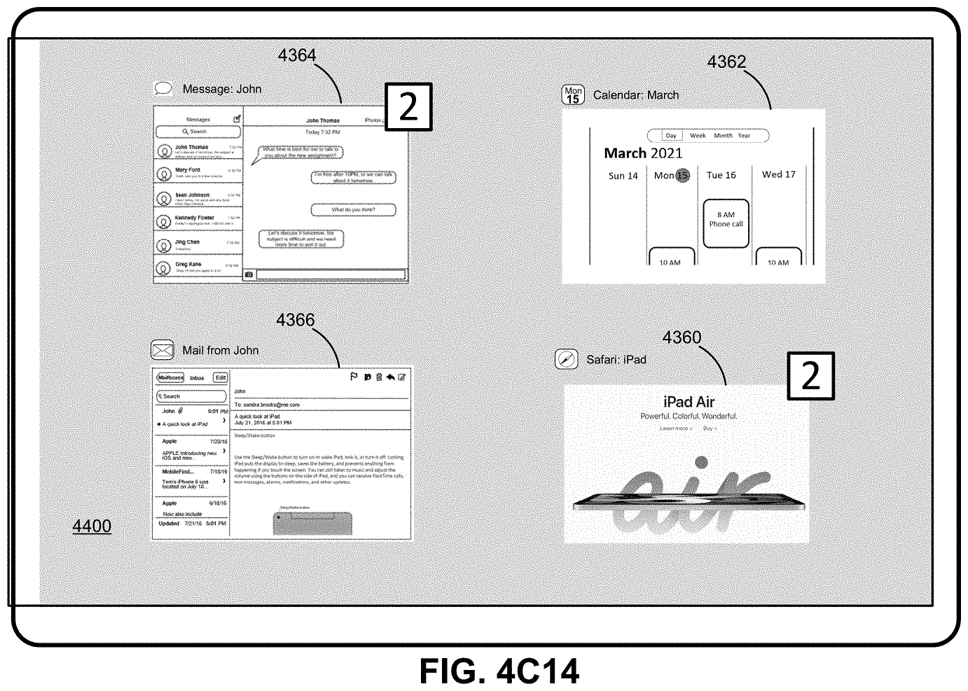

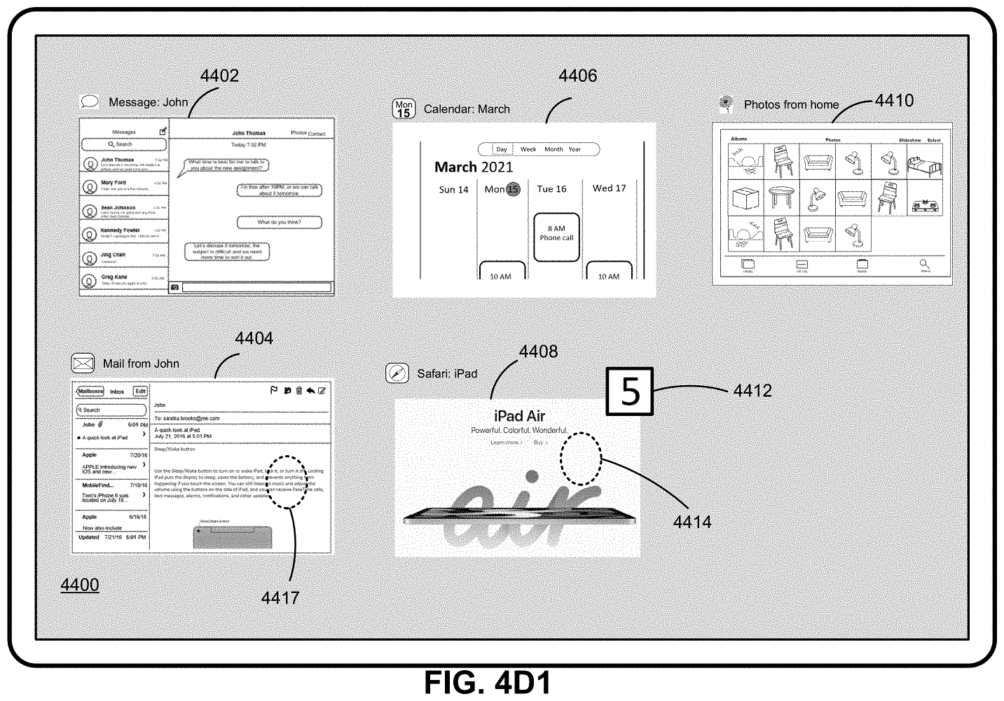

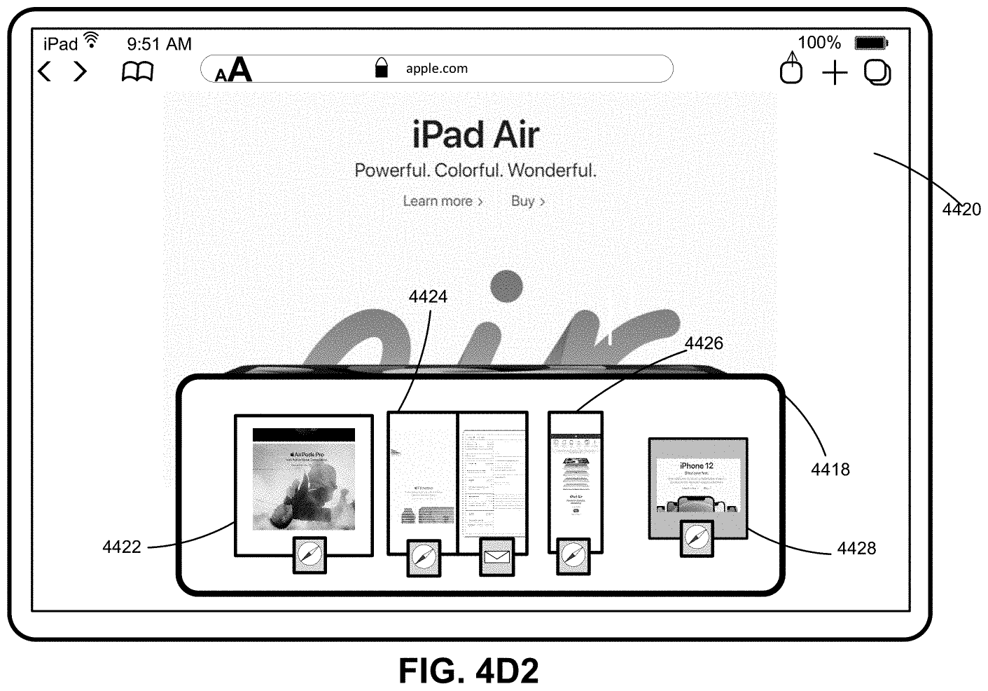

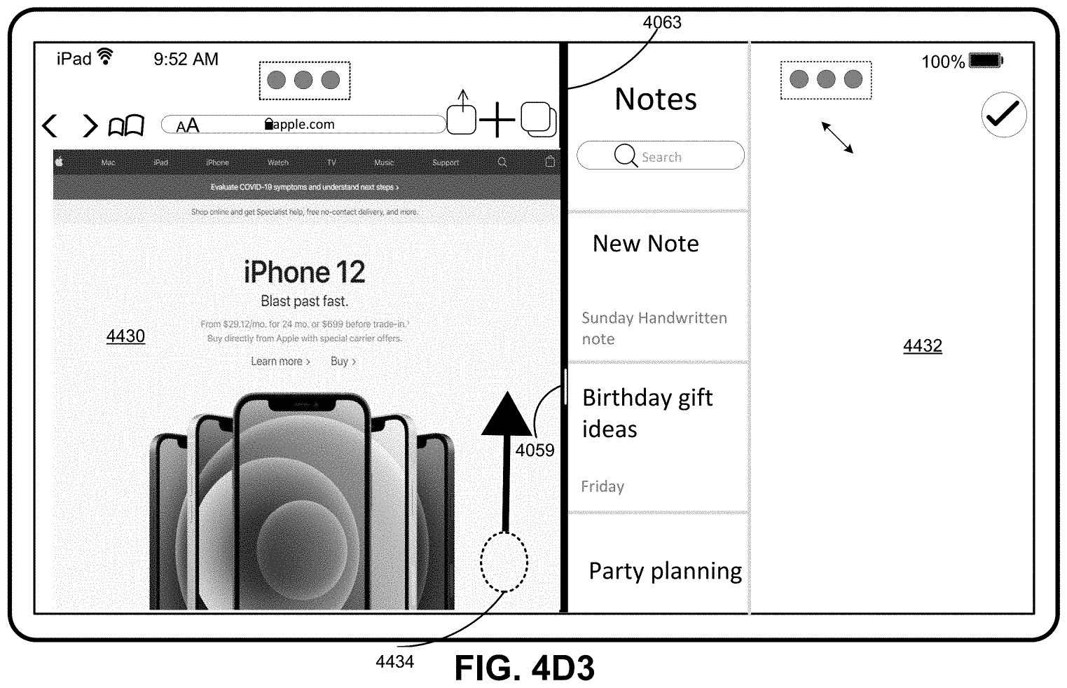

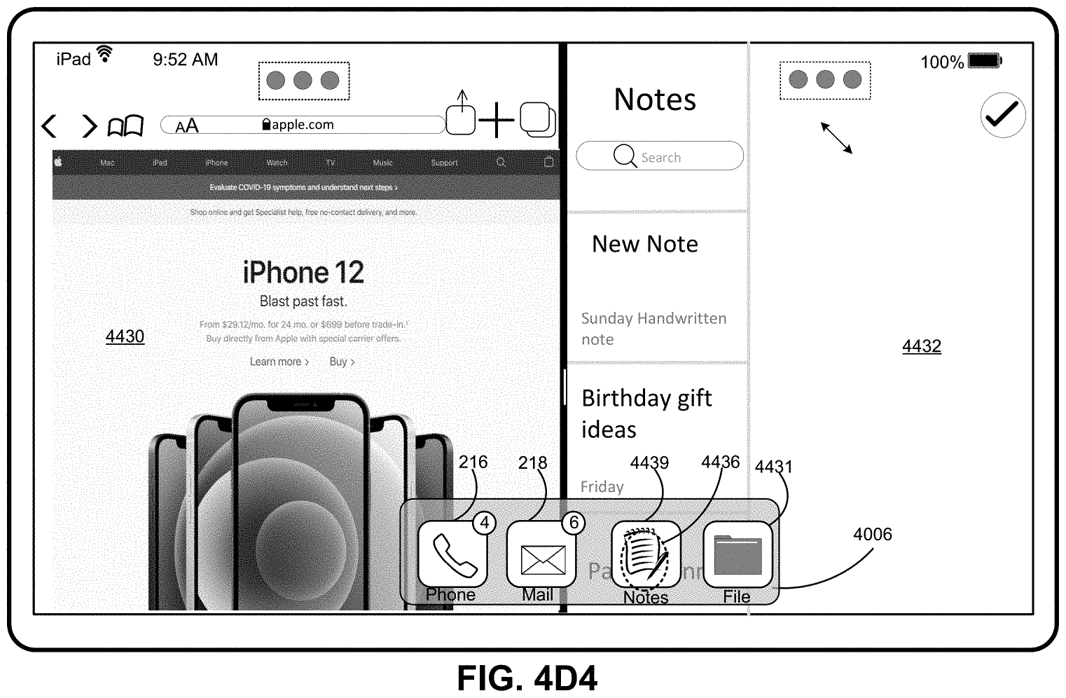

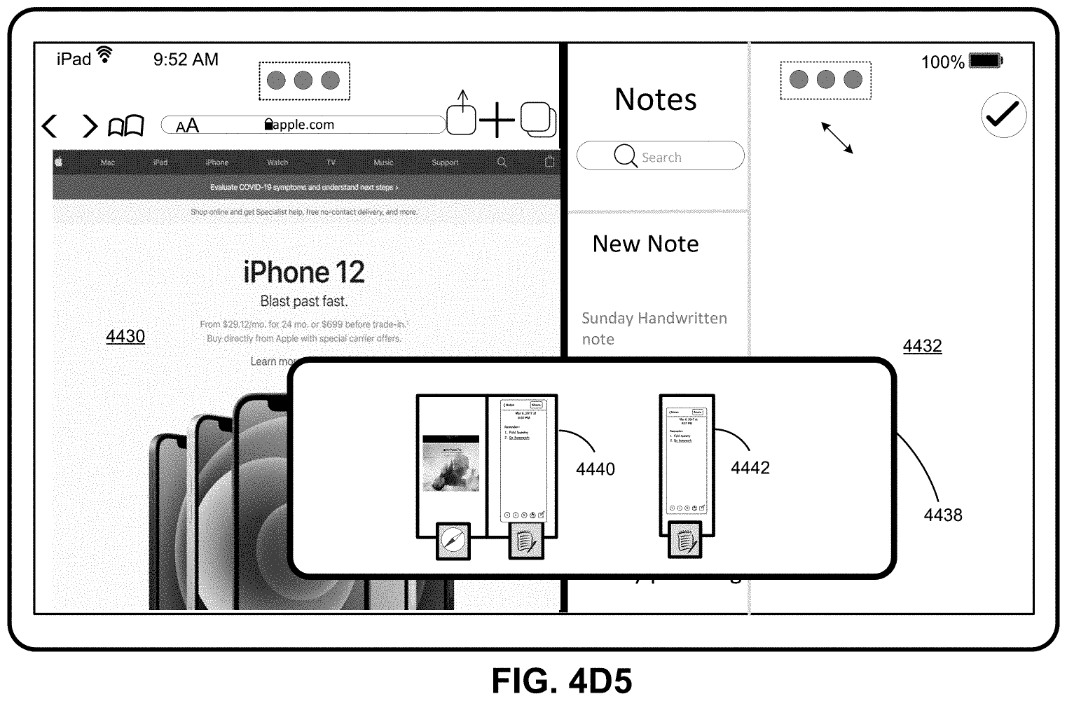

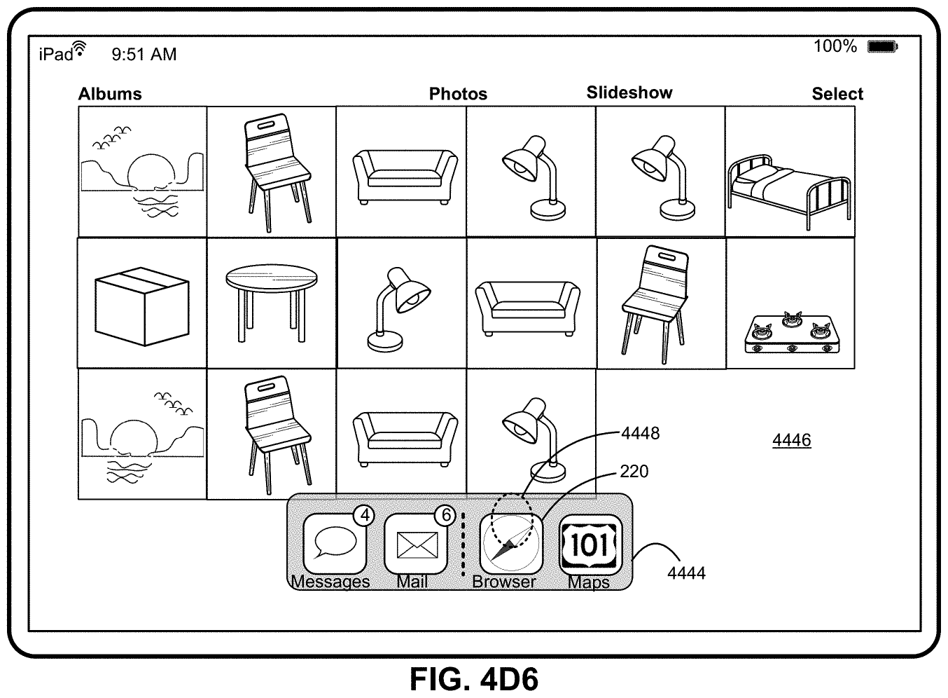

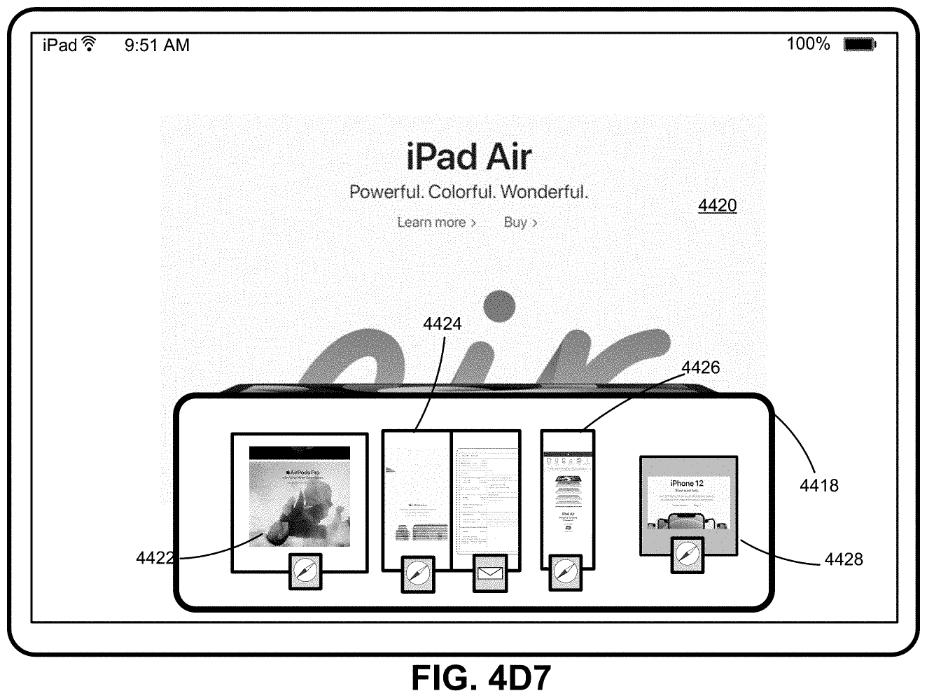

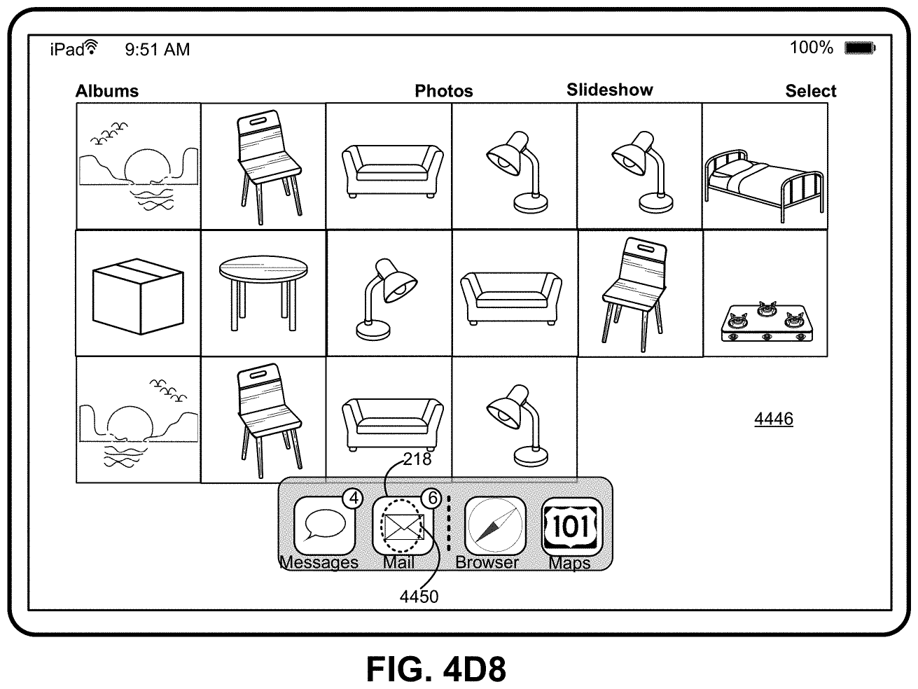

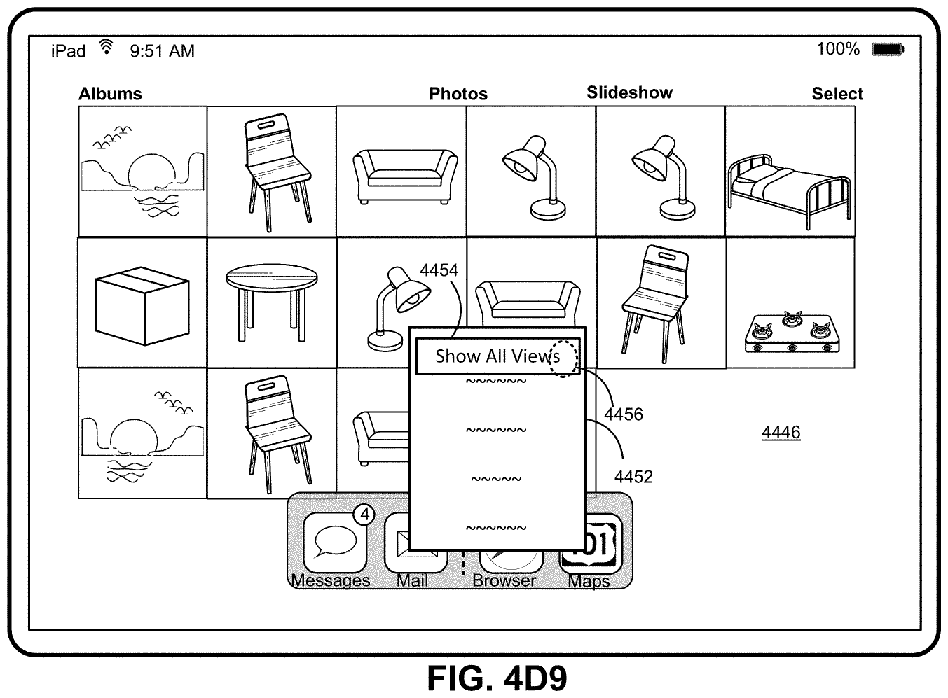

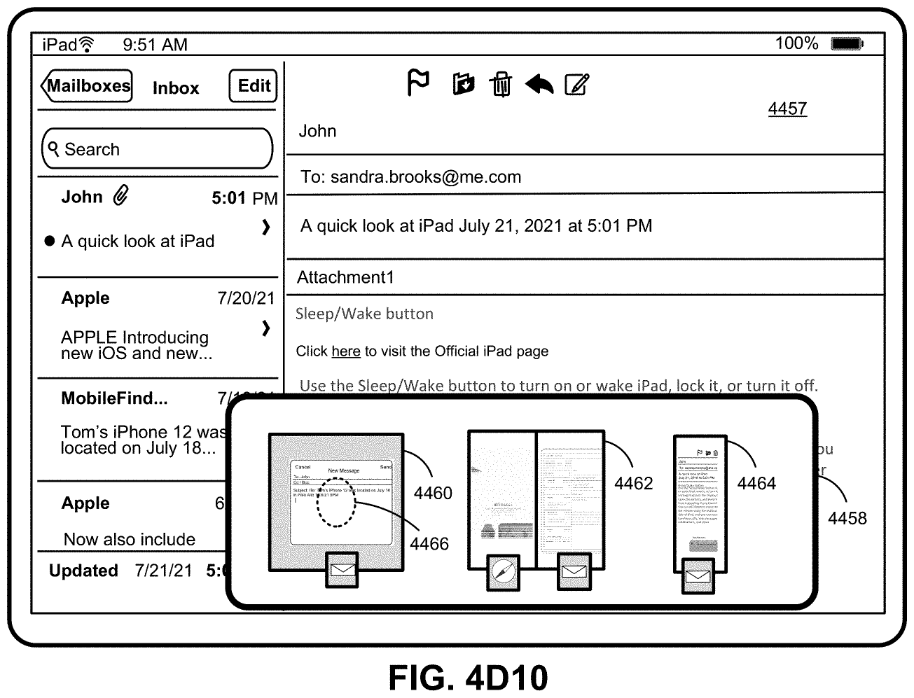

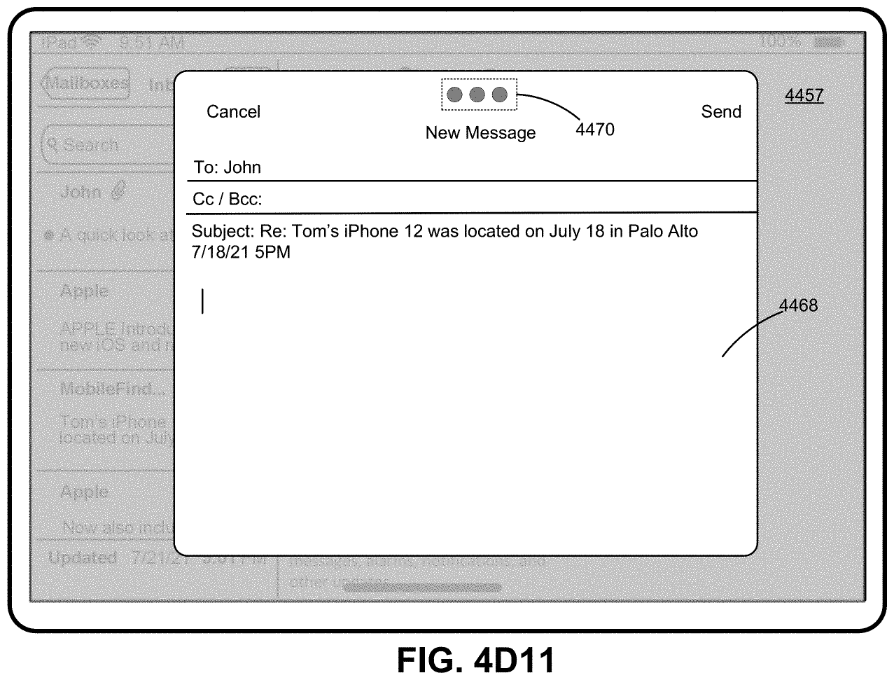

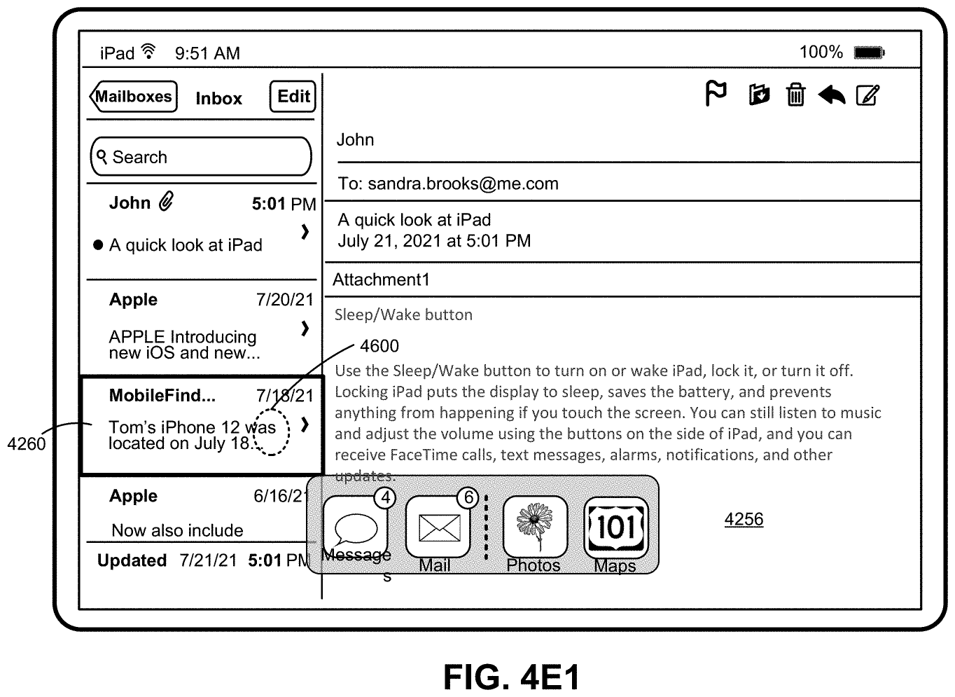

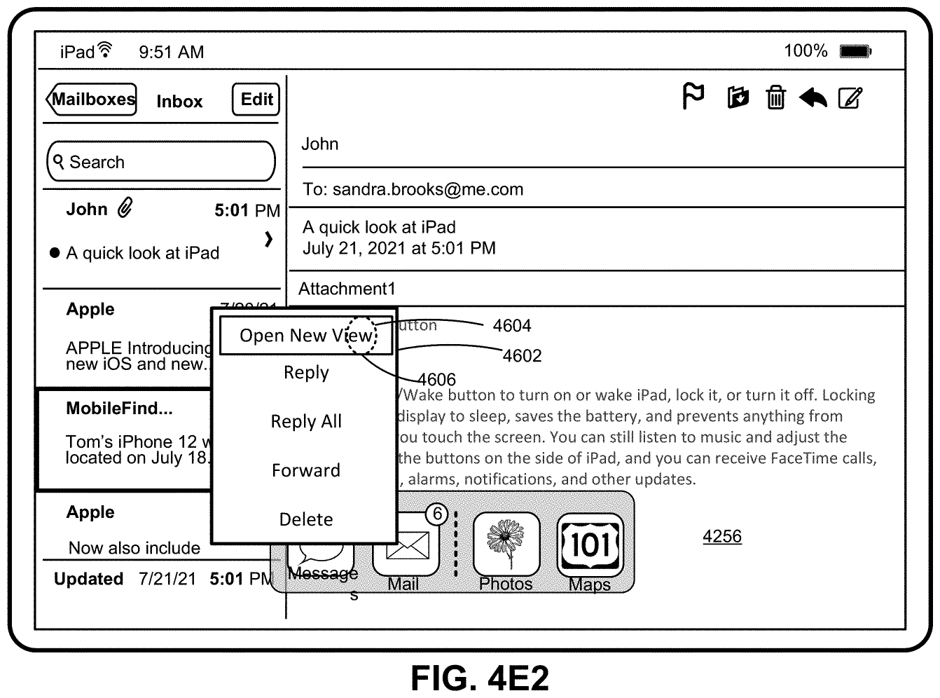

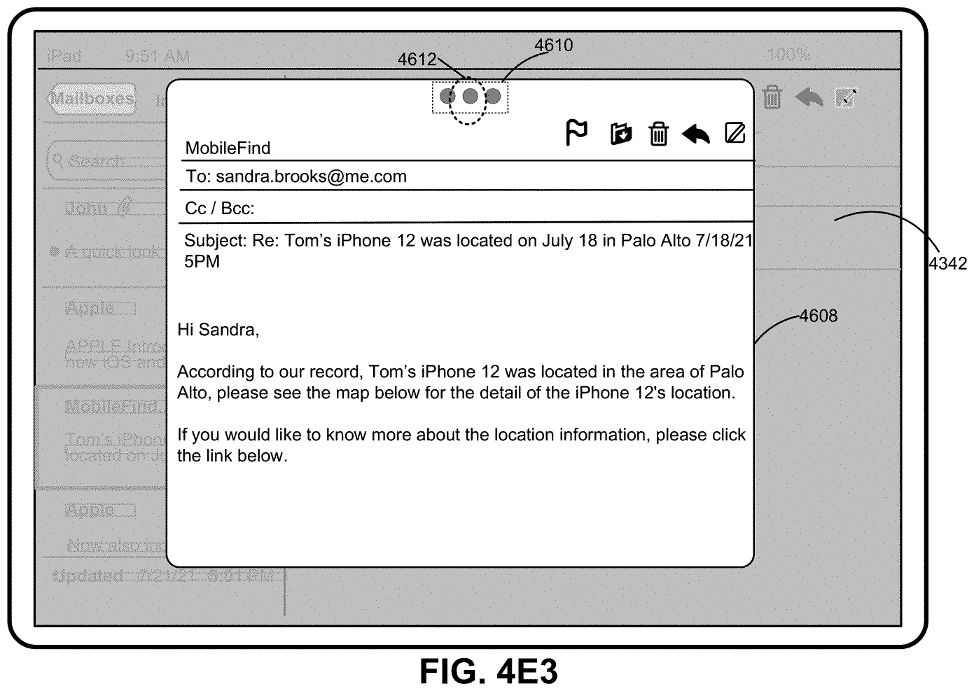

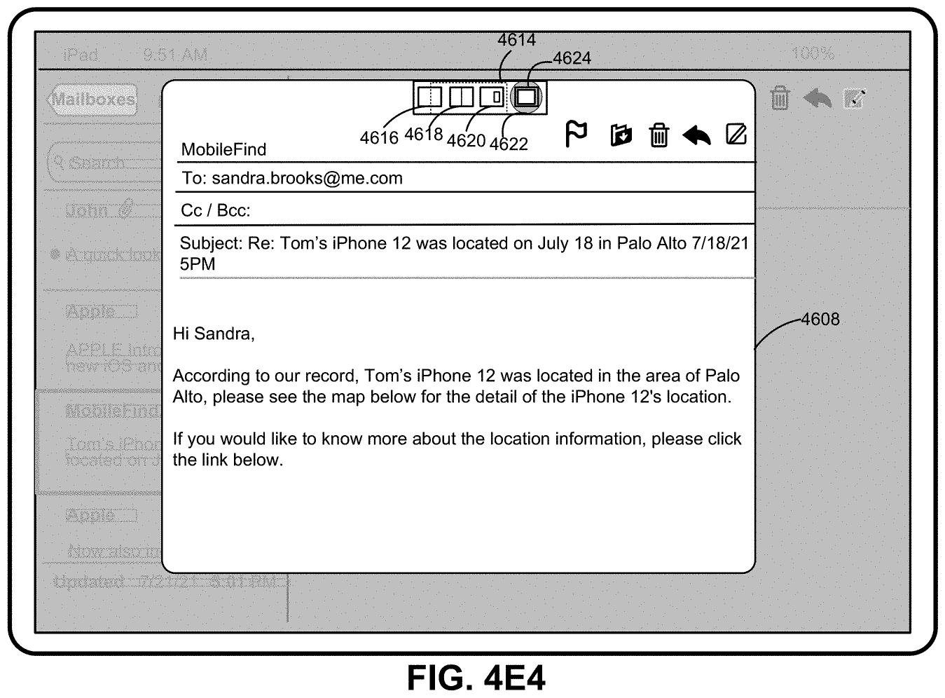

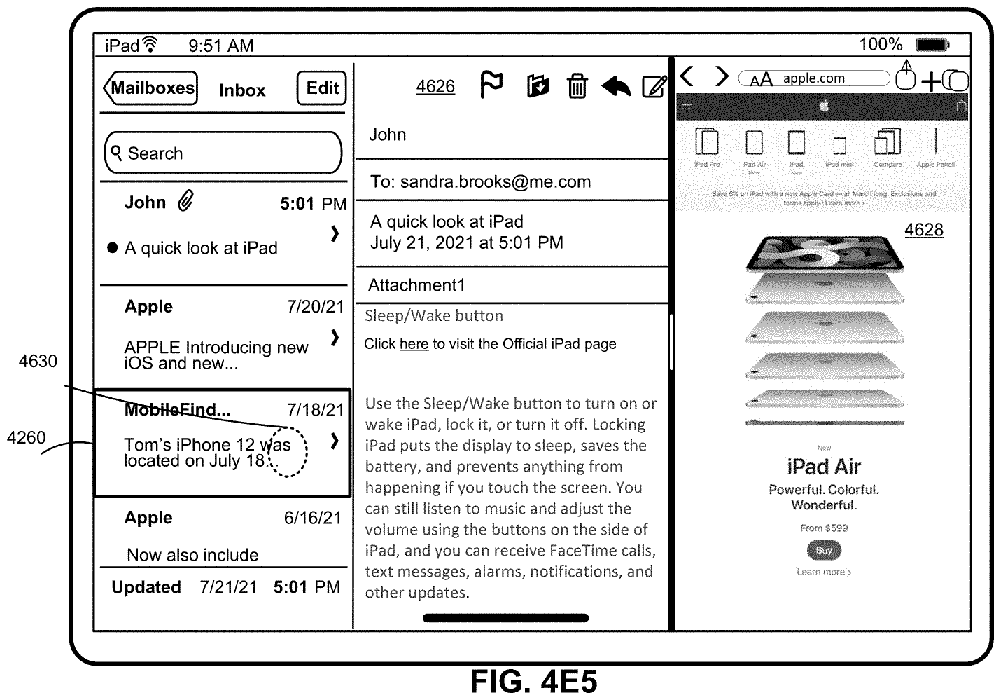

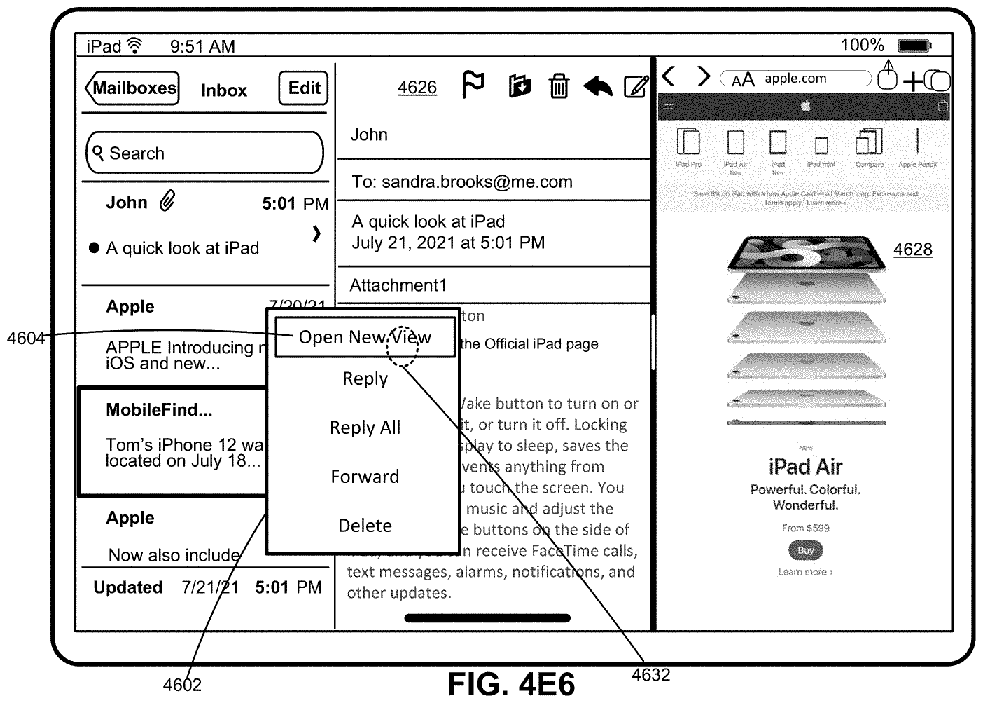

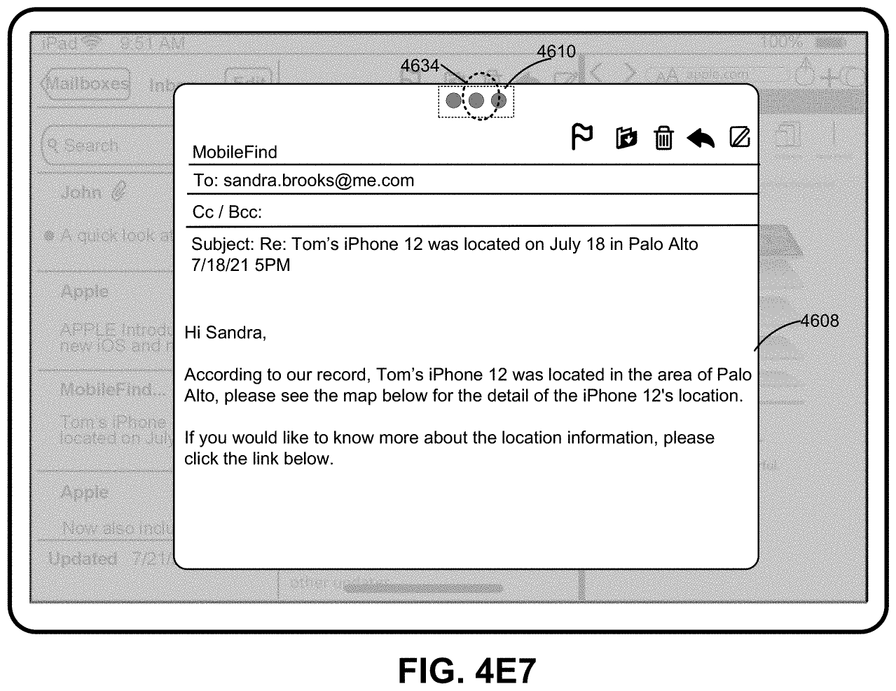

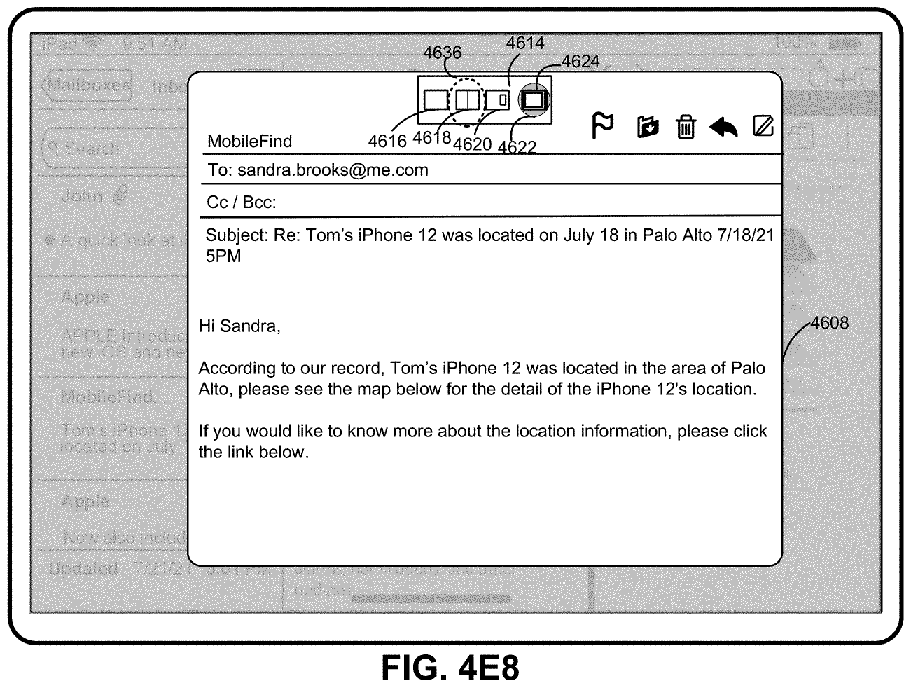

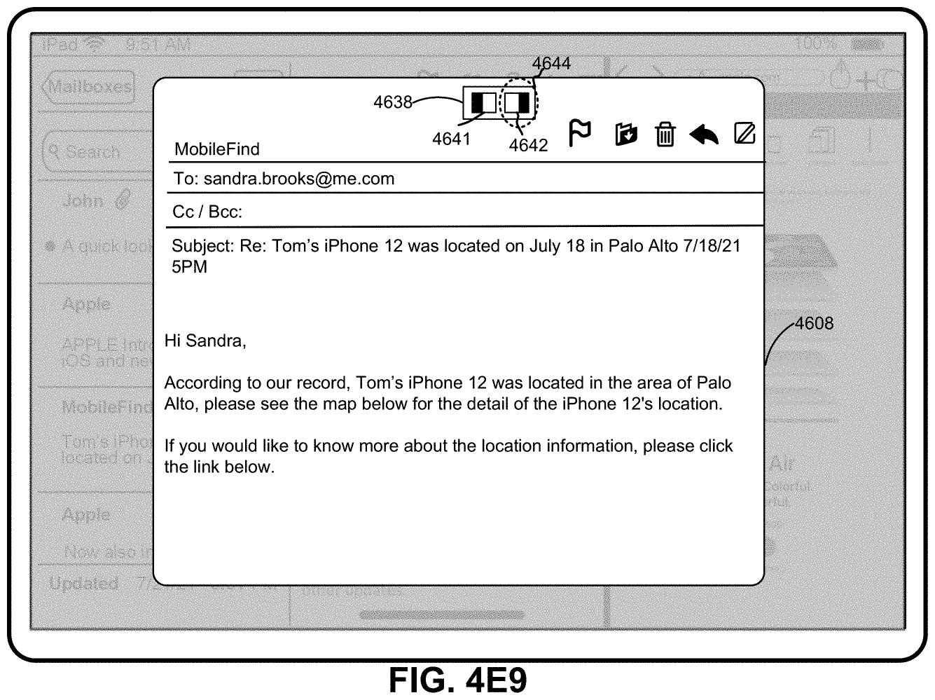

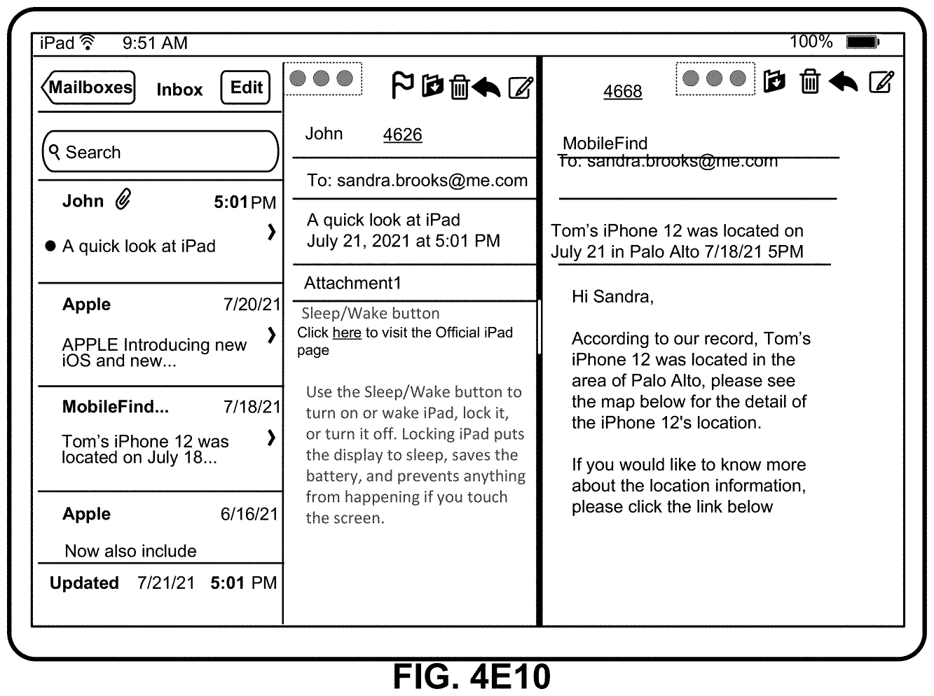

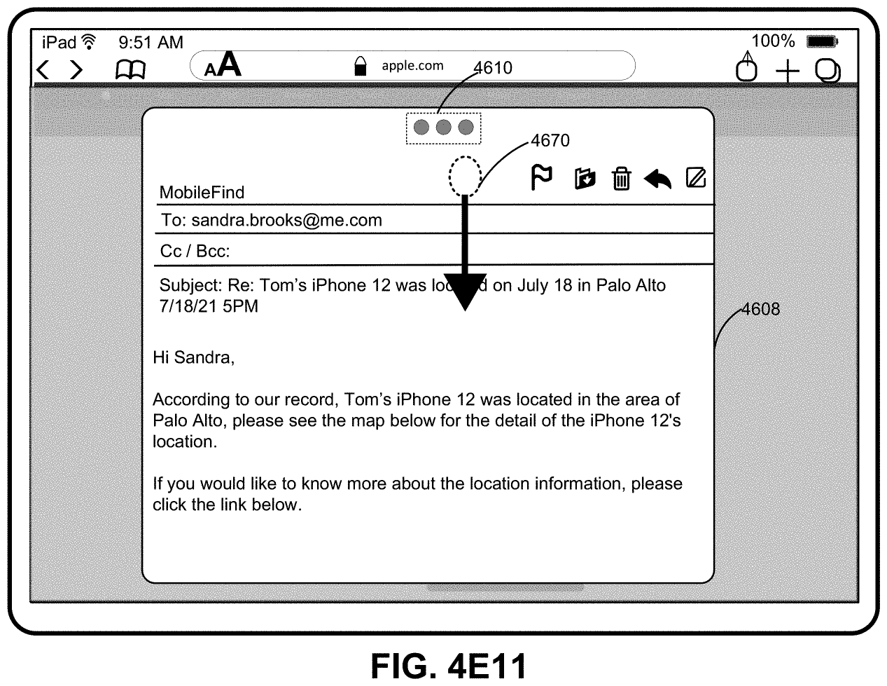

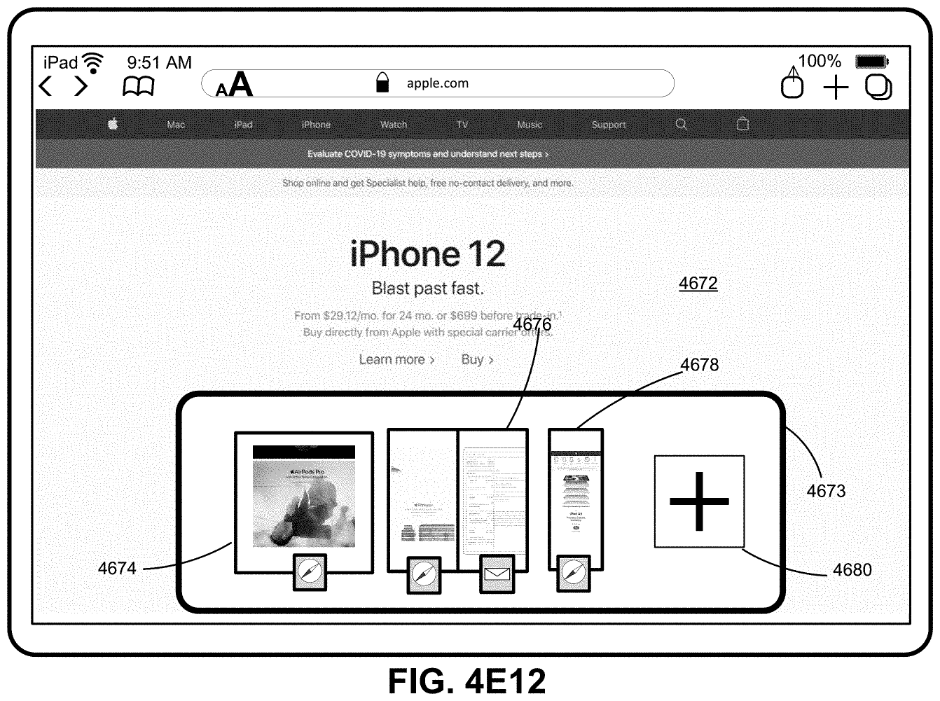

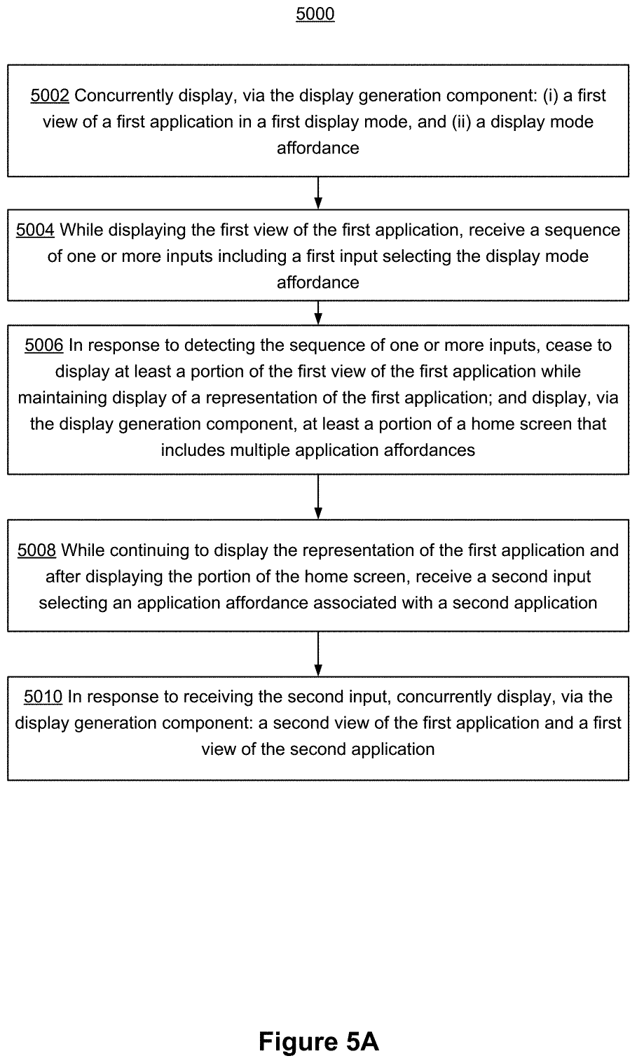

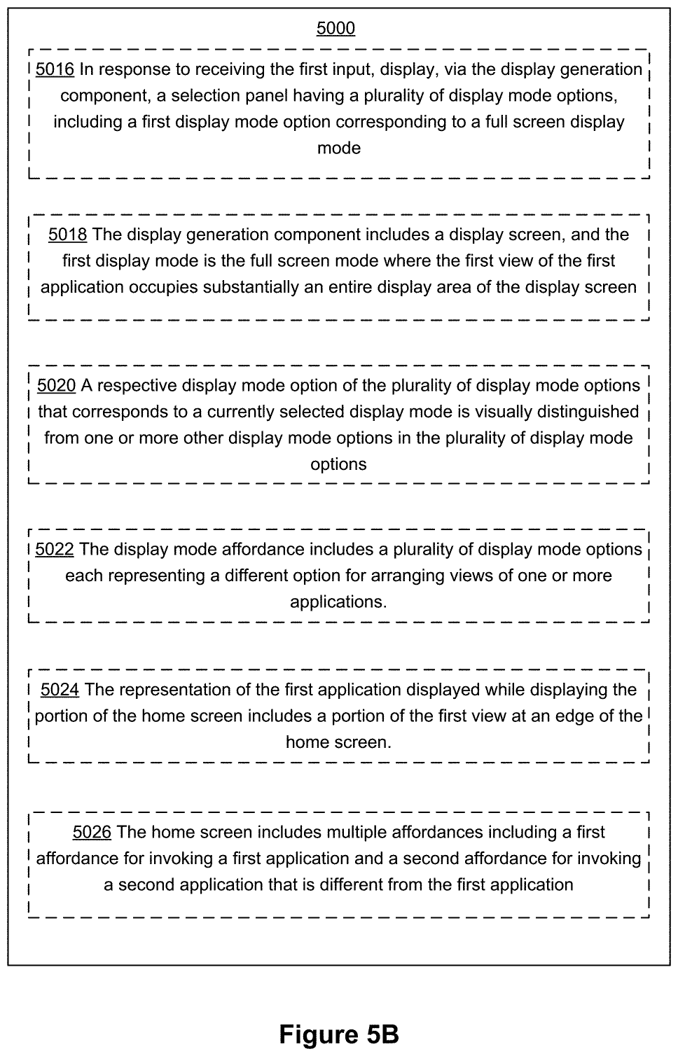

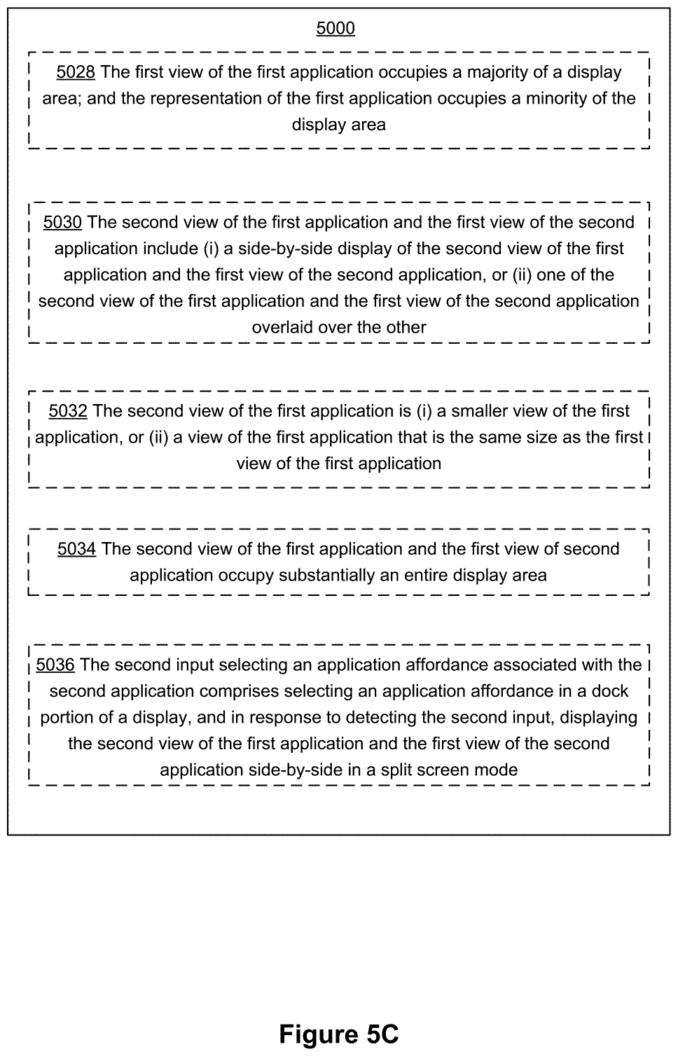

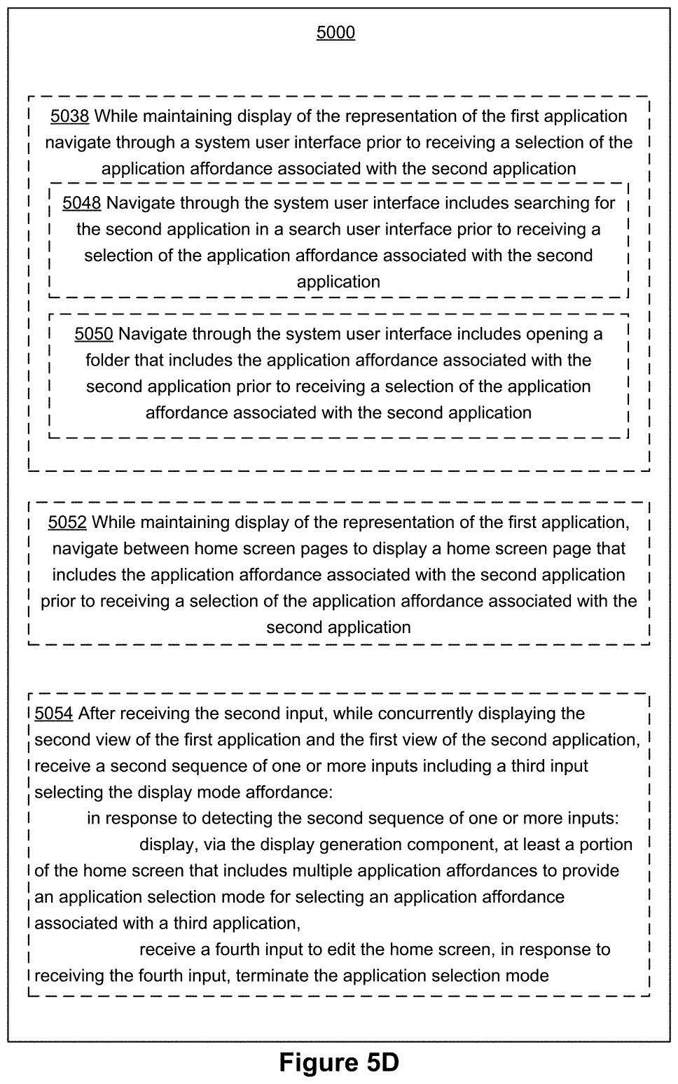

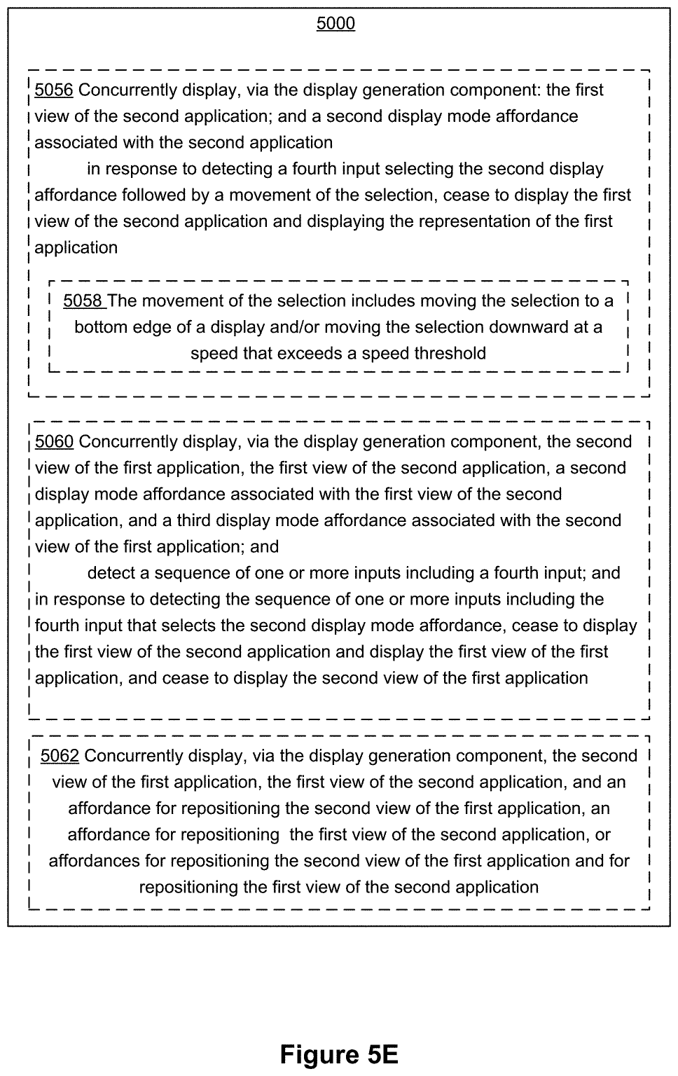

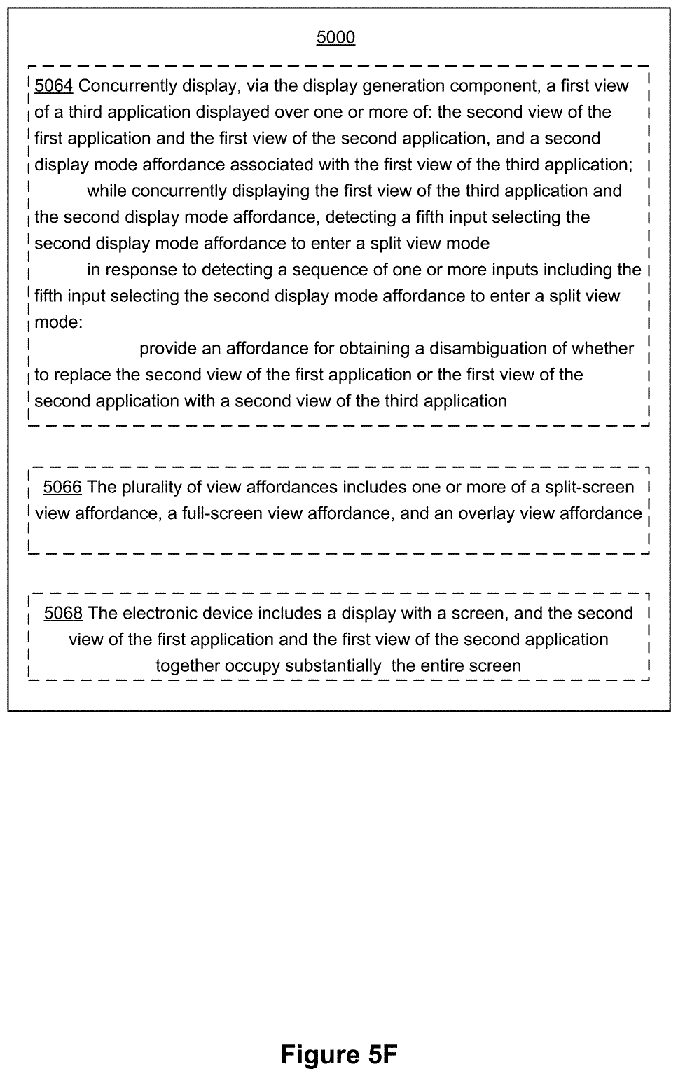

FIGS. 1A-1D and 2 provide a description of example devices. FIGS. 3A-3C illustrate examples of dynamic intensity thresholds. FIGS. 4A1-4A27, 4B1-4B22, 4C1-4C13, 4D1-4D11, and 4E1-4E12 are schematics of a touch-sensitive display used to illustrate user interfaces for simultaneously interacting with multiple applications/views, and these figures are used to illustrate the methods/processes shown in FIGS. 5, 6, 7, and 8.

### DETAILED DESCRIPTION

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The disclosure herein interchangeably refers to detecting a touch input on, at, over, on top of, or substantially within a particular user interface element or a particular portion of a touch-sensitive display. As used herein, a touch input that is detected “at” a particular user interface element could also be detected “on,” “over,” “on top of,” or “substantially within” that same user interface element, depending on the context. In some embodiments and as discussed in more detail below, desired sensitivity levels for detecting touch inputs are configured by a user of an electronic device (e.g., the user could decide (and configure the electronic device to operate) that a touch input should only be detected when the touch input is completely within a user interface element).

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the IPHONE®, IPOD TOUCH®, and IPAD® devices from APPLE Inc. of Cupertino, Calif. Other portable electronic devices, such as laptops or tablet computers with touch-sensitive surfaces (e.g., touch-sensitive displays and/or touch pads), are, optionally, used. It should also be understood that, in some embodiments, the device is not a portable communications device, but is a desktop computer with a touch-sensitive surface (e.g., a touch-sensitive display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a fitness application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable electronic devices with touch-sensitive displays. FIG. 1A is a block diagram illustrating portable multifunction device 100 (also referred to interchangeably herein as electronic device 100 or device 100) with touch-sensitive display 112 in accordance with some embodiments. Touch-sensitive display 112 is sometimes called a “touch screen” for convenience, and is sometimes known as or called a touch-sensitive display system. Device 100 includes memory 102 (which optionally includes one or more computer-readable storage mediums), controller 120, one or more processing units (CPU's) 122, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or a touchpad of device 100). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits.

Memory 102 optionally includes high-speed random access memory (e.g., DRAM, SRAM, DDR RAM or other random access solid state memory devices) and optionally also includes non-volatile memory, such as one or more magnetic disk storage devices, flash memory devices, or other non-volatile solid-state memory devices. Memory 102 optionally includes one or more storage devices remotely located from processor(s) 122. Access to memory 102 by other components of device 100, such as CPU 122 and the peripherals interface 118, is, optionally, controlled by controller 120.

Peripherals interface 118 can be used to couple input and output peripherals of the device to CPU 122 and memory 102. The one or more processors 122 run or execute various software programs and/or sets of instructions stored in memory 102 to perform various functions for device 100 and to process data.

In some embodiments, peripherals interface 118, CPU 122, and controller 120 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, and/or Wireless Fidelity (Wi-Fi) (e.g., IEEE 802.1 la, IEEE 802.1 lb, IEEE 802.1 lg and/or IEEE 802.1 ln).

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack. The headset jack provides an interface between audio circuitry 110 and removable audio input/output peripherals, such as output-only headphones or a headset with both output (e.g., a headphone for one or both ears) and input (e.g., a microphone).

I/O subsystem 106 connects input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons optionally include an up/down button for volume control of speaker 111 and/or microphone 113. The one or more buttons optionally include a push button.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, affordances (e.g., application icons), video, and any combination thereof (collectively termed “graphics”). In some embodiments, some or all of the visual output corresponds to user-interface objects.

Touch screen 112 has a touch-sensitive surface, a sensor or a set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, affordances (e.g., application icons), web pages or images) that are displayed on touch screen 112. In an example embodiment, a point of contact between touch screen 112 and the user corresponds to an area under a finger of the user.

Touch screen 112 optionally uses LCD (liquid crystal display) technology, LPD (light emitting polymer display) technology, or LED (light emitting diode) technology, or OLED (organic light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an example embodiment, projected mutual capacitance sensing technology is used, such as that found in the IPHONE®, IPOD TOUCH®, and IPAD® from APPLE Inc. of Cupertino, Calif.

Touch screen 112 optionally has a video resolution in excess of 400 dpi. In some embodiments, touch screen 112 has a video resolution of at least 600 dpi. In other embodiments, touch screen 112 has a video resolution of at least 1000 dpi. The user optionally makes contact with touch screen 112 using any suitable object or digit, such as a stylus or a finger. In some embodiments, the user interface is designed to work primarily with finger-based contacts and gestures. In some embodiments, the device translates the finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)), and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen 112 on the front of the device, so that the touch-sensitive display is enabled for use as a viewfinder for still and/or video image acquisition. In some embodiments, another optical sensor is located on the front of the device so that the user's image is, optionally, obtained for videoconferencing while the user views the other video conference participants on the touch-sensitive display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen 112 which is located on the front of device 100.

Device 100 optionally also includes one or more proximity sensors 166. FIG. 1A shows proximity sensor 166 coupled to peripherals interface 118. Alternately, proximity sensor 166 is coupled to input controller 160 in I/O subsystem 106. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch-sensitive display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIG. 1A. Device/global internal state 157 includes one or more of: active application state, indicating which applications, if any, are currently active; display state, indicating what applications, views or other information occupy various regions of touch-sensitive display 112; sensor state, including information obtained from the device's various sensors and input control devices 116; and location information concerning the device's location and/or attitude (e.g., orientation of the device). In some embodiments, device/global internal state 157 communicates with multitasking module 180 to keep track of applications activated in a multitasking mode (also referred to as a shared screen view, shared screen mode, or multitask mode). In this way, if device 100 is rotated from portrait to landscape display mode, multitasking module 180 is able to retrieve multitasking state information (e.g., display areas for each application in the multitasking mode) from device/global internal state 157, in order to reactivate the multitasking mode after switching from portrait to landscape. Additional embodiments of stateful application behavior in multitasking mode are discussed in reference to FIGS. 43A-45C below.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on some embodiments of IPOD devices from APPLE Inc. In other embodiments, the external port is a multi-pin (e.g., 8-pin) connector that is the same as, or similar to and/or compatible with the 8-pin connector used in LIGHTNING connectors from APPLE Inc.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has selected or “clicked” on an affordance). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch-sensitive display can be set to any of a large range of predefined thresholds values without changing the trackpad or touch-sensitive display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and, in some embodiments, subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including without limitation text, web pages, affordances (e.g., application icons) (such as user-interface objects including soft keys), digital images, videos, animations and the like.

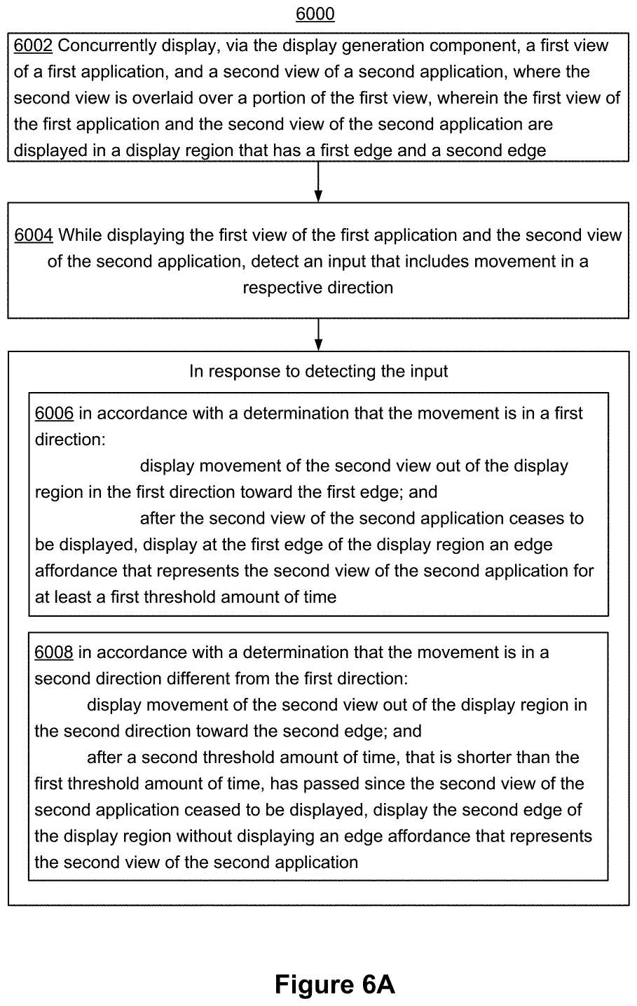

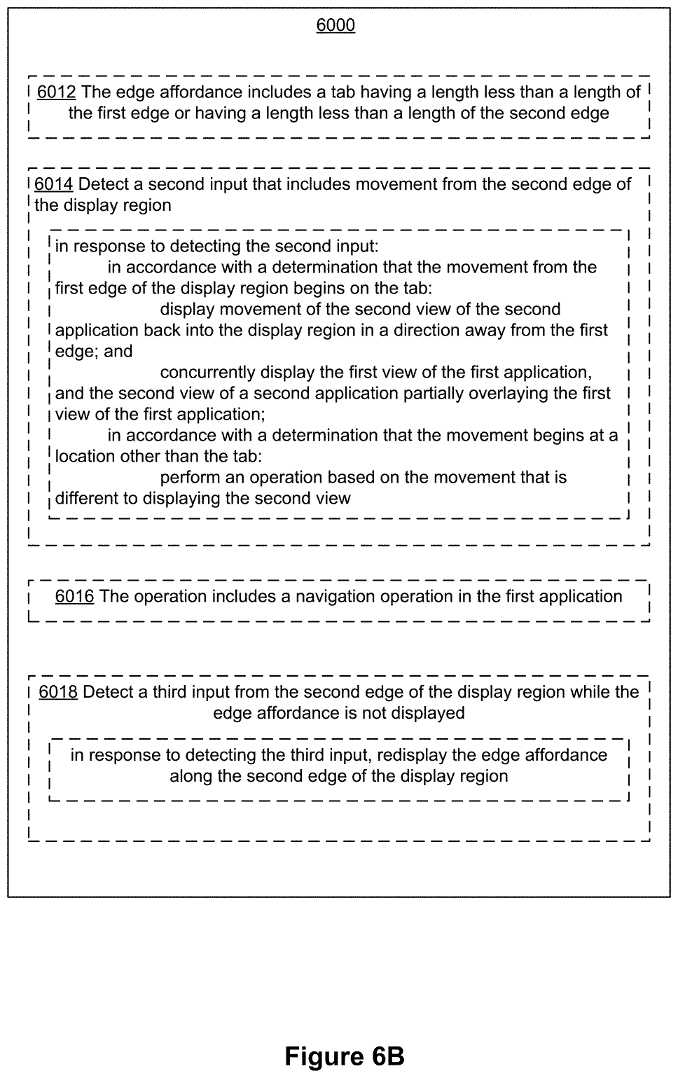

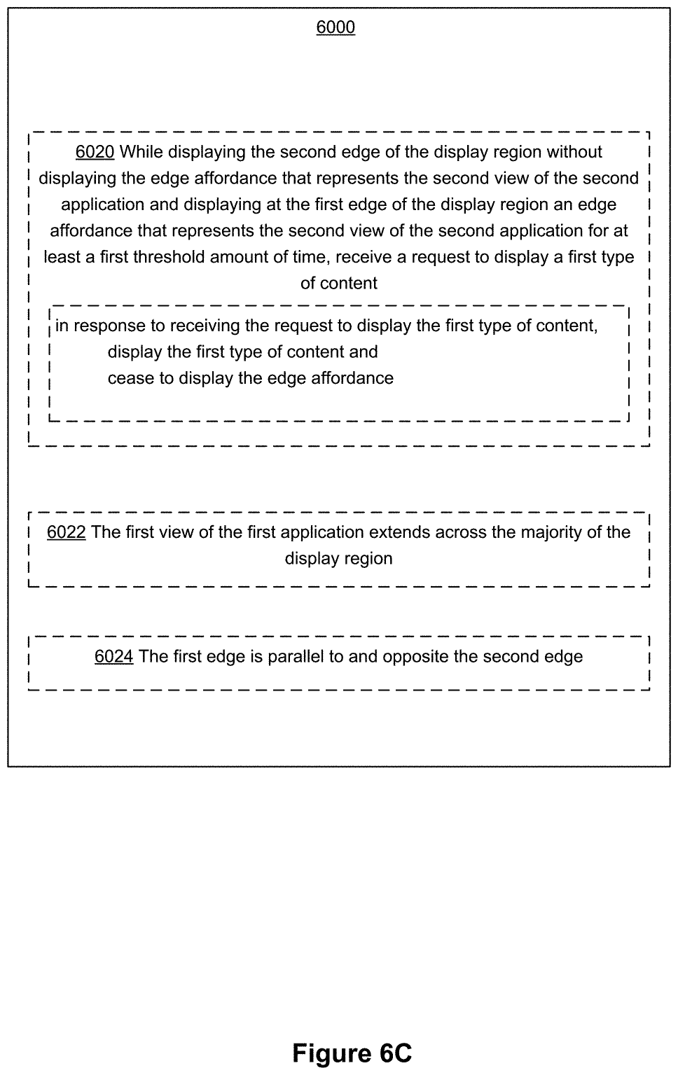

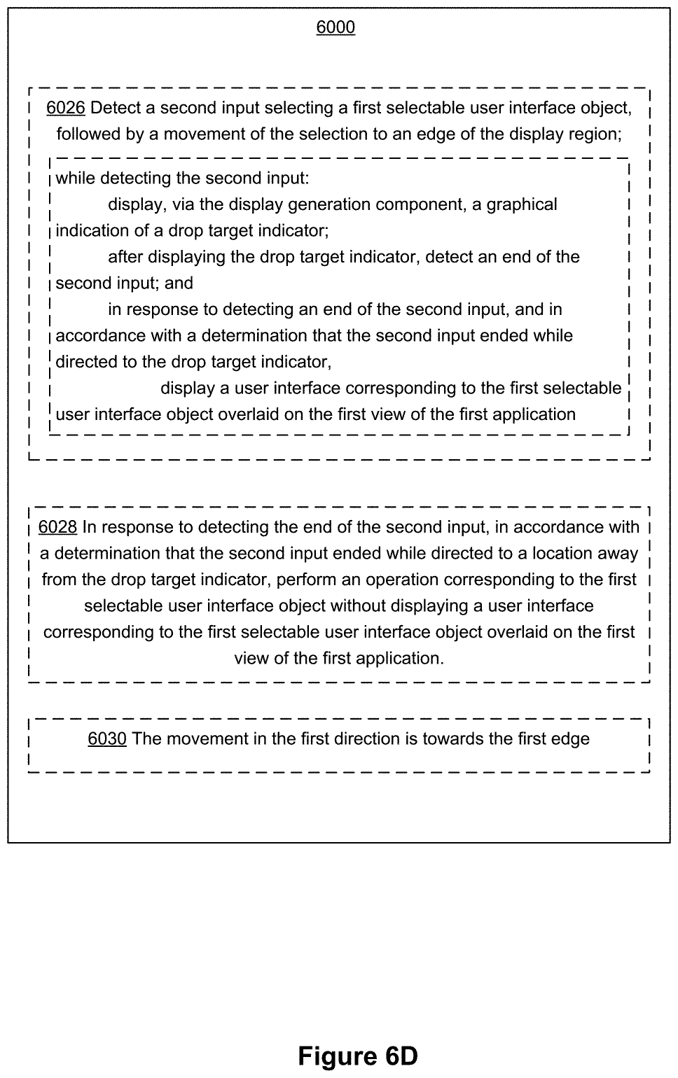

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinating data and other graphic property data, and then generates screen image data to output to display controller 156. In some embodiments, graphics module 132 retrieves graphics stored with multitasking data 176 of each application 136 (FIG. 1B). In some embodiments, multitasking data 176 stores multiple graphics of different sizes, so that an application is capable of quickly resizing while in a shared screen mode (resizing applications is discussed in more detail below with reference to FIGS. 6A-6J, 37A-37G, and 40A-40D).

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications (“apps”) 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
fitness module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, website creation applications, disk authoring applications, spreadsheet applications, JAVA-enabled applications, encryption, digital rights management, voice recognition, widget creator module for making user-created widgets 149-6, and voice replication.

In conjunction with touch screen 112, display controller 156, contact module 130, graphics module 132, and text input module 134, contacts module 137 is, optionally, used to manage an address book or contact list (e.g., stored in contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conferencing module 139, e-mail client module 140, or IM module 141; and so forth.

In conjunction with RF circuitry 108, audio circuitry 110, speaker 111, microphone 113, touch screen 112, display controller 156, contact module 130, graphics module 132, and text input module 134, telephone module 138 is, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, video conferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files, and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and video and music player module 146, fitness module 142 includes executable instructions to create workouts (e.g., with time, distance, and/or calorie burning goals), communicate with workout sensors (sports devices such as a watch or a pedometer), receive workout sensor data, calibrate sensors used to monitor a workout, select and play music for a workout, and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, a widget creator module (not pictured) is, optionally, used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an IPOD from APPLE Inc.

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 is, optionally, used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

As pictured in FIG. 1A, portable multifunction device 100 also includes a multitasking module 180 for managing multitasking operations on device 100 (e.g., communicating with graphics module 132 to determine appropriate display areas for concurrently displayed applications). Multitasking module 180 optionally includes the following modules (or sets of instructions), or a subset or superset thereof:
application selector 182;
compatibility module 184;
picture-in-picture (PIP)/overlay module 186; and
multitasking history 188 for storing information about a user's multitasking history (e.g., commonly-used applications in multitasking mode, recent display areas for applications while in the multitasking mode, applications that are pinned together for display in the split-view/multitasking mode, etc.).

In conjunction with touch screen 112, display controller 156, contact module 130, graphics module 132, and contact intensity sensor(s) 165, application selector 182 includes executable instructions to display affordances corresponding to applications (e.g., one or more of applications 136) and allow users of device 100 to select affordances for use in a multitasking/split-view mode (e.g., a mode in which more than one application is displayed and active on touch screen 112 at the same time). In some embodiments, the application selector 182 is a dock (e.g., the dock 408 described below).

In conjunction with touch screen 112, display controller 156, contact module 130, graphics module 132, and application selector 182, compatibility module 184 includes executable instructions to determine whether a particular application is compatible with a multitasking mode (e.g., by checking a flag, such as a flag stored with multitasking data 176 for each application 136, as pictured in FIG. 1B).

In conjunction with touch screen 112, display controller 156, contact module 130, graphics module 132, and contact intensity sensor(s) 165, PIP/overlay module 186 includes executable instructions to determine reduced sizes for applications that will be displayed as overlaying another application and to determine an appropriate location on touch screen 112 for displaying the reduced size application (e.g., a location that avoids important content within an active application that is overlaid by the reduced size application).

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) includes event sorter 170 (e.g., in operating system 126) and a respective application 136-1 selected from among the applications 136 of portable multifunction device 100 (FIG. 1A) (e.g., any of the aforementioned applications stored in memory 102 with applications 136).

Event sorter 170 receives event information and determines the application 136-1 and application view 175 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 175 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user. In some embodiments, application internal state 192 is used by multitasking module 180 to help facilitate multitasking operations (e.g., multitasking module 180 retrieves resume information from application internal state 192 in order to re-display a previously dismissed side application).

In some embodiments, each application 136-1 stores multitasking data 176. In some embodiments, multitasking data 176 includes a compatibility flag (e.g., a flag accessed by compatibility module 184 to determine whether a particular application is compatible with multitasking mode), a list of compatible sizes for displaying the application 136-1 in the multitasking mode (e.g., ¼, ⅓, ½, or full-screen), and various sizes of graphics (e.g., different graphics for each size within the list of compatible sizes).

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface views, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 178). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 181.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 177 and one or more application views 175, each of which includes instructions for handling touch events that occur within a respective view of the application's user interface. Each application view 175 of the application 136-1 includes one or more event recognizers 180. Typically, a respective application view 175 includes a plurality of event recognizers 180. In other embodiments, one or more of event recognizers 180 are part of a separate module, such as a user interface kit or a higher level object from which application 136-1 inherits methods and other properties. In some embodiments, a respective event handler 177 includes one or more of: data updater 177-1, object updater 177-2, GUI updater 177-3, and/or event data 179 received from event sorter 170. Event handler 177 optionally utilizes or calls data updater 177-1, object updater 177-2 or GUI updater 177-3 to update the application internal state 192. Alternatively, one or more of the application views 175 includes one or more respective event handlers 177. Also, in some embodiments, one or more of data updater 177-1, object updater 177-2, and GUI updater 177-3 are included in a respective application view 175.

A respective event recognizer 178 receives event information (e.g., event data 179) from event sorter 170, and identifies an event from the event information. Event recognizer 178 includes event receiver 181 and event comparator 183. In some embodiments, event recognizer 178 also includes at least a subset of: metadata 189, and event delivery instructions 190 (which optionally include sub-event delivery instructions).

Event receiver 181 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from portrait to landscape, or vice versa), and the event information includes corresponding information about the current orientation (also called device attitude) of the device.

Event comparator 183 compares the event information to predefined event or sub-event definitions and, based on the comparison, determines an event or sub-event, or determines or updates the state of an event or sub-event. In some embodiments, event comparator 183 includes event definitions 185. Event definitions 185 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 177.

In some embodiments, event definition 186 includes a definition of an event for a respective user-interface object. In some embodiments, event comparator 183 performs a hit test to determine which user-interface object is associated with a sub-event. For example, in an application view in which three user-interface objects are displayed on touch-sensitive display 112, when a touch is detected on touch-sensitive display 112, event comparator 183 performs a hit test to determine which of the three user-interface objects is associated with the touch (sub-event). If each displayed object is associated with a respective event handler 177, the event comparator uses the result of the hit test to determine which event handler 177 should be activated. For example, event comparator 183 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 178 determines that the series of sub-events do not match any of the events in event definitions 185, the respective event recognizer 178 enters an event impossible, event failed, or event ended state, after which it disregards subsequent sub-events of the touch-based gesture. In this situation, other event recognizers, if any remain active for the hit view, continue to track and process sub-events of an ongoing touch-based gesture.

In some embodiments, a respective event recognizer 178 includes metadata 189 with configurable properties, flags, and/or lists that indicate how the event delivery system should perform sub-event delivery to actively involved event recognizers. In some embodiments, metadata 189 includes configurable properties, flags, and/or lists that indicate how event recognizers interact, or are enabled to interact, with one another. In some embodiments, metadata 189 includes configurable properties, flags, and/or lists that indicate whether sub-events are delivered to varying levels in the view or programmatic hierarchy.

In some embodiments, a respective event recognizer 178 activates event handler 177 associated with an event when one or more particular sub-events of an event are recognized. In some embodiments, a respective event recognizer 178 delivers event information associated with the event to event handler 177. Activating an event handler 177 is distinct from sending (and deferred sending) sub-events to a respective hit view. In some embodiments, event recognizer 178 throws a flag associated with the recognized event, and event handler 177 associated with the flag catches the flag and performs a predefined process.

In some embodiments, event delivery instructions 190 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 177-1 creates and updates data used in application 136-1. For example, data updater 177-1 updates the telephone number used in contacts module 137, or stores a video file used in video and music player module 145. In some embodiments, object updater 177-2 creates and updates objects used in application 136-1. For example, object updater 177-2 creates a new user-interface object or updates the position of a user-interface object. GUI updater 177-3 updates the GUI. For example, GUI updater 177-3 prepares display information and sends it to graphics module 132 for display on a touch-sensitive display. In some embodiments, GUI updater 177-3 communicates with multitasking module 180 in order to facilitate resizing of various applications displayed in a multitasking mode.

In some embodiments, event handler(s) 177 includes or has access to data updater 177-1, object updater 177-2, and GUI updater 177-3. In some embodiments, data updater 177-1, object updater 177-2, and GUI updater 177-3 are included in a single module of a respective application 136-1 or application view 175. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof is optionally utilized as inputs corresponding to sub-events which define an event to be recognized.

FIG. 1C is a schematic of a portable multifunction device (e.g., portable multifunction device 100) having a touch-sensitive display (e.g., touch screen 112) in accordance with some embodiments. The touch-sensitive display optionally displays one or more graphics within user interface (UI) 201a. In this embodiment, as well as others described below, a user can select one or more of the graphics by making a gesture on the screen, for example, with one or more fingers or one or more styluses. In some embodiments, selection of one or more graphics occurs when the user breaks contact with the one or more graphics (e.g., by lifting a finger off of the screen). In some embodiments, the gesture optionally includes one or more tap gestures (e.g., a sequence of touches on the screen followed by liftoffs), one or more swipe gestures (continuous contact during the gesture along the surface of the screen, e.g., from left to right, right to left, upward and/or downward), and/or a rolling of a finger (e.g., from right to left, left to right, upward and/or downward) that has made contact with device 100. In some implementations or circumstances, inadvertent contact with a graphic does not select the graphic. For example, a swipe gesture that sweeps over an application affordance (e.g., an icon) optionally does not launch (e.g., open) the corresponding application when the gesture for launching the application is a tap gesture.

Device 100 optionally also includes one or more physical buttons, such as a “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch screen 112. Additional details and alternative configurations of the home button 204 are also provided below in reference to FIG. 5J below.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 1D is a schematic used to illustrate a user interface on a device (e.g., device 100, FIG. 1A) with a touch-sensitive surface 195 (e.g., a tablet or touchpad) that is separate from the display 194 (e.g., touch screen 112). In some embodiments, touch-sensitive surface 195 includes one or more contact intensity sensors (e.g., one or more of contact intensity sensor(s) 359) for detecting intensity of contacts on touch-sensitive surface 195 and/or one or more tactile output generator(s) 357 for generating tactile outputs for a user of touch-sensitive surface 195.

Although some of the examples which follow will be given with reference to inputs on touch screen 112 (where the touch sensitive surface and the display are combined), in some embodiments, the device detects inputs on a touch-sensitive surface that is separate from the display, as shown in FIG. 1D. In some embodiments the touch sensitive surface (e.g., 195 in FIG. 1D) has a primary axis (e.g., 199 in FIG. 1D) that corresponds to a primary axis (e.g., 198 in FIG. 1D) on the display (e.g., 194). In accordance with these embodiments, the device detects contacts (e.g., 197-1 and 197-2 in FIG. 1D) with the touch-sensitive surface 195 at locations that correspond to respective locations on the display (e.g., in FIG. 1D, 197-1 corresponds to 196-1 and 197-2 corresponds to 196-2). In this way, user inputs (e.g., contacts 197-1 and 197-2, and movements thereof) detected by the device on the touch-sensitive surface (e.g., 195 in FIG. 1D) are used by the device to manipulate the user interface on the display (e.g., 194 in FIG. 1D) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touch-sensitive surface 195 in FIG. 1D (touch-sensitive surface 195, in some embodiments, is a touchpad)) while the cursor is over a particular user interface element (e.g., a button, view, slider or other user interface element), the particular user interface element is adjusted in accordance with the detected input. In some implementations that include a touch-screen display (e.g., touch-sensitive display system 112 in FIG. 1A or touch screen 112) that enables direct interaction with user interface elements on the touch-screen display, a detected contact on the touch-screen acts as a “focus selector,” so that when an input (e.g., a press input) is detected on the touch-screen display at a location of a particular user interface element (e.g., a button, view, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch-sensitive display) will indicate that the user is intending to activate the respective button (as opposed to other user interface elements shown on a display of the device).

As used in the specification and claims, the term “intensity” of a contact on a touch-sensitive surface refers to the force or pressure (force per unit area) of a contact (e.g., a finger contact or a stylus contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average or a sum) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be readily accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of the portable computing system or device 100). For example, a mouse “click” threshold of a trackpad or touch-screen display can be set to any of a large range of predefined thresholds values without changing the trackpad or touch-screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds may include a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second intensity threshold results in a third operation. In some embodiments, a comparison between the characteristic intensity and one or more intensity thresholds is used to determine whether or not to perform one or more operations (e.g., whether to perform a respective option or forgo performing the respective operation) rather than being used to determine whether to perform a first operation or a second operation.

In some embodiments, a portion of a gesture is identified for purposes of determining a characteristic intensity. For example, a touch-sensitive surface may receive a continuous swipe contact transitioning from a start location and reaching an end location (e.g., a drag gesture), at which point the intensity of the contact increases. In this example, the characteristic intensity of the contact at the end location may be based on only a portion of the continuous swipe contact, and not the entire swipe contact (e.g., only the portion of the swipe contact at the end location). In some embodiments, a smoothing algorithm may be applied to the intensities of the swipe contact prior to determining the characteristic intensity of the contact. For example, the smoothing algorithm optionally includes one or more of: an un-weighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

In some embodiments one or more predefined intensity thresholds are used to determine whether a particular input satisfies an intensity-based criterion. For example, the one or more predefined intensity thresholds include (i) a contact detection intensity threshold IT₀, (ii) a light press intensity threshold IT_{L}, (iii) a deep press intensity threshold IT_{D} (e.g., that is at least initially higher than I_{L}), and/or (iv) one or more other intensity thresholds (e.g., an intensity threshold I_{H} that is lower than I_{L}). As used herein, IT_{L} and I_{L} refer to a same light press intensity threshold, IT_{D} and I_{D} refer to a same deep press intensity threshold, and IT_{H} and I_{H} refer to a same intensity threshold. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold IT₀ below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms in duration (e.g., 40, 100, or 120 ms, depending on the magnitude of the second intensity threshold, with the delay time increasing as the second intensity threshold increases). This delay time helps to avoid accidental deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

For example, FIG. 3A illustrates a dynamic intensity threshold 380 that changes over time based in part on the intensity of touch input 376 over time. Dynamic intensity threshold 380 is a sum of two components, first component 374 that decays over time after a predefined delay time p1 from when touch input 376 is initially detected, and second component 378 that trails the intensity of touch input 376 over time. The initial high intensity threshold of first component 374 reduces accidental triggering of a “deep press” response, while still allowing an immediate “deep press” response if touch input 376 provides sufficient intensity. Second component 378 reduces unintentional triggering of a “deep press” response by gradual intensity fluctuations of in a touch input. In some embodiments, when touch input 376 satisfies dynamic intensity threshold 380 (e.g., at point 381 in FIG. 3A), the “deep press” response is triggered.

FIG. 3B illustrates another dynamic intensity threshold 386 (e.g., intensity threshold I_{D}). FIG. 3B also illustrates two other intensity thresholds: a first intensity threshold I_{H} and a second intensity threshold I_{L}. In FIG. 3B, although touch input 384 satisfies the first intensity threshold I_{H} and the second intensity threshold I_{L} prior to time p2, no response is provided until delay time p2 has elapsed at time 382. Also in FIG. 3B, dynamic intensity threshold 386 decays over time, with the decay starting at time 388 after a predefined delay time p1 has elapsed from time 382 (when the response associated with the second intensity threshold I_{L} was triggered). This type of dynamic intensity threshold reduces accidental triggering of a response associated with the dynamic intensity threshold I_{D} immediately after, or concurrently with, triggering a response associated with a lower intensity threshold, such as the first intensity threshold I_{H} or the second intensity threshold I_{L}.

FIG. 3C illustrate yet another dynamic intensity threshold 392 (e.g., intensity threshold I_{D}). In FIG. 3C, a response associated with the intensity threshold I_{L} is triggered after the delay time p2 has elapsed from when touch input 390 is initially detected. Concurrently, dynamic intensity threshold 392 decays after the predefined delay time p1 has elapsed from when touch input 390 is initially detected. So a decrease in intensity of touch input 390 after triggering the response associated with the intensity threshold I_{L}, followed by an increase in the intensity of touch input 390, without releasing touch input 390, can trigger a response associated with the intensity threshold I_{D} (e.g., at time 394) even when the intensity of touch input 390 is below another intensity threshold, for example, the intensity threshold I_{L}.

An increase of characteristic intensity of the contact from an intensity below the light press intensity threshold IT_{L} to an intensity between the light press intensity threshold IT_{L} and the deep press intensity threshold IT_{D} is sometimes referred to as a “light press” input. An increase of characteristic intensity of the contact from an intensity below the deep press intensity threshold IT_{D} to an intensity above the deep press intensity threshold IT_{D} is sometimes referred to as a “deep press” input. An increase of characteristic intensity of the contact from an intensity below the contact-detection intensity threshold IT₀ to an intensity between the contact-detection intensity threshold IT₀ and the light press intensity threshold IT_{L} is sometimes referred to as detecting the contact on the touch-surface. A decrease of characteristic intensity of the contact from an intensity above the contact-detection intensity threshold IT₀ to an intensity below the contact-detection intensity threshold IT₀ is sometimes referred to as detecting liftoff of the contact from the touch-surface. In some embodiments IT₀ is zero. In some embodiments, IT₀ is greater than zero. In some illustrations a shaded circle or oval is used to represent intensity of a contact on the touch-sensitive surface. In some illustrations, a circle or oval without shading is used represent a respective contact on the touch-sensitive surface without specifying the intensity of the respective contact.

In some embodiments, described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., the respective operation is performed on a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., the respective operation is performed on an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., the respective operation is performed on an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold. As described above, in some embodiments, the triggering of these responses also depends on time-based criteria being met (e.g., a delay time has elapsed between a first intensity threshold being met and a second intensity threshold being met).

### Example User Interfaces and Associated Processes

Attention is now directed towards embodiments of user interfaces (“UI”) and associated processes that may be implemented on an electronic device with a display and a touch-sensitive surface, such as device 100.

FIG. 2 is a schematic of a touch-sensitive display used to illustrate a user interface for a menu of applications, in accordance with some embodiments. Similar user interfaces are, optionally, implemented on device 100 (FIG. 1A). In some embodiments, user interface 201a includes the following elements, or a subset or superset thereof:
Signal strength indicator(s) 202 for wireless communication(s), such as cellular and Wi-Fi signals;
Time;
Bluetooth indicator 205;
Battery status indicator 207;
Tray 203 with affordances (e.g., application icons) for frequently used applications, such as:
   Affordance 216 for telephone module 138, labeled “Phone,” which optionally includes an indicator 214 of the number of missed calls or voicemail messages;
   Affordance 218 for e-mail client module 140, labeled “Mail,” which optionally includes an indicator 210 of the number of unread e-mails;
   Affordance 220 for browser module 147, labeled “Browser;” and
   Affordance 222 for video and music player module 152 (also referred to herein as a video or video-browsing application), also referred to as IPOD (trademark of APPLE Inc.) module 152, labeled “iPod;” and
Affordances (e.g., application icons) for other applications, such as:
   Affordance 224 for IM module 141, labeled “Messages;”
   Affordance 226 for calendar module 148, labeled “Calendar;”
   Affordance 228 for image management module 144, labeled “Photos;”
   Affordance 230 for camera module 143, labeled “Camera;”
   Affordance 232 for online video module 155, labeled “Online Video”
   Affordance 234 for stocks widget 149-2, labeled “Stocks;”
   Affordance 236 for map module 154, labeled “Maps;”
   Affordance 238 for weather widget 149-1, labeled “Weather;”
   Affordance 240 for alarm clock widget 149-4, labeled “Clock;”
   Affordance 242 for fitness module 142, labeled “Fitness;”
   Affordance 244 for notes module 153, labeled “Notes;”
   Affordance 246 for a settings application or module, which provides access to settings for device 100 and its various applications; and
   Other affordances (e.g., application icons) for additional applications, such as Application Store, Music, Voice Memos, and Utilities.

It should be noted that the affordance labels illustrated in FIG. 2 are merely examples. Other labels are, optionally, used for various application affordances (e.g., application icons). For example, affordance 242 for fitness module 142 is alternatively labeled “Fitness Support,” “Workout,” “Workout Support,” “Exercise,” “Exercise Support,” or “Health.” In some embodiments, a label for a respective application affordance includes a name of an application corresponding to the respective application icon. In some embodiments, a label for a particular application affordance is distinct from a name of an application corresponding to the particular application icon.

In some embodiments, the home screen includes two regions: a tray 203 and an affordance region 201. As shown in FIG. 2, the affordance region 201 is displayed above the tray 203. However, the affordance region 201 and the tray 203 are optionally displayed in positions other than those described herein.

The tray 203 optionally includes affordances (e.g., application icons) of the user's favorite applications on the computing device 100. Initially, the tray 203 may include a set of default affordances (e.g., application icons). The user may customize the tray 203 to include other affordances (e.g., application icons) than the default affordances (e.g., application icons). In some embodiments, the user customizes the tray 203 by selecting an affordance from the affordance region 201 and dragging and dropping the selected affordance into the tray 203 to add the affordance to the tray 203. To remove an affordance from the tray 203, the user selects an affordance displayed in the favorites region for a threshold amount of time which causes the computing device 100 to display a control to remove the icon. User selection of the control causes the computing device 100 to remove the affordance from the tray 203. In some embodiments, the tray 203 is replaced by a dock 408 (as described in more detail below) and, therefore, the details provided above in reference to tray 203 may also apply to the dock 408 may supplement descriptions of the dock 408 that are provided in more detail below.

In the present disclosure, references to a “split-view mode” refer to a mode in which at least two applications are simultaneously displayed side-by-side on the display 112, and in which both applications may be interacted with (e.g., a notes application and a web-browsing application are displayed in a split-view mode in FIG. 4A9). The at least two applications may also be “pinned” together, which refers to an association (stored in memory of the device 100) between the at least two applications that causes the two applications to open together when either of the at least two applications is launched. In some embodiments, an affordance (e.g., affordance 4012, FIG. 4A2) may be used to un-pin applications and instead display one of the at least two applications as overlaying the other, and this overlay display mode by be referred to as a slide-over display mode (e.g., the web-browsing application is displayed as overlaying a photos application, in the slide-over mode shown in FIG. 4A16). In some embodiments, a split-view mode and a slide-over mode exist together, where the slide-over view overlays a portion of a split-view. In some embodiments, the split view may include more than two applications. In some embodiments, the slide-over user interface or window may include a split-view.

In some embodiments, users are able to use a border affordance, that is a displayed within a border that runs between the at least two applications while they are displayed in the split-view mode, to un-pin or dismiss one of the at least two applications (e.g., by dragging the border affordance until it reaches an edge of the display 112 that borders a first application of the at least two applications, then that first application is dismissed and the at least two applications are then un-pinned). The use of a border affordance (or a gesture at a border between two applications) to dismiss a pinned application is discussed in more detail in commonly-owned U.S. patent application Ser. No. 14/732,618 (e.g., at FIGS. 37H-37M and in the associated descriptive paragraphs), which is hereby incorporated by reference in its entirety. The use of an overlay-switcher user interface to manage various slide-over views is discussed in more detail in commonly-owned U.S. patent application Ser. No. 16/581,665 (e.g., at FIGS. 4A1-4A50 and in the associated descriptive paragraphs), which is hereby incorporated by reference in its entirety.

FIGS. 4A1-4A27, 4B1-4B22, 4C1-4C14, 4D1-4D11, and 4E1-4E12 are schematics of a touch-sensitive display used to illustrate examples of user interfaces for simultaneously interacting with multiple applications and application views, in accordance with some embodiments.

FIGS. 4A1-4E12 describe various user inputs and the resulting user interfaces on a touch-sensitive display.

Additional descriptions regarding FIGS. 4A1-4A27, 4B1-4B22, 4C1-4C14, 4D1-4D11, and 4E1-4E12 are provided below in references to methods 5000, 6000, 7000, and 8000.

FIGS. 4A1-4A27, 4B1-4B, 4C1-4C14, 4D1-4D11, and 4E1-4E12 are schematics of a touch-sensitive display used to illustrate user interfaces for interacting with multiple applications and/or views, in accordance with some embodiments.

FIGS. 4A1-4A25 illustrate user interface behaviors of application views displayed in two shared screen modes, (i) a split-screen mode and (ii) a slide-over mode, in accordance with some embodiments. Interactions with a transitional user interface that is also described in FIG. 4A19. The user interfaces in these figures are used to illustrate the processes described below, including the processes in FIGS. 5A-8F. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

As a context for the descriptions below, in some embodiments, a home screen user interface includes a plurality of application affordances (e.g., application icons) corresponding to different applications installed on the device. An arrangement of the plurality of application affordances (e.g., application icons) is arranged by a user of the device. In these embodiments, a position or location of a respective application affordance within the home screen is chosen by a user. In these embodiments, a user can change the location of any application affordance in the home screen by editing the home screen. Each application icon is also an application affordance associated with a respective application. Each application icon, when activated by a user (e.g., by a tap input), causes the device to launch a corresponding application and display a user interface (e.g., a default initial user interface or a last displayed user interface) of the application on the display. The home screen displays multiple affordances including a first affordance for invoking a first application and a second affordance for invoking a second application that is different from the first application. A dock is a container user interface object that includes a subset of application affordances (e.g., application icons) selected from the home screen user interface, to provide quick access to a small number of frequently used applications. The application affordances (e.g., application icons) included in the dock are optionally selected by the user (e.g., via a settings user interface), or automatically selected by the device based on various criteria (e.g., usage frequency or time since last use). In some embodiments, the dock is displayed as part of the home screen user interface (e.g., overlaying a bottom portion of the home screen user interface). In some embodiments, the dock is displayed over a portion of another user interface (e.g., an application user interface) independent of the home screen user interface, in response to a user request (e.g., a gesture that meets dock-display criteria (e.g., an upward swipe gesture that starts from the bottom edge portion of the touch-screen)). An application selection user interface displays representations of a plurality of recently open applications (e.g., arranged in an order based on the time that the applications were last displayed). The representation of a respective recently open application (e.g., a snapshot of a last displayed user interface of the respective recently open application), when selected (e.g., by a tap input), causes the device to redisplay the last-displayed user interface of the respective recently open application on the screen. In some embodiments, the application selection user interface displays views of different display configurations (e.g., full-screen views, slide-over views, and split-screen views, minimized views, centered views and/or draft views, etc.) that may correspond to the same or different applications.

FIG. 4A1 shows a home screen user interface 4002 and an optional dock 4004 overlaying a bottom portion of the home screen user interface 4002. The dock 4004 includes a subset of application affordances (e.g., application icons) selected from the home screen user interface. An input 4006 is detected at a location on the screen that corresponds to a first application affordance (e.g., the application affordance 220 for the browser application in the dock 4004. In response to detecting the input, the device launches a corresponding application and display a user interface (e.g., a default initial user interface or a last displayed user interface) of the application on the display. A view of an application may also be referred to as a window of an application, or an application window. An application window is one view of an application. As shown in FIG. 4A2, a first application view 4010 of the application (e.g., a view of a browser application) is displayed on touch-screen 112 in a stand-alone display configuration (e.g., also a full-screen display configuration), without being concurrently displayed with another application view of the same application or a different application. The first application view 4010 displays a portion of a first user interface (e.g., a searchable browser interface) of the first application. The first application view is also referred to as a first view of the application. In the full-screen mode, the first view of the first application occupies substantially an entire display area of the display screen, while some portion of the display is occupied by system status information. Such system status information includes, for example, the battery status indicator 207, the Bluetooth indicator 205, Wi-Fi or cellular data signal strength indicators 202 shown in FIG. 2 and FIG. 4A2. In some embodiments, the system status information is displayed at a top portion of the touch-screen 112 as shown in FIG. 4A2. A display mode affordance 4012 is displayed over the first view of the first application or embedded into the first view of the first application. The display mode affordance 4012 allows a user to select between different display modes. In some embodiments, the display mode affordance 4012 includes three solid dots. An outline, such as a rectangle, may demarcate the outline of the display mode affordance 4012.

As shown in FIG. 4A2, while displaying the full-screen view 4010 of the browser application, an input 4014 is detected at a location on the screen that corresponds to the display mode affordance 4012 (e.g., the top affordance). In some embodiments, the input 4014 is a contact (e.g., such a tap of a long press) on the screen, while in other embodiments, the input includes non-tactile or non-contact input (e.g., a mouse click, or a third dimensional selection gesture in an augmented or virtual reality environment). In some embodiments, in response to detecting the input 4014 at the display mode affordance 4012, the device ceases to display the display mode affordance 4012 and displays a selection panel 4020 that includes different selectable display mode options corresponding to different display modes, as shown in FIG. 4A3. The selectable display mode options include, for example, a full screen display mode affordance 4022, a split-screen display mode affordance 4024, and a slide-over display mode affordance 4026. In some embodiments, the selectable display mode option that corresponds to the currently selected display mode (e.g., full-screen mode in first application view 4010 (such as a first view of a browser application)) is visually distinguished from the other selectable display mode options. In FIG. 4A3, the full screen display mode affordance 4022 is highlighted by an indicator 4028 (e.g., a circular or quadrilateral shaded indicator), to provide visual feedback to the user indicating which mode is currently displayed.

FIGS. 4A4-4A12 illustrate a process for opening a view of a second application (e.g., the second application is the same or a different application from the first application) in a split-screen mode, in accordance with some embodiments. The process illustrated in FIGS. 4A4-4A12 differs from the process shown in FIGS. 4B9-4B12 in that the former process changes the full-screen view of the first application (e.g., mail application) into a split-screen view while at the same time displaying a newly opened second split-screen view, in accordance with some embodiments. In the process of FIGS. 4B9-4B12, one view in the mail application is a newly opened view, while the other view in the email application is not a newly opened view but a resized existing view.

The process illustrated in FIGS. 4A4-4A12 is initiated by the user selecting the split-screen display mode affordance 4024 in FIG. 4A3. Thereafter, a home screen is displayed as shown in FIG. 4A4. The home screen has full functionality (e.g., allows for searching as illustrated in FIGS. 4A6-4A9, scrolling as illustrated in FIGS. 4A14-4A16, and folder browsing as illustrated in FIGS. 4A10-4A12). A user can select an application affordance from the home screen. Instead of dragging an application affordance of a second application to a specific region of the display to trigger a split-screen display of that application, the process described herein may reduce the time associated with dragging an application affordance across the display while providing the user a wider selection (e.g., full selection of all installed applications) of application affordances for displaying in the split-screen mode. If, instead of detecting a tap input on an application affordance, a long input (e.g., a long-press) is detected of one of the application affordances, a user input interface is displayed to allow the user to edit the home screen. Upon receiving a user input to edit the home screen, the device ceases to display the split-screen mode application selector interface.

In some embodiments, in response to detecting an input 4030 in a region of the selection panel 4020 associated with the split-screen display mode affordance 4024, the device ceases to display the full-screen view 4010 of the browser application. Once the user selects the split-screen display mode affordance 4024, the device displays the home screen 4002, as shown in FIG. 4A4, while providing a representation 4040 of the first application (e.g., previously displayed in the full-screen display mode) in a portion of the touch screen 112. For example, the first view of the first application (e.g., full-screen display mode of the browser application shown in FIG. 4A3) occupies a majority of a display area while the representation 4040 of the first application occupies a minority of the display area near an edge (e.g., a right edge) of the display. A majority of the display area corresponds to an area equal to or greater than half of the total display area, while a minority of the display area corresponds to an area less than half of the total display area. The representation 4040 may include characteristics associated with the first application, for example, a graphic 4042 of an application affordance (e.g., a miniaturized application icon) associated with the first application, and pertinent information (e.g., a portion of the URL that was displayed in the first view of the first application), or it may include a partial representation of the user interface of the application when it was displayed in the full-screen mode (e.g., a portion of a left edge of the user interface of the application). In some embodiments, when the split-screen display mode affordance 4024 is selected, an animation is presented where the display view of the first application is made smaller while moving to an edge of the display screen.

Instead of a simplified representation of the first view of the first application, the first representation may be a portion of a reduced size view of the first view of the first application (e.g., a left edge of a reduced size full-screen view of the browser application), in accordance with some embodiments. The first representation 4040 may be displayed as a sliver of a display view (e.g., a sliver of a browser application). The first representation 4040 may be docked to an edge of the display (e.g., a right edge 4046, a left edge 4048).

In response to detecting an input 4050 at a region of the home screen 4002 corresponding a position of an affordance for a second application (e.g., the affordance 226 for the calendar application), and in accordance with a determination that the application affordance is selected by a user (e.g., by a tap input), the device ceases to display the home screen 4002, and the representation 4040, and launches the application corresponding to the application affordance (e.g., affordance 226 for the calendar application) and displays a user interface or view (e.g., a default initial user interface or a last displayed user interface) of the application on the display in a split-screen mode. As shown in FIG. 4A5, a second view 4052 (e.g., second view) of the first application (e.g., the browser application) is shown on the left-side of the display. A first view 4054 (e.g., first view) of the second application (e.g., the calendar application) is shown on the right-side of the display. In some embodiments, the second view 4052 has a display mode affordance 4056, and the first view 4054 has a display mode affordance 4058.

FIG. 4A5 shows an input 4062 at a location that corresponds to the display mode affordance 4056. If the input 4062 meets a split-screen switch criteria for initiating a swapping operation on the first view 4054 and the second view 4052 (e.g., the input 4062 has met a predefined touch-hold time threshold or a predefined speed and/or distance threshold of the input moving toward the first view 4054 meets for swapping the placement of the first view 4054 and the second view 4052), the device swaps the positions of the split-screen views on the display. The same holds true for an input 4060 is detected at a location that corresponds to the display mode affordance 4058. In the split-screen mode, the first view and the second view are displayed side-by-side to jointly occupy substantially an entire area of the display (e.g., touch-screen 112). FIG. 4A5 also shows an input 4061 at a location that corresponds to a resizing affordance 4059. If the input 4061 meets resizing criteria for initiating resizing of the first view 4054 and the second view 4052 (e.g., the input 4062 has met the touch-hold time threshold and/or distance of the input meets predefined speed and/or distance thresholds) a divider 4063 between the first view 4054 and the second view 4052 is repositioned to a location corresponding to an end (e.g., a liftoff) of the input 4061. If the divider 4063 is repositioned to the right of the position shown in FIG. 4A5, the second view 4052 is enlarged while the first view is reduced in size, with both views together occupying substantially an entire area of the display (e.g., touch-screen 112). If the divider 4063 is repositioned to the left of the position shown in FIG. 4A5, the second view 4052 is reduced in size while the first view is enlarged, with both views occupy substantially an entire area of the display (e.g., touch-screen 112).

In addition to directly selecting an application icon from the home screen 4002, as shown in FIG. 4A4, FIGS. 4A6-4A8 illustrate an application selection operation (to select a second application for a split-screen mode) accessed via a search function of the home screen 4002. The home screen 4002 in FIG. 4A6, like in FIG. 4A4, includes the first representation 4040 of the first application (e.g., browser application), indicating that the device is ready to detect an input relating to a selection of the second application for split-screen display with the first application. In accordance with a determination that an input 4062 meets a search-initiation criteria (e.g., a downward swipe gesture in a middle region of the touch screen that moves toward the bottom edge of the touch-screen, direction of the movement is away from the center of the display, and/or the movement meets a threshold distance or threshold speed), the device displays a search input box 4064 overlaying the home screen 4002, as shown in FIG. 4A7.

The search input box 4064 includes a region 4066 that accepts text input (e.g., to allow for a text-based search for a particular application, e.g., using the name of the application). The search input box 4064 also includes a region 4068 that displays the affordances (e.g., application icons) of various suggested or recently used applications (e.g., application affordance 244 for the Notes application). The search input box 4064 may optionally include a region 4070 that displays content suggestions (e.g., website suggestions, podcast suggestions). In response to detecting an input 4072 at a location corresponding to an affordance for a second application (e.g., the affordance 244 for the Notes application) as shown in FIG. 4A8, and in accordance with a determination that the application affordance (e.g., the affordance 244 for the Notes application) is selected by a user (e.g., by a tap input), the device ceases to display the search input box 4064, the home screen 4002, and the representation 4040. The device launches the application corresponding to the application affordance (e.g., affordance 244 for the Notes application) and displays a user interface or view (e.g., a default initial user interface or a last displayed user interface) of the application on the display in a split-screen mode as shown in FIG. 4A9.

Similar to FIG. 4A5, FIG. 4A9 shows using an input at a location that corresponds to the display mode affordance 4056 to cause the device to swap placement of the split-screen views on display, as described in reference to FIG. 4A5. An input 4077 is detected at a location that corresponds to a display mode affordance 4074 associated with a first view 4076 of a third application (e.g., Notes application) that was triggered from the search input box 4064. If the input 4077 meets a split-screen switch criteria for initiating a swapping operation on the first view 4076 and the second view 4052 (e.g., the input 4077 has met the touch-hold time threshold or the speed and/or distance of the input moving toward the second view 4052 meets predefined speed and/or distance thresholds for swapping the placement of the first view 4076 and the second view 4052), the device swaps the placement of the split-screen views on the display. In the split-screen mode, the first view and the second view displayed side-by-side jointly occupy substantially an entire area of the display (e.g., touch-screen 112). Similarly, as described in reference to FIG. 4A5, the resizing affordance 4059 allows the sizes of the first view 4076 and the second view 4052 to be adjusted, while allowing both views to jointly occupy substantially an entire area of the display (e.g., touch-screen 112).

While the representation 4040 of the first application is displayed on a portion of the display (e.g., docked to the right edge 4046), the device displays a home screen 4078 having various functionalities (e.g., full functionality associated with the home screen 4002) for selection of a second application, to be displayed in a split-screen display mode, by the user (e.g., the second application may be the same as the first application, for example both are browser applications, the second application may be different from the first application). As shown in FIGS. 4A10-4A12, the home screen 4078 displayed to the user for selecting the second application includes folder-browsing functionality, in accordance with some embodiments. The home screen 4078 includes an affordance 4080 of a folder storing a number of applications affordances (e.g., application icons). An input 4082 (e.g., a tap input) is detected on the affordance 4080 of the folder; and in response to detecting input 4082, the device displays a folder-display user interface 4084, as shown in FIG. 4A11, overlaying a full-screen home screen 4078 in the background. The home screen 4078 is dimmed or blurred, in accordance with some embodiments, when the folder-display user interface 4084 is displayed or active. The folder-display user interface 4084 shows the affordances (e.g., application icons) of various applications that are stored in the folder and the device displays a name 4086 of the folder above the folder-display user interface 4084 (e.g., “My Folder”). In response to detecting an input 4090 at a location corresponding to an affordance for a fourth application (e.g., the affordance 4088 for the Application Store application) as shown in FIG. 4A11, and in accordance with a determination that the application affordance (e.g., the affordance 4088 for the Application Store application) is selected by a user (e.g., by a tap input), the device ceases to display the folder-display user interface 4084, the home screen 4078, and the representation 4040. The device launches the application corresponding to the application affordance (e.g., affordance 4088 for the Application Store application) and displays a user interface or view (e.g., a default initial user interface or a last displayed user interface) of the application on the display in a split-screen mode as shown in FIG. 4A12.

Similar to FIGS. 4A5 and 4A9, FIG. 4A12 shows using an input at a location that corresponds to the display mode affordance 4056 to cause the device to swap placement of the split-screen views on display, as described in reference to FIG. 4A5.

In FIGS. 4A13-4A17, a second 7 view (e.g., view 4120 in FIG. 4A17) of the first application (e.g., the browser application) is displayed overlaying a first view (e.g., view 4122) of a second application (e.g., a photos application), in a slide-over display configuration, in accordance with some embodiments. The second application view of the first application displays a portion of a first user interface of the first application (e.g., a browser application). As shown in FIG. 4A13, while the first view 4010 of the first application (e.g., the browser application) is displayed, an input 4102 at a region of the selection panel 402 associated with the slide-over display mode affordance 4026 is detected, the device ceases to display the full-screen view 4010 of the browser application. Once the user selects the slide-over display mode affordance 4026, the device displays the home screen 4104, as shown in FIG. 4A14, while providing a representation 4040 of the first application (e.g., previously displayed in the full-screen display mode) in a portion of the touch screen 112. For example, the first view of the first application (e.g., full-screen display mode of the browser application shown in FIG. 4A13) occupies a majority of a display area while the representation 4040 of the first application occupies a minority of the display area. The representation 4040 may include characteristics associated with the first application, as described above in reference to FIG. 4A4.

The device displays the home screen 4104 having various functionalities (e.g., full functionality associated with the home screen 4104) for selection of a second application by the user, to be displayed in a full-screen display mode underneath an overlaying display view of the first application (e.g., the second application may be the same as the first application (e.g., both are browser applications), the second application may be different from the first application). As shown in FIGS. 4A14-4A15, the home screen 4104 displayed to the user for selecting the second application includes a scrolling functionality to scroll through multiple (e.g., more than one) home screen pages, in accordance with some embodiments. The home screen 4104 includes a page indicator 4107. In some embodiments, the number of circles shown in the page indicator 4107 corresponds to the number of scrollable home screen pages associated with the home screen 4104 (e.g., three scrollable home screen pages associated with the home screen 4104). The shaded circle in the page indicator 4107 represents a position of the currently displayed home screen page among the scrollable home screen pages (e.g., the leftmost shaded circle shown in FIG. 4A14 indicates that the currently displayed home screen is the first page in the scrollable home screen pages).

In some embodiments, a leftward swipe gesture at an unoccupied (e.g., devoid of affordances (e.g., application icons), representations or dock) location on the home screen, for example as shown 4108 in FIG. 4A14 causes the home screen 4104 to scrolls through to the next home screen page, as shown in FIG. 4A15.

The second page of the scrollable home screen pages corresponds to a displayed home screen 4110. The page indicator 4107 is updated and shows a shaded circle in the middle, indicating that the currently displayed home screen is the second (e.g., middle) page in the scrollable home screen pages. A leftward swipe gesture at an unoccupied (e.g., devoid of affordances (e.g., application icons), representations or dock) location on the home screen 4110, for example as shown by a directional arrow 4112 that begins as a contact 4116 in FIG. 4A14 causes the home screen 4104 to scrolls through to the next home screen page (e.g., the third scrollable home screen page). A rightward swipe gesture, for example as shown by a directional arrow 4114 that begins as a contact 4116 in FIG. 4A14 causes the home screen 4104 to scroll to the previous home screen page (e.g., the first scrollable home screen page) as shown in FIG. 4A14.

In response to detecting an input 4118 in a region of the home screen 4110 corresponding a position of an affordance for a second application (e.g., the affordance 228 for an application associated with an image management module 144, labeled “Photos”), and in accordance with a determination that the application affordance is selected by a user (e.g., by a tap input), the device ceases to display the home screen 4110, and the representation 4040, and launches the application corresponding to the application affordance (e.g., affordance 228 for the photo application) and display a user interface or view (e.g., a default initial user interface or a last displayed user interface) of the application on the display in a full-screen screen mode. As shown in FIG. 4A16, a second view 4120 (e.g., second view) of the first application (e.g., the browser application) is shown on the right-side of the display. A first view 4122 (e.g., first view) of the second application (e.g., the photos application) is displayed with the second view 4120 of the first application in a respective concurrent-display configuration (e.g., a slide-over display configuration, with the second view of the first application overlaying a portion of the first view of the second application). The first view 4112 has a display mode affordance 4124, and the second view 4120 has a different top affordance 4126, and a bottom affordance 4128.

In some embodiments, instead of displaying a representation 4040 on a portion of the home screen while the device displays a home screen in an application selection interface for a user selection of a second application, in FIG. 4A17-4A18, following 4A13, the device ceases display of the first view 4010 of the first application (e.g., a browser application) and displays the second view 4120 of the first application in a slide-over display mode, overlaying the home screen 4002. An input 4130 is detected at a location that corresponds to a position of an affordance for a second application (e.g., the affordance 228 for an application associated with an image management module 144, labeled “Photos”), and in accordance with a determination that the application affordance is selected by a user (e.g., by a tap input), the device ceases to display the home screen 4110, and launches the application corresponding to the application affordance (e.g., affordance 228 for the photo application) and display a user interface or view (e.g., a default initial user interface or a last displayed user interface) of the application on the display in a full-screen screen mode, as shown in FIG. 4A18, which is identical to FIG. 4A16.

The second view 4120 may be the top view of a stack of multiple slide-over views stored in the memory of the device. In FIGS. 4A19, following 4A18, an input 4132 is detected on the bottom edge of the slide-over view (e.g., the view 4120), and the input includes movement of contact the 4132 in a direction (e.g., upward) across the display. In response to detecting the input 4132 and in accordance with a determination that the movement of the input 4132 meets preset criteria (e.g., exceeds a threshold amount of movement in the direction, or exceeds a threshold speed in the direction), the device displays a transitional user interface 4134 that includes a representation (e.g., a representation 4120′) of the slide-over view 4120 that moves in accordance with the movement of the input 4132. In some embodiments, the background view (e.g., the view 4122) is visually obscured (e.g., blurred and darkened) underneath the representation of the slide-over view in the transitional user interface 4134. In some embodiments, representations of other slide-over views (e.g., the representations 4136′, 4138′, and 4140′) in the stack of slide-over views are shown underneath the representation of the top slide-over view (e.g., the representation 4120′), as the representation of the top slide-over view is dragged around the display in accordance with the movement of the input 4132. In some embodiments, the representations of the slide-over views are dynamically updated (e.g., changed in size) in accordance with a current position of the representations (and the contact 4134) on the display. After a lift-off of the input 4132 is detected, and the device displays a slide-over-view-switcher user interface or overlay-switcher user interface for just the slide-over views that are currently stored in the stack of slide-over views stored in memory. In some embodiments, the representations of the slide-over views in the stack of slide-over views are displayed and are individually selectable in the overlay-switcher user interface.

FIG. 4A20 illustrates that a swipe input 4142 is detected within a region of the display mode affordance 4056, and the movement of the swipe input 4142 is substantially vertical (e.g., includes no horizontal movement, or a small amount of horizontal movement as compared to the vertical movement). In response to the downward swipe input, and in accordance with a determination that the downward swipe input meets application-closing criteria (e.g., meets the distance and speed criteria of the application-closing criteria), the device ceases display of the split-screen display of both the second view 4052 of the first application and the first view 4054 of the second application. The device then displays the home screen 4002, as shown in FIG. 4A21, and displays a representation 4144 of the second application (e.g., previously displayed in the split-screen display mode) in a portion of the touch screen 112. The device also displays an animation of the first application (e.g., browser application) having a frame 4146 reducing in size as it returns to the application affordance 220 from which the first application was launched (as shown in FIG. 4A1).

FIG. 4A22 shows the animation of the first application having a frame 4148, that is smaller than the frame 4146, returning to the application affordance 220. After the animation terminates, the device is in a state to receive user input for opening another application (e.g., third application) to replace the recently closed first application, similar to the state shown in FIG. 4A4, so that the newly selected third application and the second application are jointly displayed in the split-screen display mode. In some embodiments, a tap input on the representation 4144 of the second application causes the device to cease displaying the home screen 4002, and display the second application in a full-screen mode.

FIG. 4A23 illustrates that a swipe input 4150 is detected within a region of the display mode affordance 4058, and the movement of the input 4150 is substantially vertical (e.g., includes no horizontal movement, or a small amount of horizontal movement as compared to the vertical movement). In response to the downward swipe input, and in accordance with a determination that the downward swipe input meets application-closing criteria (e.g., meets the distance and speed criteria of the application-closing criteria), the device ceases display of the split-screen display of both the second view 4052 of the first application and the first view 4054 of the second application. The device displays the home screen 4002, as shown in FIG. 4A24, and displays a representation 4040 of the first application (e.g., previously displayed in the split-screen display mode) in a portion of the touch screen 112. The device also displays an animation of the second application (e.g., calendar application) having a frame 4152 returning to the application affordance 226 from which the second application was launched (as shown in FIG. 4A4). In embodiments in which there are multiple scrollable home screen pages, the animation begins on the screen page containing the application affordance from which the application was launched.

FIG. 4A25 shows the animation of the second application having a frame 4154, that is smaller than the frame 4152, returning to the application affordance 226. After the animation terminates, the device is in a state to receive user input for opening another application (e.g., third application) to replace the recently closed second application, similar to the state shown in FIG. 4A4, so that the newly selected third application and the first application can be displayed jointly in a split-screen mode. In some embodiments, a tap input on the representation 4040 of the first application causes the device to cease displaying the home screen 4002, and display the first application in a full-screen mode.

FIGS. 4B1-4B22 illustrate user interface behaviors in response to a user's interactions with one or more slide-over views or views, in accordance with some embodiments. An edge affordance on a side of the display may serve as a visual reminder to the user about the presence of one or more slide-over view(s) that are stored in a memory of the device. By allowing the edge affordance to fade after a threshold period of time, an unobscured portion (e.g., the area not covered by the edge affordance) of the display is increased, maximizing a display area for other applications while not obscuring any of the application window near the edge. While most of FIGS. 4B1-4B22 depict a single slide-over view, more than one slide-over views may be nested in a superimposed stack underneath the topmost slide-over view, e.g., each view stacked behind a preceding view and offset to one side. Operations for a stack of single slide-over view are described in FIGS. 4A19 and 4B7. The user interfaces in these figures are used to illustrate the processes described below, including the processes in FIGS. 6A-6D. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

In FIG. 4B1, the device displays a view 4204 of a first application (e.g., a browser application) overlaying a portion of a view 4200 of a second application (e.g., another instance of the browser application). The first application may be the same as the second application, or the first application may be different from the second application. As shown in FIG. 4B1, the view 4204 of the browser application, as the most recent slide-over view, completely obscures the underlying slide-over the views 4010, and/or replaces the view 4140′ (as shown in FIG. 4B7), as the currently displayed slide-over view overlaying the view 4200 of the browser application.

In FIG. 4B1, an input 4206 is detected at a location near a left side edge of the slide-over view 4204, and the input includes movement of the input 4206 in a first direction (e.g., substantially horizontally) toward an edge on a side of the screen that the slide-over view 4204 is displayed (e.g., the right edge of the screen). In some embodiments, the device uses an input that is detected on the left side edge or within a threshold distance of the left-side edge of the view 4204, to trigger an operation to slide a single slide-over view or a stack of slide-over views off from the display. In some embodiments, during the movement of the input 4206 toward the right edge of the display, the slide-over view 4204 is gradually dragged off of the display, and visual indications of other views in the stack of slide-over views are shown trailing view 4206's movement. After the end of the input 4206 is detected, the view 4204 is removed from the display, and no other slide-over view is shown on the display concurrently with the background view 4200. The view 4200 is displayed as a full-screen view in a standalone display configuration, rather than as a full-screen background view with a slide-over view displayed in the slide-over display configuration, and an edge affordance 4210 is also displayed. In some embodiments, the edge affordance is displayed for a period of time (e.g., 0.25, 0.5, 1, 2, 3 seconds, 4 seconds, 5 seconds, 10 seconds, or 20 seconds), as shown in FIG. 4B3, before fading, e.g., via a disappearing animation.

In FIG. 4B5, an input 4214 is detected at a side edge of the display (e.g., on the side of the screen that previously displayed a slide-over view (e.g., the view 4204)), and the input includes movement of the input in a second direction (e.g., substantially horizontally) away from the side edge onto the display. In some embodiments, the edge affordance 4210 is no longer displayed near the side edge of the display (e.g., a time period longer than a threshold amount of time has passed) but in response to detecting the input 4214, the edge affordance 4210 is re-displayed at the side edge. In addition, in response to detecting the input 4214, the last displayed slide-over view (e.g., the view 4204) is dragged back onto the display, overlaying the currently displayed full-screen view (e.g., the view 4200), as shown in FIG. 4B6. In some embodiments, the edge affordance is a tab having a length that is shorter than a length of an edge of the display. Even though the edge affordance 4210 has a shorter length than a length of the right edge of the display, the input 4214 can be anywhere along the side edge of the display to trigger the last displayed slide-over view to be pulled back onto the display. No longer displaying the edge affordance 4210 after the threshold amount of time allows more of the full-screen view (e.g., e.g., the view 4200) to be displayed and not obscured and enhances user efficiency and productivity by displaying more of the application view. Re-displaying the edge affordance 4210 may serve as a visual reminder or cue to the user that one or more slide-over views are stored in the memory of the device and may be pulled back onto the screen from the edge affordance. Conversely, the input 4214 does not cause the edge affordance 4210 to be re-displayed when no slide-over views are stored in the memory of the device, and the absence of a re-display of the edge affordance serves as a visual confirmation to the user that no slide-over views are stored in the memory of the device and available to be slid over from the edge of the screen.

In some embodiments, if the view on the display has been switched to another full-screen view in the standalone display configuration (e.g., a full-screen view displayed in response to selecting an application affordance in the dock, selecting from a list of open views of an application after the application affordance is selected, or an application-switching gesture (e.g., a horizontal swipe along the bottom edge of the currently displayed standalone view)), an input that is detected at a location of the display corresponding to the edge affordance 4210 and that includes horizontal movement of the input away from the side edge onto the screen, the last displayed slide-over view (e.g., the view 4200) is dragged back onto the display, overlaying the currently displayed full-screen view (e.g., a full-screen view other than the view 4200). In some embodiments, as the view 4204 is dragged back onto the display with a leftward movement of the input 4214, representations of other views in the stack of slide-over views are shown underneath view 4204, as shown in FIG. 4B7.

In FIG. 4B8, an input by input 4240 is detected at a location that corresponds to a drag handle region of the slide-over view 4204 (e.g., near the top edge of the view 4204, near the display mode affordance 4203), and the input includes movement of the input 4240 in a third direction (e.g., substantially horizontally leftward) toward a side edge of the display (e.g., a left edge of the display). FIG. 4B8 shows the slide-over view 4204 being dragged across the display, overlaying a portion of the view 4200. In addition to the input 4240, the slide-over view 4204 may also be dragged by movement of an input at edges 4242 and 4244. In some embodiments, when the view 4204 is a topmost slide-over view of a stack of slide-over views, the other underlying slide-over views are not revealed or displayed, after the view 4204 is moved away by the drag input 4240 from its original location on the right side of the display. In FIG. 4B9, when the input 4240 is a leftward swipe input off the ledge edge in the display, the slide-over view 4204 slides off the display, and an edge affordance 4246 is displayed on the edge of the display (e.g., the left edge of the display). In some embodiments, unlike the edge affordance 4210, the edge affordance 4246 on the left edge of the display does not fade (e.g., it persists for a second threshold period of time (that could be as long as the slide-over window is open), which is longer than the threshold period of time associated with the display of the edge affordance 4210). In some embodiments, the edge affordance 4246 on the left edge of the display disappears when multimedia (e.g., videos, presentations) content is played in a full-screen mode.

In FIG. 4B9, an input 4248 is detected at a location corresponding to the edge affordance 4246 on a side edge of the display (e.g., on the left edge of the screen that previously displayed a slide-over view (e.g., the view 4204)), which includes movement in a fourth direction (e.g., substantially horizontally in a rightwards direction) away from the side edge. In response to detecting the input 4248, the last displayed slide-over view (e.g., the view 4204) is dragged back onto the display, overlaying the currently displayed full-screen view (e.g., the view 4200), as shown in FIG. 4B11. In some embodiments, if the view on the display has changed to another full-screen view in the standalone display configuration, and an input is detected on a side edge of the display that includes horizontal movement of the input away from the side edge onto the screen, the last displayed slide-over view (e.g., the view 4204) is dragged back onto the display, overlaying the currently displayed full-screen view (e.g., a full-screen view other than the view 4200). For example, the view on the display has changed to another full-screen view in response to tapping an application affordance in the dock, selecting from a listing of open views of an application after the application affordance is tapped, or an application-switching gesture (e.g., a horizontal swipe along the bottom edge of the currently displayed standalone view)) is detected to cause a display of a different free-screen view. As described in reference to FIGS. 4B5-B7, the device allows an input with movement anywhere along the right edge of the display to cause a slide-over view that was previously pushed off the right edge to return to the display. In contrast, an input 4250 that is detected at a location on the left edge of the display not at the edge affordance 4246, which includes movement in the fourth direction (e.g., substantially horizontally) away from the side edge (e.g., left edge) onto the center of the display causes an operation in the application (e.g., browser application) that is displayed in the full-screen display mode. For example, for a browser application, as shown in FIGS. 4B9-4B10, the input 4250 causes the application to perform a back navigation function, displaying a browser view 4252 that was viewed or loaded prior to display of the view 4200.

As shown in FIG. 4B11, while displaying the slide-over view 4204 of the browser application, an input 4254 is detected at a location on the screen that corresponds to the display mode affordance 4203 (e.g., the top affordance). In some embodiments, the input includes non-tactile or non-contact input (e.g., a mouse click, or a third dimensional selection gesture in an augmented or virtual reality environment) while in other embodiments it includes a contact with the display followed by a swipe gesture. In response to detecting the input 4254 on the display mode affordance 4203, the device ceases to display the display mode affordance 4203 and displays a selection panel 4257 (FIG. 4B12) that includes different selectable display mode options corresponding to different display modes. The selectable display mode options include (as also described with respect to FIG. 4A3), for example, a full screen display mode affordance, a split-screen display mode affordance, and a slide-over display mode affordance. The selectable display mode option that corresponds to the currently selected display mode (e.g., slide-over view 4204 (e.g., a slide-over view of a browser application)) is visually distinguished from the other selectable display mode options. In FIG. 4B12, the slide-over display mode affordance is highlighted by an indicator (e.g., a circular, a quadrilateral, or polygonal shaded indicator), and provides visual feedback (e.g., a reminder) to the user that the slide-over view 4204 is currently displayed in the slide-over mode.

In response to detecting an input in a region of the selection panel 4257 associated with the split-screen display mode affordance, the device ceases to display the full-screen view 4200 of the browser application, and the slide-over view 4204. The device instead displays a representation of the slide-over view 4204, similar to the processes described in FIGS. 4A3-4A12 for the user to select a second application to display in the split-screen display mode alongside the first application (e.g., the application previously displayed by the slide-over view 4204) re-rendered in the split-screen mode.

FIGS. 4B13-4B18 illustrate processes for dragging and dropping an object (e.g., user interface object representing a content item or an application icon) at different locations (e.g., side regions) on the display, in accordance with some embodiments. FIGS. 4B13-4B22 illustrate various examples in which, after a drag operation is initiated on a content object, the final outcome of the input (e.g., after an end of the input is detected) is determined based on the location of the input or the location of the dragged object at a time when the input ended.

FIGS. 4B13-4B16 illustrate a process to open another content item in a split-screen view through a drag and drop operation, in accordance with some embodiments. In some embodiments, the content item that is opened in the split-screen view is from the same application, for example, the content item is an object within an application view. In FIGS. 4B13-4B16, an object representing the content item is dragged from the first view shown on the display and dropped into the second predefined region (e.g., predefined region 4264 shown in FIG. 4B14) on a side (e.g., the right side, near a region on a right side edge) of the display, and as a result, the content item is opened in a new split-screen view of an application corresponding to the content item as shown in FIG. 4B16.

As shown in FIG. 4B13, the full-screen view 4256 of an email application is displayed (e.g., in a standalone configuration). An input 4258 is detected at a location that corresponds to an object 4260 representing a content item (e.g., an email message from MobileFind). An initial portion of the input 4258 has met an object-move criteria for initiating a drag operation on the object 4260 representing the content item or a copy of the object 4260 (e.g., the initial portion of the input 4258 has met the touch-hold time threshold or a press intensity threshold), and the device highlighted the object 4260 to indicate that the criteria for initiating a drag operation on the object has been met.

In FIG. 4B14, a representation of the content item 4260 (e.g., a copy of the object 4260) is dragged across the display in accordance with movement of the input 4258 detected after the object-move criteria were met. In some embodiments, the representation 4262 has a first appearance that indicates that no acceptable drop location is available for the object in a portion of view 4256 that is outside of the first predefined region 4264, and that if the input ended at this time, no object move operation or object copy operation will be performed with respect to the content item in view 4256.

In FIG. 4B15, the representation 4262 of the content item is dragged to a location within the predefined region 4264 in accordance with the movement of input 4258, after the object-move criteria were met. In some embodiments, the representation 4262 takes on a second appearance (e.g., the representation is elongated) that indicates that if the input ended at this time, the content item will be displayed in a new split-screen view of the application that corresponds to the content item (e.g., the email application) with a split-screen view of the email application that is reduced from the full-screen view 4256 to a partial screen view. In FIG. 4B15, in some embodiments, in addition to changing the appearance of the representation 4262 of the content item, when the representation is dragged to a location within the predefined region 4264, the device also provides additional visual feedback to indicate that the current location of the input and/or representation 4262 meets the location criterion for opening the second content item in a split-screen view. In some embodiments, the additional visual feedback includes reducing the width of the full-screen view 4256 to display a representation 4256′ of the view 4256, and revealing a background 4266 underneath the representation 4256′ on the side of the display over which the representation 4262 is currently located.

In FIG. 4B16, in response to detecting the end of the input 4258 (e.g., detecting lift-off of the input 4258), the content item is displayed in a new split-screen view 4267 of the email application, side by side with another split-screen view 4271 reduced in size from the view 4256.

FIGS. 4B17 and 418 continue from any of FIGS. 4B13, and 4B14, and illustrate an example where the content item is opened in a new slide-over view 4270 of the email application, overlaying the full-screen view 4256. As shown in FIG. 4B17, the representation 4262 of the content item is dragged to a region 4268 within the predefined region 4264 in accordance with the movement of the input 4258 after the object-move criteria were met. As the representation 4262 of the content item is dragged to the region 4268, an edge affordance 4269 is displayed. In some embodiments, the representation 4262 takes on a third appearance (e.g., the representation is less elongated as compared to the state shown in 4B15 and is expanded laterally) that indicates that if the input ended at this time, the content item will be displayed in a new slide-over view of the application that corresponds to the content item (e.g., the email application). In FIG. 4B17, in some embodiments, in addition to changing the appearance of the representation 4262 of the content item, when the representation is dragged to the region 4268 within the predefined region 4264, the device also provides additional visual feedback to indicate that the current location of the input and/or representation 4262 meets the location criterion for opening the content item in a slide-over view. In some embodiments, the additional visual feedback includes reducing the overall size of the view 4256 to display a representation 4256′ of the view 4256, and revealing a background 4266 underneath the representation 4256′. The region 4268 is a smaller region within the predetermined region 4264. As a result, the user may more easily convert content items into the split-screen display mode than the slide-over display mode.

In FIG. 4B18, in response to detecting the end of the input 4258 (e.g., detecting lift-off of the input 4258), the content item is displayed in a new slide-over view 4270 of the email application, overlaying the view 4256. In FIG. 418, an input 4272 is detected on the display mode affordance 4274 (e.g., serves as a drag handle) of the slide-over view 4270, and the input includes movement of the input 4272 toward a side edge (e.g., the right side edge) of the display. In response to detecting the input and in accordance with a determination that a current location of the input 4272 is within the predefined region 4264, a representation of the slide-over view 4270 is displayed with an appearance (e.g., elongated application affordance that is also expanded laterally) that indicates that, if the input were to end at the current location, the slide-over view 4270 will be converted to a slide-over view overlaying the original background view 4256. In some embodiments, visual feedback also includes reducing the overall size of the background view 4256 to a representation 4256′ and revealing a background 4266 underneath the representation 4256′. In response to detecting that the input continues to the side edge (e.g., the right side edge) of the display, the slide-over view 4270 is removed from the display and replaced by an edge affordance 4276, shown in FIG. 4B19, similar to the process described in FIGS. 4A1-4A4. The edge affordance 4276 remains on the display for a period of time before the edge affordance 4276 begins to fade. The device ceases to display the edge affordance 4276 after a threshold amount of time.

In FIG. 4B20, an input 4278 is detected on the slide-over view 4270, and the input includes movement of the input 4278 in a fifth direction (e.g., vertically (e.g., upward)) across the display. In response to detecting the input 4278, the slide-over view 4270 is removed from the display, as shown in FIG. 4B21, and the slide-over view is removed from the stored stack of slide-over views in memory. In other words, the slide-over view is “closed.”

In FIG. 4B22, an input 4280 is detected at a location that corresponds to a drag handle region of the slide-over view 4204 (e.g., near the top edge of the view 4204, near the display mode affordance 4203), and the input includes movement of the input 4280 in the third direction (e.g., leftward, substantially horizontal) toward a side edge of the display (e.g., a left edge of the display). FIG. 4B22 shows the slide-over view 4270 being dragged across the display, overlaying a portion of the view 4256. In addition to the input 4280, the slide-over view 4270 may also be dragged by movement of contacts near edges of the slide-over view 4270 (e.g., as shown in FIG. 4B8). When the input 4280 terminates as a leftward swipe input, the slide-over view 4270 slides off the display, and an edge affordance is displayed on the edge of the display (e.g., the left edge of the display), similar to that shown in FIG. 4B9. In some embodiments, unlike the edge affordance 4210, the edge affordance on the left edge of the display does not fade. The edge affordance 4246 on the left edge of the display disappears when multimedia (e.g., videos, presentations) content is played in a full-screen mode.

In addition to dragging content items as shown in FIGS. 4B13-4B17, an application affordance or a representation of an application can also be dragged in the manner described in FIGS. 4B13-4B17 to create additional views of split-screen display views and slide-over views.

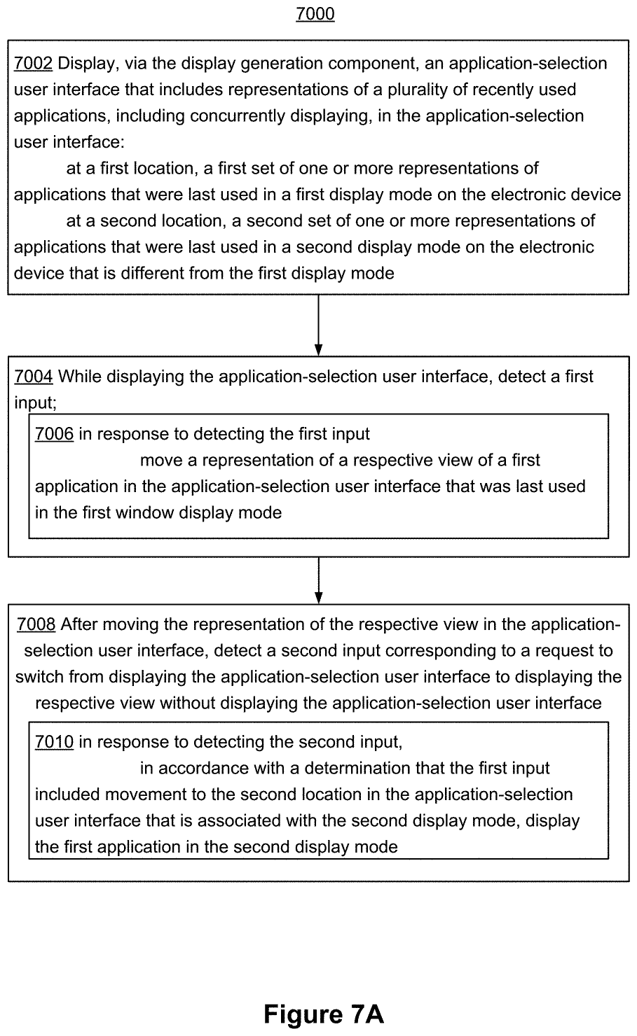

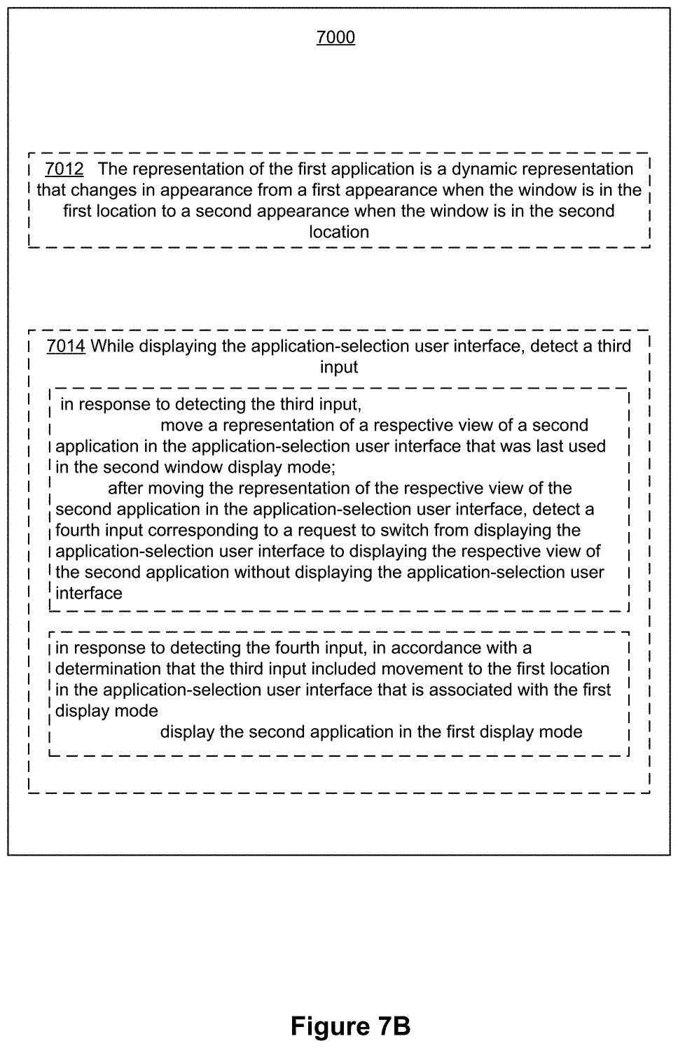

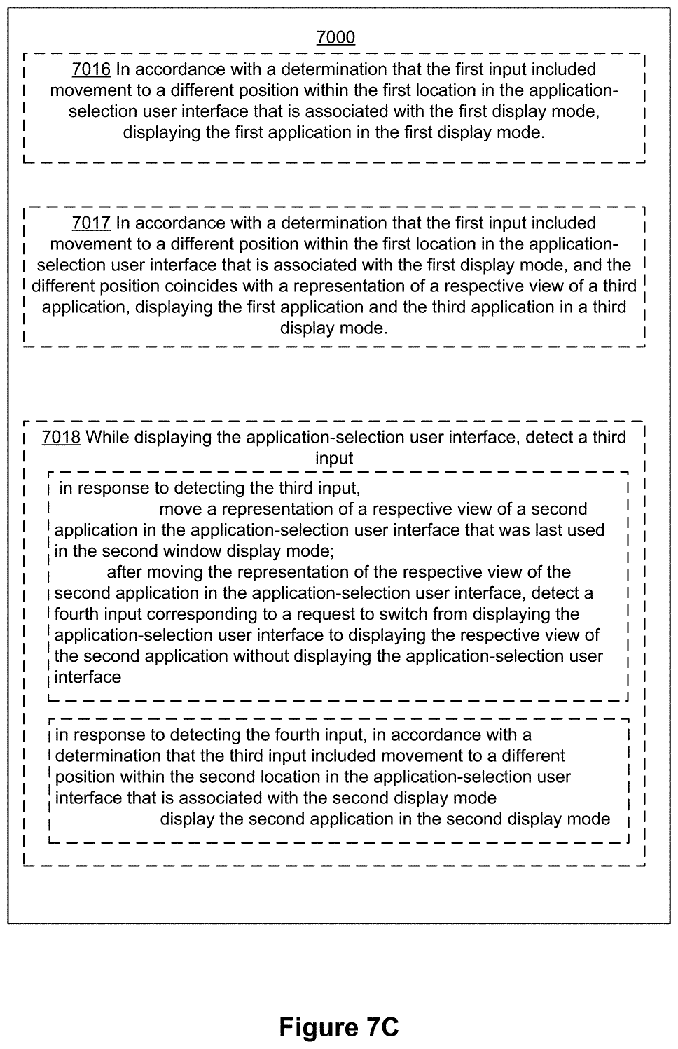

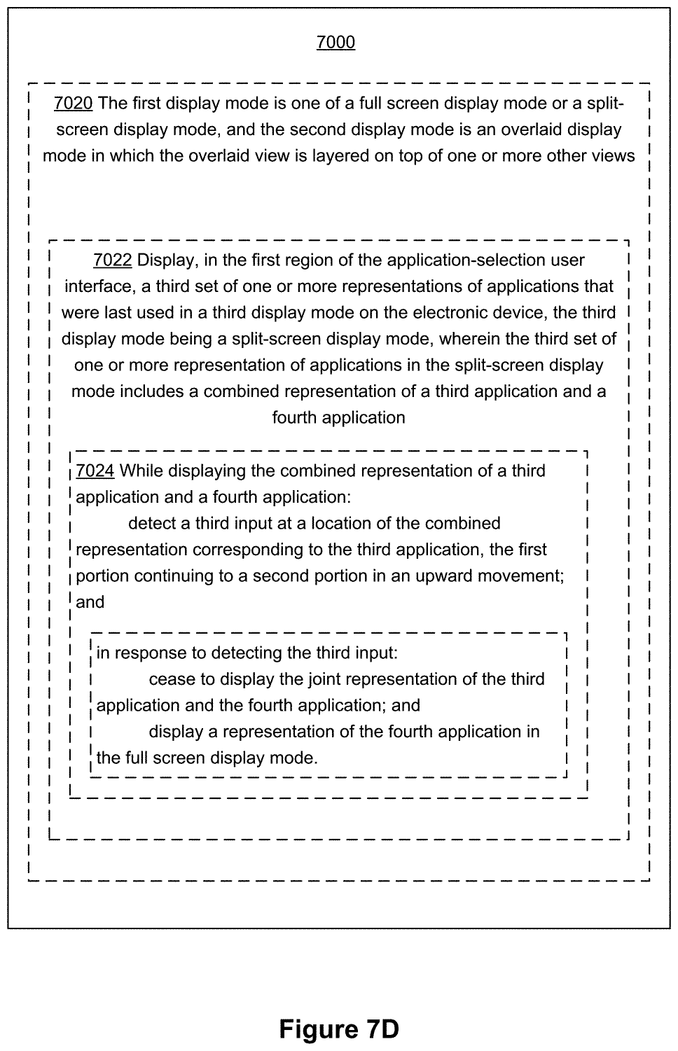

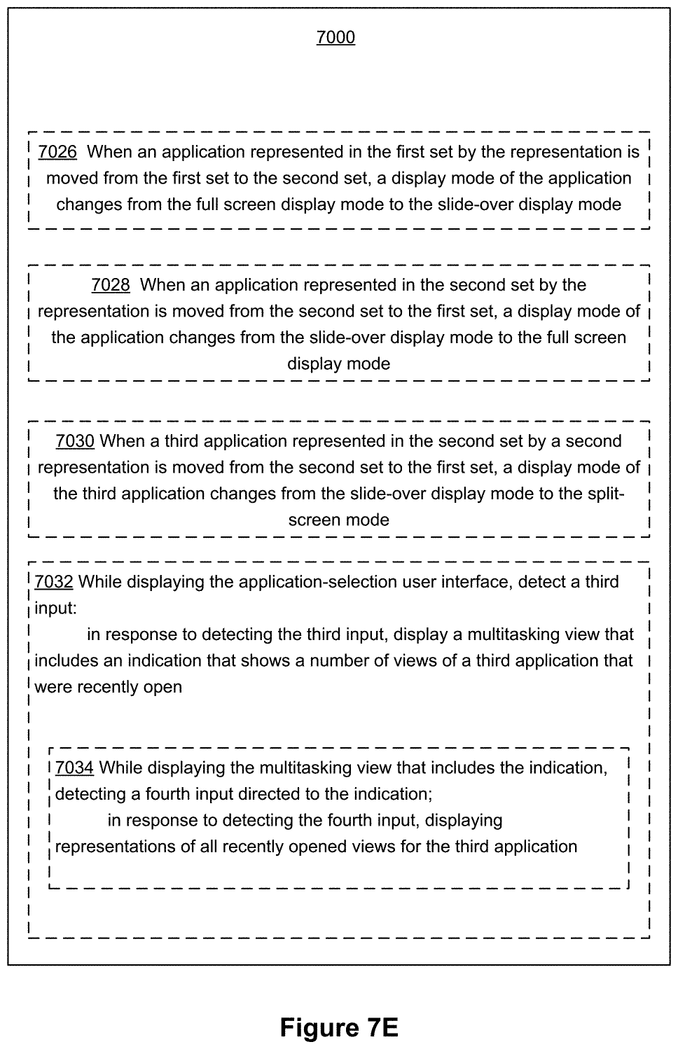

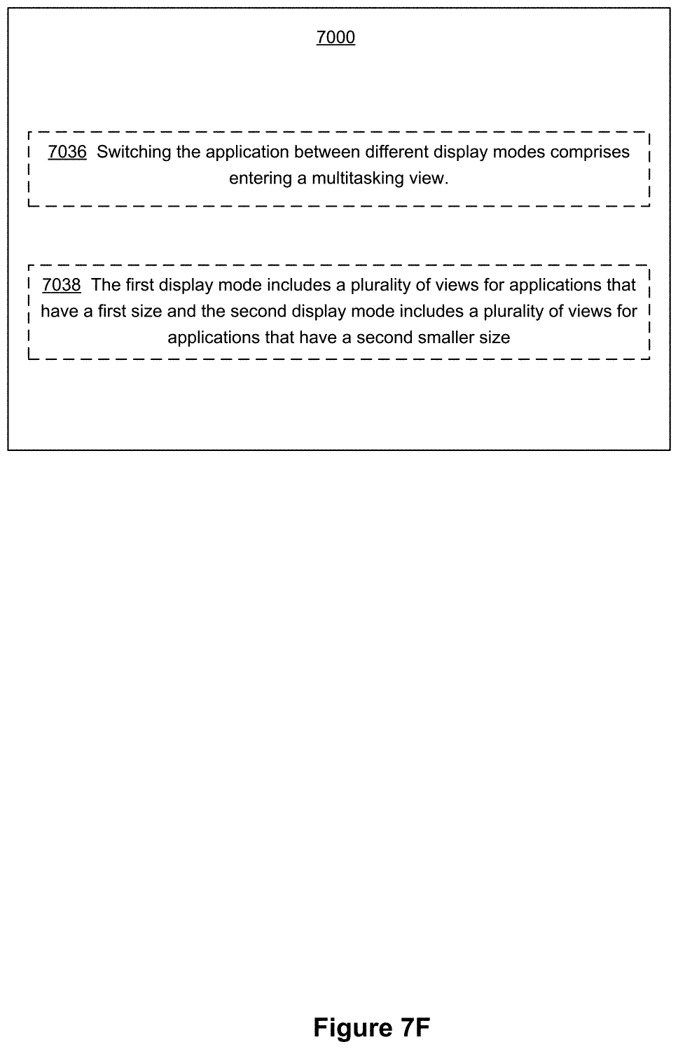

FIGS. 4C1-4C14 illustrate processes for dragging and dropping a representation of an application at different locations (e.g., a first region on the left and a second region on the right) in a display view-affordance switcher user interface, in accordance with some embodiments. The user interfaces in these figures are used to illustrate the processes described below, including the processes in FIGS. 7A-7F. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIG. 4C1 shows an application selection user interface 4300. An application selection user interface displays representations of a plurality of recently open applications (e.g., arranged in an order based on the time that the applications were last displayed). The representation of a respective recently open application (e.g., a snapshot of a last displayed user interface of the respective recently open application), when selected (e.g., by a tap input), causes the device to redisplay the last-displayed user interface of the respective recently open application on the screen. In some embodiments, the application selection user interface displays views of different display configurations (e.g., full-screen views, slide-over views, and split-screen views, views and/or draft views, etc.) that may correspond to the same or different applications.

A request to display an application selection user interface that includes representations of a plurality of recently open applications involves an input by a contact is detected at a location within a bottom edge region of the touch-screen, and the input includes movement of the input in a first direction (e.g., upward) toward the top edge of the touch-screen. In accordance with a determination that the input meets application selection display criteria (e.g., the speed, the direction, and/or distance of the input meets predefined speed and/or distance thresholds for navigating to the application selection user interface), a current display state of the screen transitions into displaying the application selection user interface 4300 (e.g., also referred to as a multitasking user interface) (e.g., FIG. 4C1). In some embodiments, an animated sequence is displayed starting at the current display state of the screen and transitioning to displaying the application selection user interface 4300. In such an animated sequence, a full-screen view of a current display is reduced in size and moves upward with the movement of the input. In some embodiments in which the current display includes a slide-over view overlaying the full-screen view, the slide-over view is reduced in size and moves away from the representation of the full-screen view, such that they are no longer overlapping At least a portion of other views stored in the memory of the device (e.g., recently open views with stored states in memory), including full-screen views, split-screen views, and slide-over views that are currently available on the device to be recalled to the display with the stored display states are presented on the application-selection user interface 4300. In some embodiments, instead of detecting the request for displaying the application selection user interface 4300 while a slide-over view is displayed over a full-screen view, the request for displaying the application selection user interface is detected while the device concurrently displaying the second application and the first application in the respective concurrent display configuration.

FIG. 4C1 illustrates the application selection user interface 4300, including representations of full-screen views (e.g., a representation 4306 for a view of a full-screen messaging application, a representation 4308 for a full-screen email application, a representation 4310 for a full-screen browser application, a representation 4312 for a full-screen calendar application), and representations for slide-over views (e.g., a representation 4314 for a slide-over view of a messaging application, a representation 4316 for a slide-over view of a browser application). The application selection user interface 4300 is displayed in a single-view display mode, occupying substantially all areas of the display, without concurrent display of another application on the screen. The application selection user interface 4300 includes representations of a plurality of application views corresponding to the plurality of recently open applications, including one or more first application views that are full-screen views and one or more slide-over views to be displayed with another application view, including any of the first application views. FIGS. 4C4-4C6 illustrate representations for pairs of views displayed in the split-screen mode (e.g., a representation 4326 for a browser view and a calendar view displayed in the split-screen mode).

In some embodiments, views with different display configurations are grouped and shown in different regions of the application selection user interface 4300, and within each group, the views are ordered in accordance with respective timestamps for when the views were last displayed. For example, in a region 4302 including the representations for the slide-over views, a view for a messaging application is the most recently displayed slide-over view, and its corresponding representation 4314 is displayed in the leftmost position in a row, with the representation 4316 for a slide-over view of a browser application displayed next to it. The slide-over views represented by the representation 4316 was displayed at times earlier than when the view for the messaging application was last displayed.

Similarly, a region 4304 (e.g., a left portion of the application selection user interface 4300) includes the representations for the full-screen views and the split-screen views. A view for a calendar application is the most recently displayed full-screen view, and its corresponding representation 4312 is displayed in the bottom rightmost position in a row, with the representation 4310 for a full-screen view of a browser application displayed above to it. The full-screen views represented by the representations 4310, 4308, and 4306 were displayed at times earlier than when the view for the calendar application was last displayed.

In FIG. 4C1, an input 4318 is detected on a portion of the application selection user interface 4300, and the input includes movement of the input 4318 in a second direction (e.g., horizontally (e.g., rightward)) across the display. In response to detecting the input 4318 and in accordance with a determination that the input meets preset criteria (e.g., a location of the input 4318 is not any representations, and a direction of movement of the input 4318 is horizontal), the device scrolls the application selection user interface 4300 to reveal representations of slide-over views that are not currently displayed or fully displayed in the application selection user interface 4300, as shown in FIG. 4C2. For example, in FIG. 4C2, the representation 4316 is fully displayed, and a representation 4320 associated with a photos application is also fully displayed. In some embodiments, the scrolling of the application selection user interface 4300 is performed as long as the input includes more than a threshold amount movement in the horizontal direction. In some embodiments, the representations displayed near one side of the display (e.g., the representations 4306 and 4308) gradually moves off the display on the left and the representations on the other side of display gradually comes onto the display in accordance with the movement of the input 4318, as shown in FIGS. 4C2. In some embodiments, representations that are moved off the display are added to the end of the stack (e.g., the stack with its end and its beginning connected to each other, analogous to a circular carousel) and redisplayed on the other side of the display with continued movement of the input 4318 in the same direction. In some embodiments, the direction of scrolling is determined in accordance with the direction of the movement of the input across the display.

In some embodiments, each representation of an application view in the application selection user interface 4300 is displayed with an identifier (e.g., an application name and an application icon) for the application of the view, and with an identifier (e.g., a view name that is automatically generated based on the content of the view) for the view of the application.

In FIG. 4C2, an input 4322 is detected on a portion of the application selection user interface 4300, and the input includes movement of the input 4322 in a third direction (e.g., horizontally (e.g., leftward)) across the display. In response to detecting the input 4322 and in accordance with a determination that the input meets preset criteria (e.g., a location of the input 4322 is not on any representations, or not on a representation after a long press on the representation that would normally allow movement of the representation, and a direction of movement of the input 4322 is substantially horizontal), the device scrolls the application selection user interface 4300 leftward to reveal representations of other representations, e.g., full-screen views that are not currently displayed or fully displayed in the application selection user interface 4300, as shown in FIG. 4C3.

In some embodiments, each representation of a view in the application selection user interface, when activated (e.g., by a tap input), causes the device to redisplay that view on the display. If the activated representation corresponds to a full screen view (e.g., a view corresponding to the representation 4306 or a view corresponding to the representation 4308), then the view is recalled to the screen in the full-screen, stand-alone display configuration, without another application being concurrently displayed on the screen. In some embodiments, even if the full-screen view was last displayed concurrently with another slide-over view on top, when the full-screen view is recalled to the screen from the application selection user interface 4300, the full-screen view is displayed without the slide-over view on top. In some embodiments, if the full-screen view was last displayed concurrently with another slide-over view on top, when the full-screen view is recalled to the screen from the application selection user interface 4300, the full-screen view is displayed with the slide-over view on top. In some embodiments, when the representation of a slide-over view (e.g., the representation 4314 of a view, or the representation 4316 of a view) is activated in the application selection user interface 4300, the slide-over view is recalled to the display with the full-screen or split screen view (e.g., the view 4010, the view 4034, or a pair of views in the split-screen configuration) that was previously displayed concurrently under the slide-over view. In some embodiments, the view underlying the slide-over view is the full-screen view or the pair of split-screen views that was on display immediately prior to the display of the application selection user interface 4300. In some embodiments, the view underlying the slide-over view is the last view that was concurrently displayed with the slide-over view. In some embodiments, when a representation (e.g., the representation 4326 or the representation 4331 in FIG. 4C5) of a pair of split-screen views (e.g., two applications displayed side-by-side) is activated in the application selection user interface 4300, the pair of split-screen view is recalled to the display together in the split-screen mode.

In FIG. 4C3, an input 4324 is detected on a portion of the application selection user interface 4300 that corresponds to a location of a representation (e.g., the representation 4310), and the input includes movement of the input 4324 in a third direction (e.g., horizontally, vertically, diagonally, or along any other path) across the display. In response to detecting the input 4324 and in accordance with a determination that the input meets preset criteria (e.g., a location of the input 4324 is on a first representation, there is movement of the contact, and a lift-off of the is detected over a second representation, different from the first representation), the device ceases to display the representation 4310. Instead, the view corresponding to the first representation (e.g., a browser application) and the view 4164 corresponding to the second representation (e.g., a calendar application) are associated (e.g., pinned) as a pair of split-screen views, and represented together in the application selection user interface 4300 by a single split-screen representation. In addition, in some embodiments, each view of the pair of split-screen views is also counted as an open view for its respective application in the application-selection user interface corresponding to the respective application. In some embodiments, the pair of split-screen views is represented in the application selection user interface 4300 by a single representation 4326. In some embodiments, the pair of split-screen views are recalled to the display from the application selection user interface, when the single representation of the pair of split-screen views is selected (e.g., by a tap input). The first representation on which the input begins and the second representation on which the input terminates do not both have to be full-screen display mode representations as shown in FIG. 4C3). Instead, as shown in FIG. 4C4, an input by input 4328 is detected on a portion of the application selection user interface 4300 that corresponds to the region 4302 where representations of slide-over views are displayed, and the input 4328 terminates in the region 4304 where presentations of full-screen views and split-screen views are displayed.

The input 4328 is detected at a location of a representation (e.g., the representation 4316) of a slide-over view, and the input includes movement of the input 4328 in a fourth direction (e.g., horizontally, vertically, diagonally, or along any other path) across the display. In response to detecting the input 4328 and in accordance with a determination that the input meets preset criteria (e.g., a location of the input 4328 is on a first representation, there is movement, and a lift-off of the input 4328 is detected on a second representation, different from the first representation), the device ceases display of the representation 4316. Instead, the view corresponding to the first representation (e.g., a browser application) and the view 4164 corresponding to the second representation (e.g., a mail application) are associated (e.g., pinned) as a pair of split-screen views, and represented together in the application selection user interface 4300 by a single split-screen representation 4331, as shown in FIG. 4C5. In some embodiments, while the input 4328 moves from the region 4302 to the region 4304, a dynamic representation 4330 is concurrently presented. The dynamic representation that changes in appearance from a first appearance (e.g., more elongated slide-over representation) when the view is in the first location (e.g., the region 4302) to a second appearance (e.g., less dull-screen representation) when the view is in the second location (e.g., the region 4304 (e.g., each representation of the one or more first and second sets of representations are dynamic representations that have a first appearance when representing an application in a first display mode and a second appearance when representing an application in the second display mode, for example, the dynamic representations have different appearances depending on whether they are at the first location or the second location).

In some embodiments, the input 4328 is continuously evaluated against the location criteria corresponding to different predefined regions on the display for different operations performed after the end of the input (e.g., a representation moves within the same region, a representation moves to a different region, a representation moves to create a new split-screen view, etc.), and the visual feedback is dynamically updated to indicate a corresponding possible outcome if the input were to end at the current location. Before the end of the input 4328 is detected, movement of the input 4328 drags the a representation t from the region 4302 to a location outside of the region 4302 (e.g., into the region 4304), and as a result, the visual feedback is dynamically updated to indicate that the location criterion for displaying the representation in a slide-over view is no longer met, and the application corresponding to the representation will be displayed in a full-screen view or split-screen view.

Representations dismissed from the application selection user interface can be removed from the memory of the device (e.g., from the current state of the device). In FIG. 4C5, an input 4332 is detected on a portion of the application selection user interface 4300 that corresponds to a representation 4306, and the input includes movement of the input 4332 in a fourth direction (e.g., vertically/upward to the top edge or with a quick upwards flick such as a movement with a speed or acceleration greater than a predetermined threshold) across the display. In response to detecting the input 4332 and in accordance with a determination that the input meets preset criteria (e.g., a location of the input 4332 is on a representation, and a direction of movement of the input 4332 is vertical), the device dismisses the representation 4306 by removing the representation from the application selection user interface 4300, as shown in FIG. 4C6. When an input for displaying the application selection user interface is detected, the now closed or terminated full-screen view will also not be shown among all of the representations of all recently open applications. Ceasing to display a representation of an application view in accordance with a determination that an input is directed to the representation of the application reduces the number of controls used to close an application (e.g., swiping up at a representation of an application in the application selection user interface to dismiss the application instead of a long-press following by tapping on a closing affordance (e.g., an “x” symbol) to close the application).

In addition to combining views into a split-screen display view by dragging a representation of a full-screen view (e.g., FIG. 4C3) or a representation of a slide-over view (e.g., FIG. 4C4) onto another representation, a split-screen view's representation can be converted to a full-screen view as shown in FIG. 4C6. An input 4334 is detected at a location of a representation (e.g., the representation 4326) of one application in a split-view representation. If the input remains on the contact for a predetermined threshold amount of time (e.g., a 1 second long press), and the input then includes movement in a fourth direction (e.g., horizontally, vertically, diagonally, or along any other path) across the display to an empty position within the first location, then the application may be split out from the split-screen view representation into a full-view representation. In other words, in response to detecting the input 4336 and in accordance with a determination that the input meets preset criteria (e.g., a location of the input 4336 is on a first representation in the region 4304 for a threshold amount of time, followed by movement, and a lift-off of the input 4336 at a location in the region 4302 that is free of any representation), the device ceases to display of the representation 4310. Instead, the view corresponding to the split screen view in the representation 4326 that was not selected 4334 is resized into the representation 4310 of a full-screen view (e.g., a browser application) and the split screen view in the representation 4326 that was selected 4334 terminating in the region 4304 that is free of any representation is presented as the representation 4312 of a full-screen view (e.g., a calendar application), as shown in FIG. 4C7.

In FIG. 4C8, an input 4336 is detected at a location of a representation (e.g., the representation 4310) of a representation in the region 4304, and the input includes movement in a fourth direction (e.g., horizontally, vertically, diagonally, etc.) across the display. In response to detecting the input 4336 and in accordance with a determination that the input meets preset criteria (e.g., a location of the input 4336 is on a first representation, and a lift-off of the input 4336 was detected within a location in the region 4302 that is free of any representation), the device ceases to display the representation 4310. Instead, a new representation 4338 corresponding to a slide-over view of the same application (e.g., a browser application) is displayed in the region 4302, effectively converting the application corresponding to the representation 4310 from a full-screen display mode to a slide-over display mode, as shown in FIG. 4C9. In some embodiments, a dynamic representation of the representation 4310, similar to the dynamic representation 4330, as described above in FIG. 4C4 is concurrently displayed during the movement of the input 4336. The representation 4338 also indicates that a new slide-over view is adding to a listing of slide-over views stored in the memory of the device (e.g., in addition to the slide-over views corresponding to the representation 4314 and 4316). The removal of the representation 4310 also removes the full-screen view associated with the representation 4310 from a listing of the one or more full-screen views stored in the memory of the device. The application selection user interface 4300 allows display modes of various applications to be changed without exiting the application selection user interface 4300, providing both an efficient way to display an overview of the applications currently opened on the device and a way to modify the display mode of one or more of the currently opened applications. The efficiency may derive from (i) allowing the user to use fewer steps or inputs to access the desired view, (ii) providing a more intuitive arrangement of currently opened applications to the user to interaction with the device. Using fewer steps or inputs also helps to reduce wasted battery energy, and consumes less processing power because users may avoid having to repeat their inputs to cancel incorrectly or inadvertently provided inputs.

In FIG. 4C10, an input 4340 is detected at a location of a representation (e.g., the representation 4338) of a representation in the region 4302, and the input includes movement of the input 4340 in a fourth direction (e.g., horizontally, vertically, or diagonally) across the display. In response to detecting the input 4340 and in accordance with a determination that the input meets preset criteria (e.g., a location of the input 4340 is on a first representation, and a lift-off of the input 4340 was detected within a location in the region 4304 that is free of any representation), the device ceases display of the representation 4310. Instead, the representation 4310 corresponding to full-screen view of the same application (e.g., a browser application) is displayed in the region 4304, effectively converting the application corresponding to the representation 4310 from a slide-over display mode to a full-screen display mode, as shown in FIG. 4C11. In some embodiments, a dynamic representation of the representation 4310, similar to the dynamic representation 4330, as described above in FIG. 4C4 is concurrently displayed during the movement of the input 4340. The representation 4338 also indicates that the slide-over view is removed from a listing of the one or more slide-over views stored in the memory of the device. The addition of the representation 4310 also adds the full-screen view associated with the representation 4310 to a listing of the zero or more full-screen views stored in the memory of the device. The application selection user interface 4300 allows display modes of various applications to be changed without exiting the application selection user interface 4300, providing both an efficient way to provide an overview of the applications currently opened on the device and a way to modify the display mode of one or more of the currently opened applications.

FIGS. 4C12-4C14 shows how a view-selector user interface may be accessed from the application selection user interface 4300. In some embodiments, the application selection user interface does not show separate representations for each instance of an application that has a saved state (e.g., recently used applications that have not been closed). Instead, an application selection user interface represents all instances of the same application (e.g., multiple instances of the Photos application) with a single representation. In some embodiments, this single representation is a view of the last used instance of the application. In some embodiments, the single representation of multiple instances of the same application with a saved state also includes a numeral representing the number of instances of that application with a saved state. For example, if there are two instances of the Web Browser with a saved state, then the numeral 2 is displayed, as shown by 4342 in FIG. 4C12. In some embodiments, a user may collate or bundle instances of the same application together in the application selection user interface (e.g., FIG. 4C12) by toggling a control settings. Similarly, the user can turn off this control setting so that each instance of the application includes a separate representation (e.g., as shown in FIG. 4C1.

A user may enter the application selection user interface 4400 shown in FIG. 4C12 from the application selection user interface 4300 by using a long press or other input. In some embodiments, when more than one display view corresponding to a particular application is recently opened in the device, an indicator 4342 displays a number of views associated with the particular application (e.g., two full-screen display views are associated with the browser application). In some embodiments, the representation displayed in the application selection user interface 4400 is the most recently used instance of the application. The application selection user interface 4400 (e.g., a multitasking view) bundles all instances (with a saved state) of the same application together and shows a representation of the most recently viewed instance and a numerical indicator (e.g., the indicator 4342) showing the number of instances (with a saved state) of that application.

In FIG. 4C12, an input 4344 is detected on the indicator 4342 for the associated application (e.g., a browser application in a full-screen display view). In response to detecting the input 4344, the device ceases to display the application selection user interface 4400 and displays a view-selector user interface 4346, as shown in FIG. 4C13.

The view-selector user interface 4346 shows the same number of representations corresponding to opened display views shown in the indicator 4342 (e.g., representations 4350 and 4352 of one full-screen representation of the browser application and one slide-over representation of the browser application). A input on either of these representations causes the device to cease to display the view-selector user interface region 4346, and display the view associated with the representation (e.g., for a full-screen view of the browser application is displayed when a tap input is received at a location of the representation 4350). The view-selector user interface 4346 also includes a new view affordance (e.g., the “plus” button or the “new” button 4354 in the view-switcher user interface 4346) that, when activated, causes display of a user interface for generating a new instance or view of the application (e.g., a “new” button, displayed concurrently with the respective representations of the multiple views of the application, which, when activated, causes creation and display of a new instance in a new view of the application). In some embodiments, after selecting the new window affordances, an overlay is displayed with selectable affordances for opening a new instance of the application in different modes, e.g., full screen, slide-over, split screen etc., similar to that described above in relation to FIG. 4A4.

An input 4348 detected at a location on a view-selector user interface 4346 causes the device to cease displaying the view-selector user interface 4346 and to return to the application selection user interface 4300, as shown in FIG. 4C14.

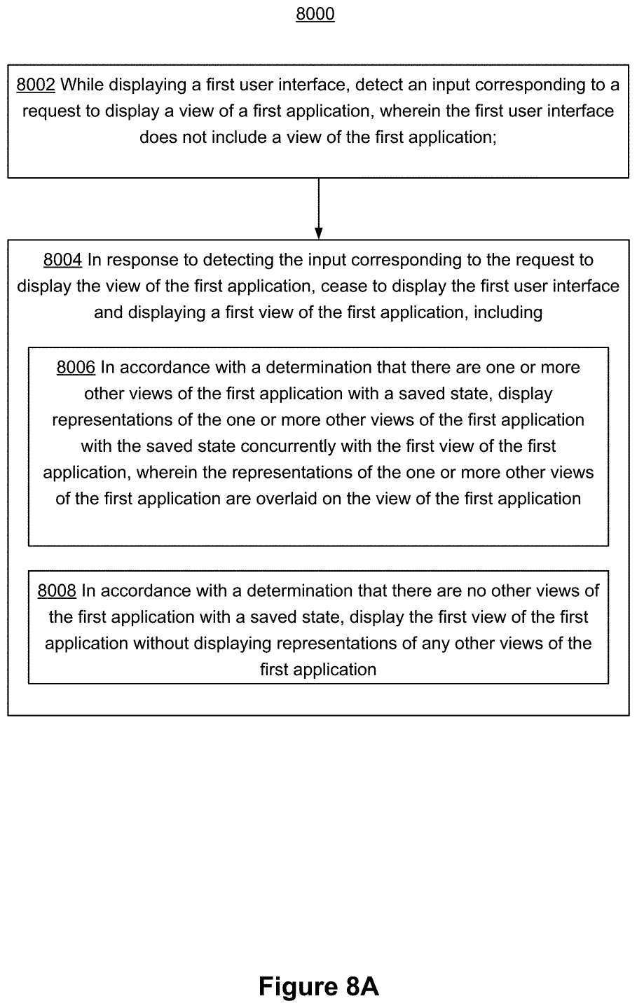

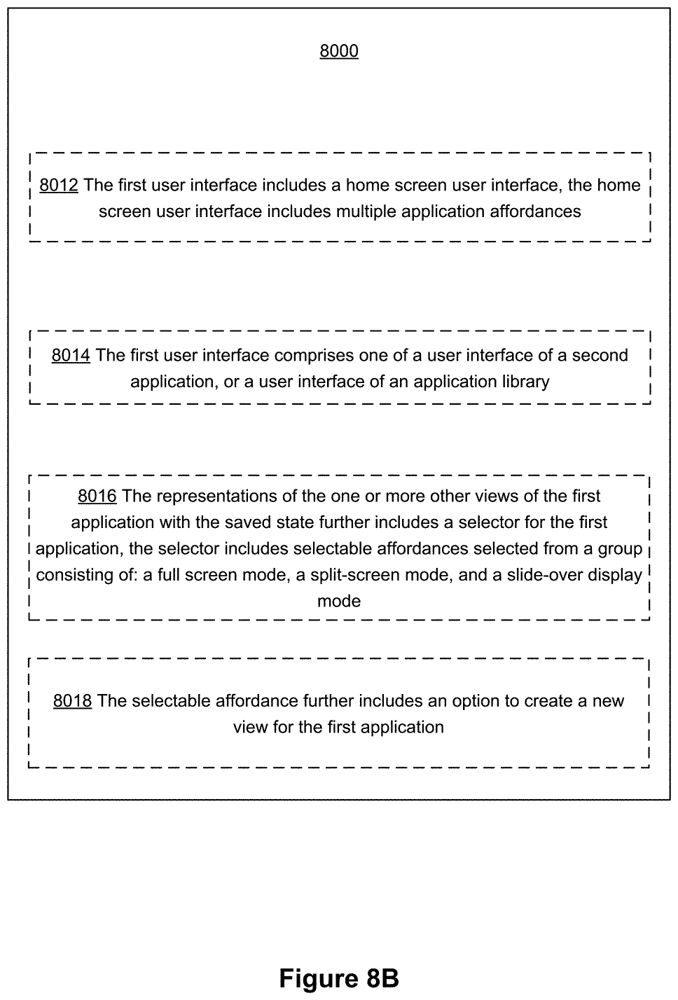

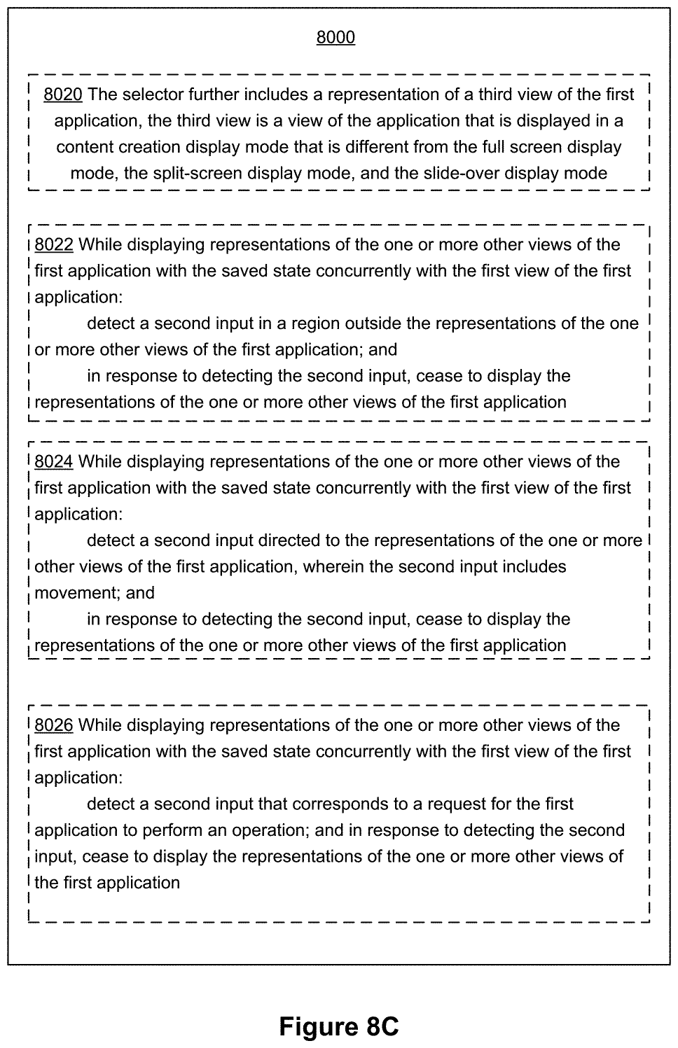

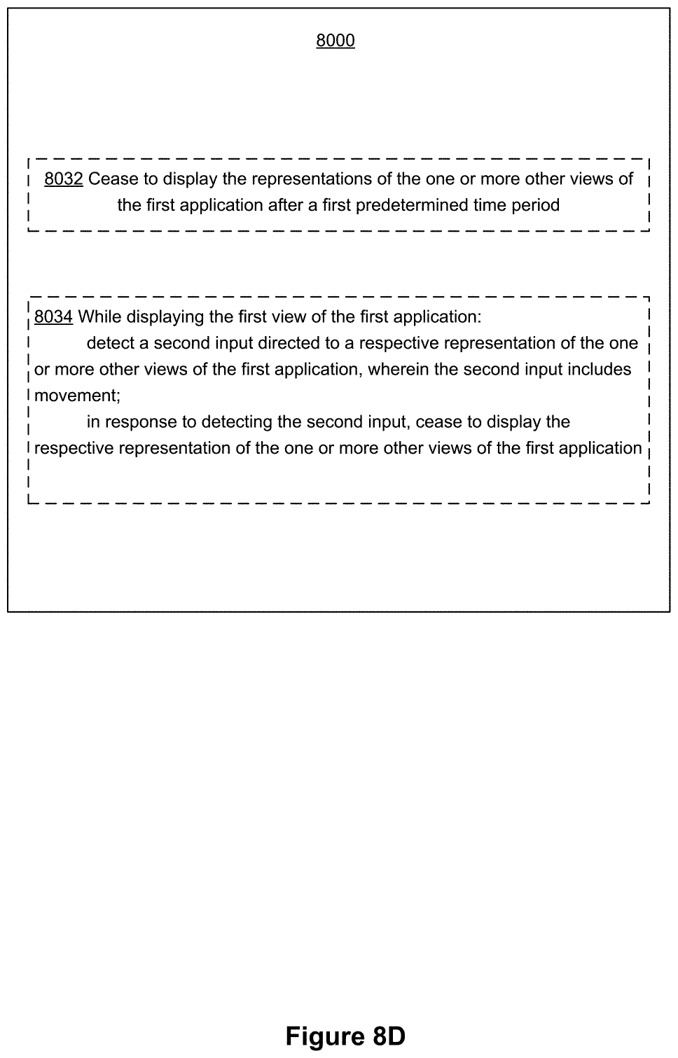

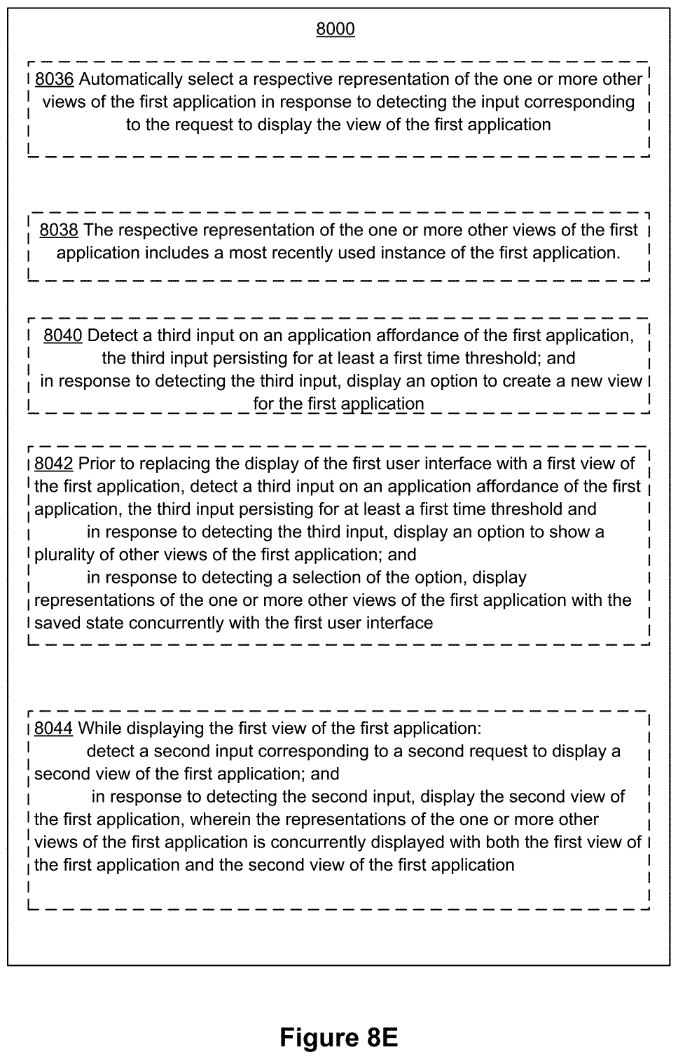

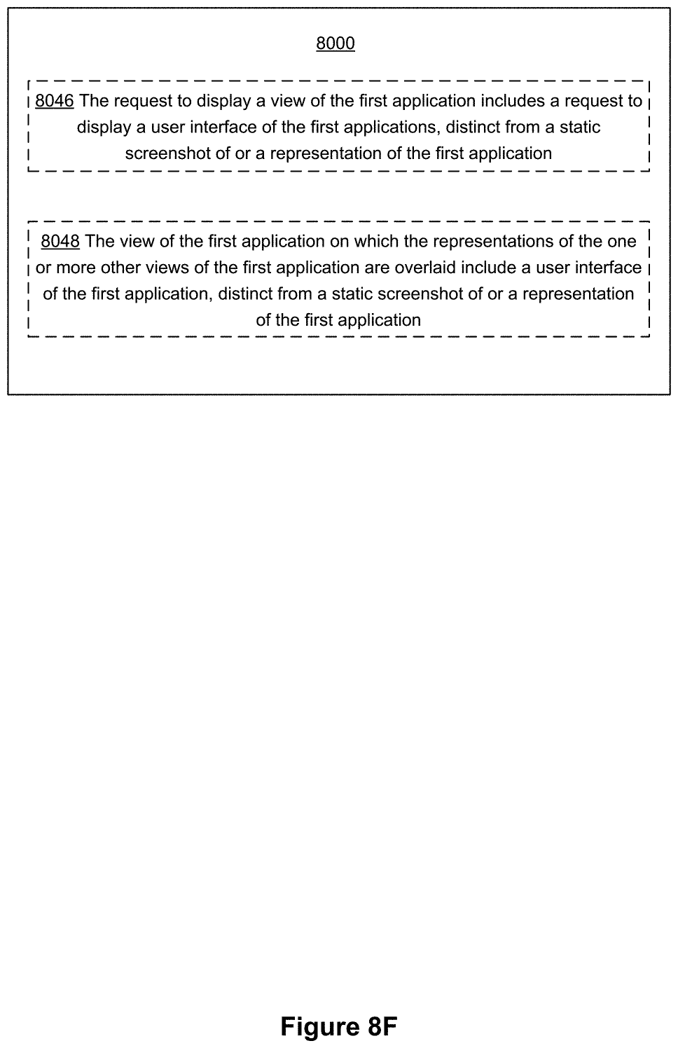

FIGS. 4D1-4D11 illustrate processes interaction with a view-selector shelf user interface (referred to below as a view-selector shelf), in accordance with some embodiments. The user interfaces in these figures are used to illustrate the processes described below, including the processes in FIGS. 8A-8F. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIG. 4D1 shows an application selection user interface 4400 that includes representations of full-screen views (e.g., a representation 4402 for a view of a full-screen messaging application, a representation 4404 for a full-screen email application, a representation 4406 for a full-screen calendar application, a representation 4408 for a full-screen browser application). The application selection user interface 4400 is displayed in a single-view display mode, occupying substantially all areas of the display, without concurrent display of another application on the screen. The application selection user interface 4400 includes representations of a plurality of application views corresponding to the plurality of recently opened or used applications, also referred to as views of an application with a saved state, including one or more first application views that are full-screen views, including any of the first application views.

When more than one display view corresponding to a particular application is recently opened or used in the device, an indicator 4412 displays a number of views associated with the particular application (e.g., five different display views are associated with the browser application). Applications that are recently opened or used may refer to applications that are opened or used since the last reboot of the system, and are applications with working data reflecting a current state of use of the application that are stored or saved in the memory of the device.

In FIG. 4D1, an input 4414 is detected at a location of a representation (e.g., the representation 4408) of an application. In response to detecting the input 4414 and in accordance with a determination that the input meets a selection criteria (e.g., it is a tap input, a location of the input 4414 is on a representation), a further determination is made regarding whether there are more than one views open for the application corresponding to the representation. In order words, the input 4414 within the first user interface (e.g., the application selection user interface 4400) corresponds to a request to display a view of a first application (e.g., the browser application), and that the first user interface does not include a view of the first application. In response to detecting the input corresponding to the request to display the view of the first application, and in accordance with a determination that there are one or more other views of the first application with a saved state, the device ceases to display the first user interface (e.g., the application selection user interface 4400) and displays a first view of the first application (e.g., a full-screen view of a browser application corresponding to the representation 4408) concurrently with a view-selector shelf 4418, as shown in FIG. 4D2. The view-selector shelf 4418 includes representations of the one or more other views of the first application with the saved state, and the view-selector shelf 4418 is overlaid on or over the view (here a full-screen view) of the first application.

As shown in FIG. 4D1, an input 4417 is detected at a location of a representation (e.g., the representation 4404) of an application. In response to detecting the input 4417 and in accordance with a determination that the input meets a selection criteria (e.g., it is a tap input, a location of the input 4417 is on a representation), a further determination is made regarding whether there are more than one views open for the application corresponding to the representation. The input 4417 within the first user interface (e.g., the application selection user interface 4400) corresponds to a request to display a view of a second application (e.g., the mail application). The first user interface does not include a view of the second application. In response detecting the input corresponding to the request to display the view of the second application, and in accordance with a determination that there no other views of the second application with a saved state, the device ceases to display the first user interface (e.g., the application selection user interface 4400) and displays a first view of the second application (e.g., a full-screen view of a mail application corresponding to the representation 4404) without concurrently with a view-selector shelf.

The view-selector shelf 4416 includes representations of the one or more other views of the first application with the saved state, and the view-selector shelf 4416 is overlaid on the view of the first application.

FIGS. 4D1-4D7 illustrate a heuristic according to which, if there are multiple views associated with an application, when a request to display a view of the application is detected, a view-selector shelf region is displayed to allow the user to select a view from the multiple views to be opened; and if there is a single view associated with the application, the single view associated with the application, instead of the view-selector region, is displayed, in accordance with some embodiments.

In accordance with a first branch of the heuristic, in a scenario where a selected application (e.g., the representation 4404 of the mail application in the application selection user interface 4400) is currently associated with zero other views (e.g., the selected application is launched from the dock, and the selected application is has no other recently opened or used instances of the application or only a single view (e.g., only one recently open view is saved in memory, the representation 4404 of the mail application in the application selection user interface 4400), the device opens the application in a the display mode of the one recently open view (e.g., a full screen display mode without any view-selector shelf overlaying the background view corresponding to the application associated with the representation 4404).

In some embodiments, if the application is associated with no views, (e.g., because it was not recently opened or used or because the views associated with the application were closed after they were last used) the full screen display view is displayed as a default view of the application. In some embodiments, if the application is associated with a single view, the view contains the content last shown in the single view. In some embodiments, the single view is a full-screen view, while in other embodiments, it is not. In some embodiments, the single view saved in memory is a split-screen view or a slide-over view before it is displayed in response to the input.

In accordance with a second branch of the heuristic, in a scenario where the application selected by the input (e.g., the browser application as shown in FIGS. 4D1 and 4D2) is currently associated with multiple views (e.g., multiple recently open views are saved in memory), when selected or invoked, the device opens a view-selector shelf region 4418 overlaying a portion of the background view 4420 (e.g., on a bottom region of the screen). In some embodiments, all the views associated with the application (e.g., saved in memory), irrespective of display configuration (e.g., full-screen, split-screen view, slide-over view, draft view, center view etc.), are available for viewing and selection (e.g., displayed initially, or displayed in response to a scroll or browsing input) in the view-selector shelf region 4418, except the view that is being currently displayed in the background view 4420. All views or views associated with a particular application at this time are displayed in the view-switcher user interface. Each representation of a view may additionally be displayed with an application affordance and a unique name of the view that is automatically generated based on the content of the view, to distinguish views with similar or identical content.

For example, as shown in FIG. 4D2, the background view 4420 is a full-screen display view of a first web page. A representation 4422 in the view-selector shelf 4418 shows another full-screen display view of the browser application displayed as second web page. If the background view 4420 is the only instance of a full-screen display view of the browser application, the view-selector shelf 4418 would not include the representation 4422. The view-selector shelf 4418 displays only representations of the other views of the application that is not displayed in the background view. A representation 4424 in the view-selector shelf 4418 shows a pair of split-screen display views having a browser application on the left half of the split-screen representation and a mail application on right half of the split-screen representation. A representation 4426 in the view-selector shelf 4418 shows a slide-over view of the browser application. A representation 4428 in the view-selector shelf 4418 shows a center view of the browser application. Center views are discussed in greater details in reference to FIGS. 5A1-5A11.

Depending on the number of open applications currently on the device, representations of some display views (e.g., split screen, slide-over, full-screen, center view) may not be included in the view-selector shelf 4418. Similarly, if there are multiple open views of a particular display mode (e.g., two instances of slide-over views for the browser application, two instances of split-screen views, multiple instances of center views) a representation for each of the instance is displayed in the view-selector shelf 4418. Like the scrolling function on the application-selector user interface described in FIGS. 4C1-4C2, the view-selector shelf 4418 may include scrolling functionality when there are too many representations to be displayed simultaneously in the view-selector shelf 4418.

As shown in FIG. 4D2, a view-selector shelf 4418 is concurrently displayed if the application (e.g., browser application) is associated with multiple views. Allowing the user to open the view-selector for the application affordance based on whether the application is associated with multiple views is intuitive and efficient. This helps to reduce the number and/or types of inputs the user needs to provide in order to achieve a desired outcome (e.g., selecting a particular instance of the application in a specific display mode) and to reduce the chance of user mistakes. For example, the user need not navigate to an application switcher, scroll through the listings to search for a particular open instance, and then select that open instance. The user interface provides a more efficient way of interaction that uses less memory and processing power, thereby reducing battery energy usage.

In addition to displaying the view-selector shelf 4418 via a selection of a representation in the application-selector user interface 4400 as shown in FIGS. 4D1-4D2, the view-selector shelf can be launched from an input to the dock as shown in FIGS. 4D3-4D11.

FIG. 4D3 shows a pair of split-screen views with a browser view 4430 on the left and a notes view 4432 on the right. An input 4434 that satisfies dock-display criteria (e.g., an upward edge swipe input by the input 4434) is detected on touch-screen 112 (e.g., near the bottom edge portion of the touch-screen 112), as shown in FIG. 4D3. In response to detecting the input that satisfies the dock-display criteria, the dock 4004 is displayed overlaying both the browser view 4430 and the notes view 4432 on the split-screen display, as shown in FIG. 4D4. The dock 4004 includes a plurality of application affordances (e.g., application icons), corresponding to different applications (e.g., affordance 216 for a telephony application, affordance 218 for an email application, affordance 4439 for a notes application, and affordance 4431 for a file folder). In some embodiments, the dock includes an application affordance of the currently displayed application (e.g., the browser application and the notes application) and one or more most recently displayed applications. In some embodiments, the dock is temporarily removed from the display in response to an input that meets dock-dismissal criteria (e.g., a downward swipe gesture on the dock that moves toward the bottom edge of the touch-screen).

An input 4436 is detected at a location that corresponds to the affordance 4439 for the notes application. In response to detecting the input 4436 and in accordance with a determination that the input meets a selection criteria (e.g., it is a tap input, and a location of the input 4436 is a tap on an icon), a further determination is made regarding whether there are more than one views open for the application corresponding to the selected affordance. The split-screen display of the views 4430 and 4432 includes a view of the notes application. In response detecting that the input corresponds to the request to display a view of the notes application, and in accordance with a determination that there are one or more other views of the notes application with a saved state, the device ceases to display the dock 4004 but maintains the display of the split-screen views 4430 and 4432 while concurrently displaying a view-selector shelf 4416, as shown in FIG. 4D5. The view-selector shelf 4416 includes representations of the one or more other views of the first application with the saved state, and the view-selector shelf 4438 is overlaid on the views of both the split-screen views 4430 and 4432.

A representation 4440 in the view-selector shelf 4438 shows another pair of split-screen display views having a browser application on the left half of the split-screen representation and a notes application on right half of the split-screen representation. If the background view 4420 is the only instance of a split-screen display view of the browser application, the view-selector shelf 4418 would not include the representation 4440. The view-selector shelf 4418 displays only representations of other views of the application that is not displayed in the background view (e.g., the background view in FIG. 4D5 is a pair of split-screen views). A representation 4442 in the view-selector shelf 4438 shows a slide-over view of the notes application.

Instead of a pair of split-screen views as shown in FIGS. 4D3-4D4, FIG. 4D6 shows a dock 4444 overlaying a background view 4446 of a photos application.

An input 4448 is detected at a location that corresponds to the affordance 220 for the browser application. In response to detecting the input 4448 and in accordance with a determination that the input meets a selection criteria (e.g., it is a tap input, a location of the input 4448 is on an icon), a further determination is made regarding whether there are more than one views recently used or opened (e.g., an application with a saved state) for the application corresponding to the affordance 220. The background view 4446 of the photos application does not include a view of the browser application. In response to detecting the input 4448 corresponding to the request to display the view of the browser, and in accordance with a determination that there are one or more other views of the browser application with a saved state, the device ceases to display the background view 4446 of the photos application and displays a first view of the browser application (e.g., a full-screen view 4420 of the browser application corresponding to the affordance 220) concurrently with a view-selector shelf 4416, as shown in FIG. 4D7. The view-selector shelf 4416 includes representations of the one or more other views of the browser application with the saved state, and the view-selector shelf 4416 is overlaid on the view of the browser application, which is the background view 4420, as shown in FIG. 4D7.

In FIG. 4D8, an input 4450 is detected at a location in the dock that corresponds to the affordance 218 for the mail application. As shown, the background view 4446 is of the photos application, and does not include a view of the mail application. In response to detecting the input 4450 and in accordance with a determination that the input meets the predetermined criteria (e.g., it is an input persisting for at least a first threshold period of time, e.g., a touch-hold time threshold, or it is an input that meets an intensity threshold, e.g., of a light-press-and-hold, and there is no movement of the input, and a location of the input 4450 is on an icon), a menu 4452 of selectable options 4454 is displayed for managing the view management of the application corresponding to the selected application affordance (e.g., the mail application). An input 4456 is detected on a first selectable option 4454 for showing all views. In response to detecting the input 4456, corresponding to the request to show/display all views of the mail application, and in accordance with a determination that there are one or more other views of the mail application with a saved state, the device ceases to display the background view 4446 of the photos application and displays a first view of the mail application (e.g., a full-screen view 4457 of the mail application corresponding to the affordance 218) concurrently with a view-selector shelf 4458, as shown in FIG. 4D10. The view-selector shelf 4458 includes representations of the one or more other views of the mail application with the saved state, and the view-selector shelf 4416 is overlaid on the view of the background full-screen view 4457 of the mail application, as shown in FIG. 4D10.

The view-selector shelf 4416 includes representations of the one or more other views of the first application with the saved state, and the view-selector shelf 4438 is overlaid on the views of both the split-screen views 4430 and 4432.

A representation 4462 in the view-selector shelf 4458 shows a pair of split-screen display views having a browser application on the left half of the split-screen representation and a mail application on the right half of the split-screen representation. The background full-screen view 4567 is the only instance of a full-screen display view of the mail application, and the view-selector shelf 4458 does not include a representation corresponding to the full-screen view. The view-selector shelf 4418 displays only representations of other views of the application that are not displayed in the background view. Representation 4464 in the view-selector shelf 4458 shows a slide-over view of the mail application, and representation 4460 in the view-selector shelf 4458 shows a center view of the mail application.

An input 4466 is detected at a location that corresponds to the representation 4460 of the mail application. In response to detecting the input 4466 and in accordance with a determination that the input meets a selection criteria (e.g., it is a tap input, there is no movement of the input, and a location of the input 4450 is on the representation 4460), the view-selector user interface 4458 ceases to be displayed, and instead, a center view 4468 of the mail application is displayed, as shown in FIG. 4D11. With this center view, the background full-screen view 4458 is darkened, dimmed or blurred while the center view 4468 is displayed. The center view is automatically displayed at a location in a central portion of the display. A display mode affordance 4470 is also displayed on the center view 4468. More details about the center view 4468 is described below in reference to FIG. 4E1-4E11.

In some embodiments, for displaying a second application as an slide-over view overlaying a background view of a first application, if the second application has multiple views open, the representations of the multiple views of the second application are displayed (e.g., in a view-selector user interface for the second application), and the user selects one of the multiple views to display with the first application in the slide-over configuration (e.g., by tapping on the representation of the desired view of the second application in the view-selector user interface).

In some embodiments, the representations of the views include an identifier for the application, and a unique name corresponding to each of the views. In some embodiments, the name of the views are automatically generated by the device in accordance with the displayed content of the view (e.g., a title, username, subject line, etc. of the document, email, message, webpage, image, etc.). In some embodiments, the view-selector user interface includes a close affordance for closing the view-selector user interface, without closing the saved views of the application. In some embodiments, the view-selector user interface includes an affordance for closing all of the views associated with the application, without closing the view-selector user interface. In some embodiments, the view-selector includes an affordance for opening a new view of the application (e.g., the affordance 4680 shown in FIG. 4E12).

FIG. 4E1, like FIG. 4B13, shows a full-screen view 4256 of an email application (e.g., in a standalone configuration). An input 4600 is detected at a location that corresponds to a content item 4260 representing a content item (e.g., an email message from MobileFind). In accordance with a determination that the input 4600 meets predetermined criteria (e.g., it is an input persisting for at least a first threshold period of time, the input has met the touch-hold time threshold or the intensity threshold of a light press input, there is no movement of the input, and a location of the input 4450 is on a selectable content item), the device highlights the object 4260 to indicate that the long-press criteria has been met.

As shown in FIG. 4E2, the device then displays a menu 4602 of selectable options for content management of the selected content item 4260. An input 4606 is detected on a first selectable option 4604 for opening a new view. In response to detecting the input 4606, corresponding to the request to open a new view of the content item 4260 (also referred to as an object), the device displays the full-screen view 4256 as a background view by dimming, darkening, or blurring the full-screen view 4256, as shown in FIG. 4E3, and the content item 4260 is displayed in a center view 4608. The center view has a display mode affordance 4610 in a top region of the center view.

An input 4612 is detected on a location corresponding to the display mode affordance 4610. In response to detecting the input 4612, the device optionally ceases to display the display mode affordance 4610 and displays a selection panel 4614 that includes different selectable display mode options corresponding to different display modes. The selectable display mode options include, for example, a full screen display mode affordance 4616, a split-screen display mode affordance 4618, a slide-over display mode affordance 4620, and a center view display mode affordance 4622. The selectable display mode option that corresponds to the currently selected display mode (e.g., the center view display mode of the center view 4608) is visually distinguished from the other selectable display mode options (e.g., the center display mode affordance 4622 is highlighted by an indicator 4624 like a circular shaded indicator to provide visual feedback to the user.

The center view is not only accessible from a full-screen view (e.g., the full-screen view 4256 of the mail application as shown in FIG. 4E1), but from any view, such as the split-screen view 4626 shown in FIG. 4E5 that has a mail application on the left and a browser application on the right.

An input 4630 is detected at a location that corresponds to the content item 4260 representing a content item (e.g., an email message from MobileFind). In accordance with a determination that the input 4630 meets predetermined criteria (e.g., a long press), the device highlights the object 4260.

As shown in FIG. 4E6, the device displays the menu 4602 of selectable options for content management of the selected content item 4260. An input 4632 is detected on a first selectable option 4604 for opening a new view. In response to detecting the input 4632, corresponding to the request to display open a new view of the content item 4260, the device maintains the split-screen view 4626 as a background view by dimming, darkening, or blurring the views 4626/4628, as shown in FIG. 4E3. The content item 4260 is displayed in a center view 4608. The center view shows the display mode affordance 4610 in the top region of the center view.

An input 4634 is detected on a location corresponding to the display mode affordance 4610. In response to detecting the input 4634, the device ceases to display the display mode affordance 4610 and displays the selection panel 4614 that includes different selectable display mode options corresponding to different display modes, as described in reference to FIG. 4E4. An input 4636 is detected at a location corresponding to the split-screen display mode affordance 4618. The center view 4608 changes into a split-screen view in two ways—the center view 4608 may replace the split-screen view 4626 (of the mail application), or it may replace the split-screen view 4628 (of the browser application). In response to detecting the input 4636, the device ceases to display the selection panel 4614, and displays a disambiguation affordance 4638, shown in FIG. 4E9. The disambiguation affordance 4638 includes a left selection affordance 4341 to indicate that the center view 4608 will replace the split-screen view 4626 on the left, and a right selection affordance 4642 to indicate that the center view 4608 will replace the split-screen view 4628 on the right. An input 4644 is detected on a location corresponding to the right selection affordance 4642. In response to detecting the input 4666, the device ceases to display the center view 4608, and displays the split-screen view 4626 on the left, together with the split-screen view 4668 (converted from the center view 4608), as shown in FIG. 4E10.

The center view may also be displayed in front of a background view of a different application. In FIG. 4E11, the center view 4608 of the mail application is displayed in front of a background view of a browser application. An input 4670 is detected near a top region of the center view 4608 close to the display mode affordance 4610 (or on the display mode affordance 4610). In accordance with a determination that the input 4670 is a downward swipe input, and in accordance with a determination that the downward swipe input meets view-closing criteria (e.g., meets the distance and speed criteria of the view-closing criteria), the center view 4608 is no longer displayed.

In some embodiments, once the view is closed, and in accordance with a determination that the application corresponding to the background view is currently associated with multiple views (e.g., multiple recently open views are saved in memory), the device opens a view-selector shelf 4673 overlaying a portion of the background view 4672 (e.g., on a bottom region of the display). The view-selector shelf 4673 has been described in detail with respect to FIGS. 4D1-4D11. In some embodiments, the view-selector shelf 4673 includes a “new” affordance 4680 for invoking another instance or view of the application (e.g., browser application).

Additional descriptions regarding FIGS. 4A1-4A25, 4B 1-4B22, 4C1-4C14, 4D1-4D11, and 4E1-4E12 are provided below in references to methods 5000, 6000, 7000, and 8000.

FIGS. 5A-5F are a flowchart representation of a method of 5000 of interacting with multiple views in a respective concurrent-display configuration (e.g., a split-screen display configuration), in accordance with some embodiments. FIGS. 4A1-4A25, 4B 1-4B22, 4C1-4C14, 4D1-4D11, and 4E1-4E12 are used to illustrate the methods and/or processes of FIGS. 5A-5F. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D.

In some embodiments, the method 5000 is performed by an electronic device (e.g., portable multifunction device 100, FIG. 1A and/or one or more components of the electronic device (e.g., I/O subsystem 106, operating system 126, etc.). In some embodiments, the method 5000 is governed by instructions that are stored in a non-transitory computer-readable storage medium and that are executed by one or more processors of a device, such as the one or more processors 122 of device 100 (FIG. 1A). For ease of explanation, the following describes method 5000 as performed by the device 100. In some embodiments, with reference to FIG. 1A, the operations of method 5000 are performed by or use, at least in part, a multitasking module (e.g., multitasking module 180) and the components thereof, a contact/motion module (e.g., contact/motion module 130), a graphics module (e.g., graphics module 132), and a touch-sensitive display (e.g., touch-sensitive display system 112). Some operations in method 5000 are, optionally, combined and/or the order of some operations is, optionally, changed.

As described below, the method 5000 provides intuitive ways to interact with multiple application views. The method reduces the number of inputs required from a user to interact with multiple application views and, thereby, ensures that battery life of an electronic device implementing the method 5000 is extended, since less power is required to process the fewer number of inputs (and this savings will be realized over and over again as users become increasingly familiar with the more intuitive and simple gesture). As is also explained in detail below, the operations of method 5000 help to ensure that users are able to engage in sustained interactions (e.g., they do not need to frequently undo behaviors, which interrupts their interactions with their devices) and the operations of method 5000 help to produce more efficient human-machine interfaces. Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, method 5000 is performed at an electronic device including a display generation component (e.g., a display like the touch-sensitive display 112 (FIG. 1A), a projector, a heads-up display, etc.) and one or more input devices including a touch-sensitive surface (e.g., a touch-sensitive surface that is coupled to a separate display, or a touch-screen display (e.g., 112 in FIG. 1A) that serves both as the display and the touch-sensitive surface). The device concurrently displays (5002), by the display generation component, a first view of a first application in a first display mode (e.g., in a standalone-display configuration or mode, occupying substantially all areas of the display, without concurrent display of another application on the screen (e.g., as a full-screen view of the first application as shown in FIG. 4A2)). In some embodiments, a first user interface of the first application is not a system user interface, such as a home screen or springboard user interface from which applications can be launched by activating their respective application affordances (e.g., application icons)) and a display mode affordance. While displaying the first view of the first application, the device receives (5004) a sequence of one or more inputs including a first input selecting the display mode affordance (e.g., 4012 in FIG. 4A2). In response to detecting the sequence of one or more inputs, the device ceases to display (5006) at least a portion of the first view of the first application while maintaining display of a representation of the first application, and displays, via the display generation component, at least a portion of a home screen that includes multiple application affordances (e.g., the home screen includes various application affordances that are organized by a user of the device, a position of a respective application affordance within the home screen is chosen by a user). This is shown, for example in FIG. 4A4. While continuing to display the representation of the first application and after displaying the portion of the home screen (e.g., while continuing to display both the representation of the first application and the portion of the home screen), the device receives (5008) a second input (e.g., 4050 in FIG. 4A4) selecting an application affordance associated with a second application. In response to detecting the second input: the device concurrently displays (5010), via the display generation component, a second view of the first application and a first view of the second application (e.g., the first application and the second application that is an application other than the first application in a split-screen mode) (e.g., the second view of the first application and the first view of the second application include user interfaces of the concurrently displayed applications that are responsive to user inputs to perform operations within those applications (e.g., user interface objects within the user interfaces function as they normally would in a single-view display mode, and direct copy and paste and/or drag and drop functions are available across the two or more concurrently displayed applications)). In some embodiments, the first application and the second application are distinct applications. This is illustrated, for example, in FIGS. 4A1-4A25.

In some embodiments, in response to receiving the first input, the device displays (5016), via the display generation component, a selection panel (e.g., 4020 in FIG. 4A3) having a plurality of display mode options, including a first display mode option corresponding to a full screen display mode (e.g., in a standalone-display configuration or mode, occupying substantially all areas of the display, without concurrent display of another application on the screen (e.g., as a full-screen view of the first application). In some embodiments, a second view of a first application and a first view of a first application are displayed side-by-side with no overlap between the views of the two applications. This is shown, for example in FIG. 4A5. Such side-by-side display is distinct from an application selection or view-switcher user interfaces (e.g., as shown in FIG. 4C1) that concurrently display representations of multiple open applications or application views that are not responsive to user inputs to perform operations within the applications. This is illustrated in FIGS. 4A19-4A21 and 4A28-4A29, following FIG. 4A12, for example. Displaying via a display generation component a selection panel having a plurality of display mode options, including a first display mode option corresponding to a full screen display mode, provides improved visual feedback to a user (e.g., displaying multiple selectable display mode options on a display generation component in response to inputs). Providing improved visual feedback to the user enhances the operability of the device and makes the user-device interface more efficient (e.g., allowing the user to select different display mode options and to view and interact with multiple applications on a user interface), which, additionally, reduces power usage and improves battery life of the device by enabling the user to use the device more quickly and efficiently.

In some embodiments, the display generation component includes a display screen (5018), and wherein the first display mode is the full screen mode where the first view of the first application occupies substantially an entire display area of the display screen. An example of an application 4010 displayed in a full screen mode is shown in FIG. 4A2, See also, 4010 in FIG. 4A3, 4010 in FIG. 4A13, 4122 in FIG. 4A16, and 4122 in FIG. 4A18. Displaying a first display mode that is the full screen mode where the first view of the first application occupies substantially an entire display area of the display screen provides improved visual feedback to a user (e.g., displaying a first view of the first application that occupies substantially an entire display area of the display screen). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, a respective display mode option of the plurality of display mode options that corresponds (5020) to a currently selected display mode is visually distinguished from one or more other display mode options in the plurality of display mode options. This is illustrated, for example, by 4028 in FIGS. 4A3 and 4A13, a circle around the rightmost display mode option in 4257 in FIG. 4B12, and 4622 in FIGS. 4E4 and 4E8. Displaying a respective display mode option of the plurality of display mode options that corresponds to a currently selected display mode that is visually distinguished from one or more other display mode options in the plurality of display mode options provides improved visual feedback to a user (e.g., highlighting the currently selected display mode to the user interface provides a visual reminder to the user). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments the display mode affordance includes a plurality of display mode options each representing (5022) a different option for arranging views of one or more applications views. This is illustrated by, for example, 4022, 4024, and 4026 in FIGS. 4A3 and 4A13, 4616, 4618, 4620, and 4622 in FIGS. 4E4, and 4E8. Displaying a display mode affordance that includes various display mode options each representing a different option for arranging views of one or more applications provides improved visual feedback to the user (e.g., displaying selectable options of other available display modes). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, displaying the representation of the first application displayed while displaying the portion of the home screen includes displaying a portion of the first view at an edge of the home screen. This is illustrated, for example, by 4040 in FIGS. 4A4, 4A6, 4A7, 4A10, 4A14, and 4A15, 4144 in FIGS. 4A21 and 4A22. Displaying (5024) the representation of the first application while displaying the portion of the home screen includes displaying a portion of the first view at an edge of the home screen provides improved visual feedback to the user (e.g., displaying a portion of the first view at an edge of the home screen reminds a user the first application that will be displayed in a concurrent display mode). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, the home screen includes (5026) multiple affordances including a first affordance for invoking a first application and a second affordance for invoking a second application that is different from the first application. These different affordances are shown, for example, as the Messages, Calendar, Settings, Camera, GarageBand, Stocks, Maps, and Weather affordances in FIGS. 4A1, 4A4, 4A6, 4A10, 4A14, 4A15, and 4A17. Displaying the home screen includes multiple affordances including a first affordance for invoking a first application and a second affordance for invoking a second application that is different from the first application provides improved visual feedback to a user (e.g., allowing a user quick access to all the installed applications on the device). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, the first view of the first application occupies (5028) a majority of a display area (as shown, for example, by 4010 in FIG. 4A2); and the representation of the first application occupies a minority of the display area (as shown, for example, by 4040 in FIG. 4A4) (e.g., a majority being equal to or greater than half and minority being less than half). Displaying a first view of the first application that occupies a majority of a display area; and displaying a representation of the first application that occupies a minority of the display area provides improved visual feedback to a user (e.g., displaying a representation on a display generation component in response to inputs). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, displaying the second view of the first application and the first view of the second application includes displaying (5030) (i) a side-by-side display of the second view of the first application and the first view of the second application (e.g., a split-screen view as shown by 4052 and 4054 in FIG. 4A5), or displaying (ii) one of the second view of the first application and the first view of the second application overlaid over the other (e.g., a slide-over view overlaying a portion of one of the second view of the first application or the first view of the second application, as shown for example by 4122 and 4120 in FIG. 4A16) See also other similar views in FIGS. 4A9, 4A12, 4A17-4A18, 4A20, and 4A23. Displaying the second view of the first application and the first view of the second application includes displaying (i) a side-by-side display of the second view of the first application and the first view of the second application, or displaying (ii) one of the second view of the first application and the first view of the second application overlaid over the other provides improved visual feedback to a user (e.g., displaying multiple applications on a display generation component in response to inputs). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, the second view of the first application is (i) a smaller view of the first application (e.g., compare 4010 in FIG. 4A3 to 4052 in FIG. 4A5), or (ii) a view of the first application that is the same size as the first view of the first application (5032). The second view of the first application being (i) a smaller view of the first application, or (ii) a view of the first application that is the same size as the first view of the first application provides improved visual feedback to a user (e.g., displaying multiple applications on a display generation component in response to inputs). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, the second view of the first application and the first view of second application occupy (5034) substantially an entire display area (e.g., 4052 and 4054 in FIG. 4A5). This can also be seen in other similar examples, shown in FIGS. 4A9, 4A12, 4A16-4A18, 4A20, and 4A23. Displaying the second view of the first application and the first view of second application occupy substantially an entire display area provides improved visual feedback to the user (e.g., providing increased viewing area to the user for viewing multiple applications). Providing improved visual feedback enhances the operability of the device and makes the user-device interface more efficient (e.g., allowing the user to interact with multiple applications on a user interface), which, additionally, reduces power usage and improves battery life of the device by enabling the user to use the device more quickly and efficiently.

In some embodiments, the second input selecting an application affordance associated with the second application includes selecting (5036) an application affordance in a dock portion of a display (e.g., the mail affordance 218 in the dock 4004 in FIG. 4A26), and in response to detecting the second input, displaying the second view of the first application (4158 in FIG. 4A27) and the first view of the second application (4160 of FIG. 4A27) side-by-side in a split screen mode (e.g., overlaying the first view of the second application over the second view of the first application comprises maintaining display the first view of the first application in a full screen mode and displaying at least a portion of the first view of the second application overlaid over a portion of the first view of the first application). Selecting an application affordance in a dock portion of a display reduces the number of inputs needed to perform an operation (e.g., the operation to open a first view of a second application having an affordance in the dock portion of the display). Reducing the number of inputs needed to perform an operation enhances the operability of the device and makes the user-device interface more efficient (e.g., allowing the user to interact with multiple applications with a single input on a user interface), which, additionally, reduces power usage and improves battery life of the device by enabling the user to use the device more quickly and efficiently.

In some embodiments, while maintaining display of the representation of the first application (e.g., at an edge of the display region) (e.g., 4040 in FIG. 4A6), the device navigates (5038) through a system user interface prior to receiving a selection (e.g., 4072 in FIG. 4A6) of the application affordance (e.g., 244 in FIG. 4A6) associated with the second application view. See also FIGS. 4A7-4A12, for example. Navigating through a system user interface prior to receiving a selection of the application affordance associated with the second application reduces the number of inputs needed to perform an operation (e.g., the ability to search in a folder for an application affordance, or to perform as search on the home screen). Reducing the number of inputs needed to perform an operation enhances the operability of the device and makes the user-device interface more efficient (e.g., allowing the user to interact with multiple applications with fewer inputs on a user interface), which, additionally, reduces power usage and improves battery life of the device by enabling the user to use the device more quickly and efficiently.

In some embodiments, navigating through the system user interface includes searching (5048) for the second application in a search user interface (e.g., 4064 in FIG. 4A8) prior to receiving a selection of the application affordance (e.g., 244 in FIG. 4A6) associated with the second application. Searching for the second application in a search user interface prior to receiving a selection of the application affordance associated with the second application reduces the number of inputs needed to perform an operation (e.g., the ability to search on the home screen). Reducing the number of inputs needed to perform an operation enhances the operability of the device and makes the user-device interface more efficient (e.g., allowing the user to interact with multiple applications with fewer inputs on a user interface), which, additionally, reduces power usage and improves battery life of the device by enabling the user to use the device more quickly and efficiently.

In some embodiments, navigating through the system user interface includes opening (5050) a folder (e.g., 4084 in FIG. 4A11) that includes the application affordance (e.g., 4088 in FIG. 4A11) associated with the second application prior to receiving a selection of the application affordance associated with the second application. Opening a folder that includes the application affordance associated with the second application prior to receiving a selection of the application affordance associated with the second application reduces the number of inputs needed to perform an operation (e.g., the ability to browse through application affordances in a folder). Reducing the number of inputs needed to perform an operation enhances the operability of the device and makes the user-device interface more efficient (e.g., allowing the user to interact with multiple applications with fewer inputs on a user interface), which, additionally, reduces power usage and improves battery life of the device by enabling the user to use the device more quickly and efficiently.

In some embodiments, while maintaining display of the representation of the first application (e.g., 4040 in FIG. 4A14), the device navigates (5052) between home screen pages to display a home screen page (e.g., 4110 in FIG. 4A15) that includes the application affordance associated with the second application prior to receiving a selection of the application affordance (e.g., 228 in FIG. 4A15) associated with the second application. Navigating between home screen pages to display a home screen page that includes the application affordance associated with the second application prior to receiving a selection of the application affordance associated with the second application provides additional control options without cluttering the UI with additional displayed controls (e.g., an input at the location corresponding to the content causes the content to be displayed in an application view), and enhances the operability of the device, which, additionally, reduces power usage and improves battery life of the device by enabling the user to use the device more quickly and efficiently.

In some embodiments, after receiving the second input: while concurrently displaying the second view of the first application and the first view of the second application (e.g., as shown in FIG. 4A20), receiving (5054) a second sequence of one or more inputs including a third input selecting the display mode affordance (e.g., as shown by 4056 in FIG. 4A20); and in response to detecting the second sequence of one or more inputs: the device displays, via the display generation component, at least a portion of the home screen that includes multiple application affordances (e.g., as shown in FIGS. 4A21 and 4A22) to provide an application selection mode for selecting an application affordance associated with a third application (e.g., the Messages affordance in FIG. 4A22); the device receives a fourth input to edit the home screen (e.g., a long press input directed to a portion of the home screen), in response to receiving the fourth input, terminating the application selection mode. Terminating the application selection mode in response to receiving the fourth input affordance provides additional control options without cluttering the UI with additional displayed controls (e.g., allowing the user to affordance edit a home screen by exiting the application selection mode), and enhances the operability of the device, which, additionally, reduces power usage and improves battery life of the device by enabling the user to use the device more quickly and efficiently.

In some embodiments, the device concurrently displays (5056), via the display generation component: the first view of the second application (e.g., 4054 in FIG. 4A20); and a second display mode affordance (e.g., 4058 in FIG. 4A23) associated with the second application; and in response to detecting a fourth input (e.g., 4150 in FIG. 4A23) selecting the second display mode affordance followed by a movement of the selection, the device ceases to display the first view of the second application and displays the representation of the first application (e.g., as shown in FIG. 4A25). Ceasing to display the first view of the second application and displaying the representation of the first application provides additional control options without cluttering the UI with additional displayed controls (e.g., allowing the user to view switch out an application for display in a split-screen mode), and enhances the operability of the device, which, additionally, reduces power usage and improves battery life of the device by enabling the user to use the device more quickly and efficiently.

In some embodiments, the movement of the selection includes moving (5058) the selection to a bottom edge of a display and/or moving the selection downward at a speed that exceeds a speed threshold (e.g., as shown in FIG. 4A23). Moving the selection to a bottom edge of a display and/or moving the selection downward at a speed that exceeds a speed threshold provides additional control options without cluttering the UI with additional displayed controls (e.g., allowing the user to switch out an application for display in a split-screen mode view), and enhances the operability of the device, which, additionally, reduces power usage and improves battery life of the device by enabling the user to use the device more quickly and efficiently.

In some embodiments, the device concurrently displays (5060), via the display generation component: the second view of the first application (e.g., 4052 in FIG. 4A20); the first view of the second application (e.g., 4054 in FIG. 4A20); a second display mode affordance (e.g., 4058 in FIG. 4A20) associated with the first view of the second application; and a third display mode affordance (e.g., 4056 in FIG. 4A20) associated with the second view of the first application; and the device detects a sequence of one or more inputs including a fourth input; and in response to detecting the sequence of one or more inputs including the fourth input that selects the second display mode affordance, the device ceases to display the first view of the second application and displays the first view of the first application (e.g., as shown in FIG. 4A20), and the device ceases to display the second view of the first application (e.g., concurrently displaying the first view of the first application and displaying a second view of the second application) (e.g., 4058 in FIG. 4A2). Ceasing to display the first view of the second application and displaying the first view of the first application provides additional control options without cluttering the UI with additional displayed controls (e.g., removing the first view of the second application from the split), and enhances the operability of the device, which, additionally, reduces power usage and improves battery life of the device by enabling the user to use the device more quickly and efficiently.

In some embodiments, the device concurrently displays (5062), via the display generation component: the second view of the first application (e.g., 4052 in FIG. 4A9); the first view of the second application (e.g., 4076 in FIG. 4A9); and an affordance (e.g., 4056 in FIG. 4A9) for repositioning the second view of the first application, an affordance (e.g., 4074 in FIG. 4A9) for repositioning the first view of the second application, or one or more affordances for repositioning the second view of the first application and for repositioning the first view of the second application (e.g., a swap affordance or an affordance (e.g., 4059 in FIG. 4A9) that can be dragged to move that view from one position on a screen to another). Displaying an affordance for repositioning the first view of the second application, or affordances for repositioning the second view of the first application and for repositioning the first view of the second application provides additional control options without cluttering the UI with additional displayed controls (e.g., repositioning and swapping views of the applications), and enhances the operability of the device, which, additionally, reduces power usage and improves battery life of the device by enabling the user to use the device more quickly and efficiently.

In some embodiments, the device concurrently displays (5064), via the display generation component a first view of a third application (e.g., 4608 in FIG. 4E7) displayed over one or more of: the second view of the first application and the first view of the second application, and a second display mode affordance (e.g., 4610 in FIG. 4E7 and/or 4614 in FIG. 4E8) associated with the first view of the third application. While concurrently displaying the first view of the third application and the second display mode affordance, the device detects a fifth input (e.g., 4636 in FIG. 4E8) selecting the second display mode affordance (e.g., 4618 in FIG. 4E8) to enter a split view mode; in response to detecting a sequence of one or more inputs including the fifth input selecting the second display mode affordance to enter a split view mode: providing an affordance (e.g., 4338 in FIG. 4E9) for obtaining a disambiguation of whether to replace the second view of the first application or the first view of the second application with a second view of the third application. Providing an affordance for obtaining a disambiguation of whether to replace the second view of the first application or the first view of the second application with a second view of the third application provides additional control options without cluttering the UI with additional displayed controls (e.g., obtaining disambiguation which of two split-screens to replace), and enhances the operability of the device, which, additionally, reduces power usage and improves battery life of the device by enabling the user to use the device more quickly and efficiently.

In some embodiments, the plurality of view affordances includes (5066) one or more of a split-screen view affordance (e.g., 4618 in FIG. 4E8), a full-screen view affordance (e.g., 4616 in FIG. 4E8), an overlay view affordance (e.g., 4620 in FIG. 4E4), and a center view affordance (e.g., 4624 in FIG. 4E8). Similar affordances are shown, for example, in FIGS. 4A3, 4A13, 4B12, 4E4, and 4E8. Displaying a plurality of view affordances includes one or more of a split-screen view affordance, a full-screen view affordance, and an overlay view affordance provides improved visual feedback to a user (e.g., displaying different selectable display mode affordances to the user). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, the electronic device includes a display with a screen, and the second view of the first application (e.g., 4052 in FIG. 4A5) and the first view of the second application (e.g., 4054 in FIG. 4A5) together occupy substantially the entire screen (5058). Similar views can be seen, for example, in FIGS. 4A9, 4A12, 4A20. Displaying the second view of the first application and the first view of the second application together occupy substantially the entire screen provides improved visual feedback to a user (e.g., displaying two views concurrently to the user). Providing improved visual feedback to the user enhances the operability of the device and makes the user-device interface more efficient (e.g., allowing the user to view and interact with multiple applications on a user interface), which, additionally, reduces power usage and improves battery life of the device by enabling the user to use the device more quickly and efficiently.

In some embodiments, aspects/operations of methods 5000, 6000, 7000, and 8000 may be interchanged, substituted, and/or added between these methods. For brevity, these details are not repeated here.

FIGS. 6A-6D are a flowchart representation of a method 6000 of interacting with an application affordance while displaying an application, in accordance with some embodiments. FIGS. 4A1-4A27, 4B1-4B22, 4C1-4C14, 4D1-4D11, and 4E1-4E12 are examples that illustrate the methods of FIGS. 6A-6D. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D.

In some embodiments, the method 6000 is performed by an electronic device (e.g., portable multifunction device 100, FIG. 1A and/or one or more components of the electronic device (e.g., I/O subsystem 106, operating system 126, etc.). In some embodiments, the method 6000 is governed by instructions that are stored in a non-transitory computer-readable storage medium and that are executed by one or more processors of a device, such as the one or more processors 122 of device 100 (FIG. 1A). For ease of explanation, the following describes method 6000 as performed by the device 100. In some embodiments, with reference to FIG. 1A, the operations of method 6000 are performed by or use, at least in part, a multitasking module (e.g., multitasking module 180) and the components thereof, a contact/motion module (e.g., contact/motion module 130), a graphics module (e.g., graphics module 132), and a touch-sensitive display (e.g., touch-sensitive display system 112). Some operations in method 6000 are, optionally, combined and/or the order of some operations is, optionally, changed.

As described below, the method 6000 provides intuitive ways to interact with multiple application views. The method reduces the number of inputs required from a user to interact with multiple application views and, thereby, ensures that battery life of an electronic device implementing the method 6000 is extended, since less power is required to process the fewer number of inputs (and this savings will be realized over and over again as users become increasingly familiar with the more intuitive and simple gesture). As is also explained in detail below, the operations of method 6000 help to ensure that users are able to engage in sustained interactions (e.g., they do not need to frequency undo behaviors, which interrupts their interactions with their devices) and the operations of method 6000 help to produce more efficient human-machine interfaces.

In some embodiments, method 6000 is performed at an electronic device including a display generation component (e.g., a display, a projector, a heads-up display, etc.) and one or more input devices (e.g., a camera, a remote controller, a pointing device, a touch-sensitive surface that is coupled to a separate display, or a touch-screen display that serves both as the display and the touch-sensitive surface). The device currently displays (6002), via the display generation component, a first view of a first application (e.g., 4200 in FIG. 4B1), and a second view of a second application (e.g., 4204 in FIG. 4B1), where the second view is overlaid over a portion of the first view, wherein the first view of the first application and the second view of the second application are displayed in a display region that has a first edge and a second edge; (e.g., the second edge is an opposing edge). While displaying the first view of the first application and the second view of the second application, the device detects (6004) an input that includes movement in a respective direction; (e.g., the respective direction is towards one of the first edge or second edge, as shown, for example with the arrow in FIG. 4B8). In response to detecting the input and in accordance with a determination that the movement is in a first direction (e.g., movement toward the first edge): display (6006) movement of the second view out of the display region in the first direction toward the first edge (e.g., as shown in FIG. 4B8); and after the second view of the second application ceases to be displayed, displaying at the first edge of the display region an edge affordance (e.g., 4246 in FIG. 4B9) that represents the second view of the second application for at least a first threshold amount of time; and in accordance with a determination that the movement is in a second direction different from the first direction (e.g., movement toward the second edge, as shown, for example with the arrow in FIG. 4B1): displays (6008) movement of the second view out of the display region in the second direction toward the second edge (e.g., as shown in FIGS. 4B1 and 4B2); and after a second threshold amount of time, that is shorter than the first threshold amount of time, has passed since the second view of the second application ceased to be displayed, displays the second edge of the display region without displaying an edge affordance that represents the second view of the second application (e.g., as shown in FIG. 4B4). Displaying at the first edge of the display region an edge affordance that represents the second view of the second application for at least a first threshold amount of time provides improved visual feedback to the user (e.g., allowing the user to view and interact with a second view of a second application views). Providing improved visual feedback enhances the operability of the device and makes the user-device interface more efficient, which, additionally, reduces power usage and improves battery life of the device by enabling the user to use the device more quickly and efficiently.

In some embodiments, the edge affordance includes a tab having a length less than a length of the first edge or having a length less than a length of the second edge (6012). This tab 4210 is illustrated in FIGS. 4B3, 4B5, and by 4246 in FIGS. 4B9-4B12, for example. Displaying the edge affordance that includes a tab having a length less than a length of the first edge or having a length less than a length of the second edge views, provides improved visual feedback to the user (e.g., allowing the user to view and interact with one or more views associated with an application). Providing improved visual feedback enhances the operability of the device and makes the user-device interface more efficient, which, additionally, reduces power usage and improves battery life of the device by enabling the user to use the device more quickly and efficiently.

In some embodiments, the device detects (6014) a second input that includes movement from the first edge of the display region; in response to detecting the second input: in accordance with a determination that the movement from the first edge of the display region begins on the tab (e.g., 4246 in FIG. 4B9): display movement of the second view of the second application back into the display region in a direction away from the first edge; and concurrently displays the first view of the first application, and the second view of a second application partially overlaying the first view of the first application (e.g., as show in in FIG. 4B11). In accordance with a determination that the movement begins at a location other than the tab: the device performs an operation based on the movement that is different to displaying the second view. Performing an operation based on the movement that is different to displaying the second view, provides additional control options without cluttering the UI with additional displayed controls (e.g., performing an operation based on a location where the input begins), and enhances the operability of the device, which, additionally, reduces power usage and improves battery life of the device by enabling the user to use the device more quickly and efficiently.

In some embodiments, the operation based on the movement that is different to displaying the second view, includes a navigation operation in the first application (e.g., navigating through a user interface hierarchy in the first application to display a different user interface in the application) (6016). For example, swiping from contact 4250 in FIG. 4B9 navigates to a different browser page 4252 in FIG. 4B10. Performing a navigation operation in the first application, provides additional control options without cluttering the UI with additional displayed controls (e.g., performing a navigation operation in the first application based on a location where the input begins), and enhances the operability of the device, which, additionally, reduces power usage and improves battery life of the device by enabling the user to use the device more quickly and efficiently.

In some embodiments, the device detects (6018) a third input from the second edge of the display region while the edge affordance is not displayed (e.g., as shown in FIG. 4B4); and in response to detecting the third input, redisplaying the edge affordance along the second edge of the display region (e.g. when the second input is detected after the first threshold time period where the edge affordance is no longer displayed, displaying the edge affordance when the movement from the first edge of the display region) (e.g., the second input begins where the edge affordance was previously displayed) (e.g., as shown in FIG. 4B5). Redisplaying the edge affordance along the second edge of the display region provides improved visual feedback to the user (e.g., allowing the user to view and interact with multiple application views). Providing improved visual feedback enhances the operability of the device and makes the user-device interface more efficient, which, additionally, reduces power usage and improves battery life of the device by enabling the user to use the device more quickly and efficiently.

In some embodiments, while displaying the second edge of the display region without displaying the edge affordance that represents the second view of the second application, the device displays at the first edge of the display region an edge affordance that represents the second view of the second application for at least a first threshold amount of time, receiving a request to display a first type of content (e.g., a full screen video); and in response to receiving the request to display the first type of content, displaying the first type of content and ceasing to display the edge affordance (e.g., the first edge is a left edge and the second edge is a right edge of a display region as viewed by a user, the first edge is a right edge and the second edge is a left edge, the first edge is a top edge and the second edge is a bottom edge; the first edge is a bottom edge and the second edge is a top edge) (6020). Displaying the first type of content and ceasing to display the edge affordance provides additional control options without cluttering the UI with additional displayed controls (e.g., playing a first type of content and automatically ceasing to display the edge affordance provides a larger viewable area for the first type of content), and enhances the operability of the device, which, additionally, reduces power usage and improves battery life of the device by enabling the user to use the device more quickly and efficiently.

In some embodiments, the first view of the first application extends across the majority of the display region (e.g., a majority is more than half of the display region; a majority can include all of the display region; the first and second applications are the same application; the first and second applications are different applications) (6022). This is illustrated by reference numeral 4200 in FIG. 4B1-4B11, for example. Displaying the first view of the first application across the majority of the display region provides improved visual feedback to the user (e.g., allowing the user to view and interact with a first view that extends across the majority of the display region). Providing improved visual feedback enhances the operability of the device and makes the user-device interface more efficient, which, additionally, reduces power usage and improves battery life of the device by enabling the user to use the device more quickly and efficiently.

In some embodiments, the first edge is parallel to and opposite the second edge (6024). For example, the left and right edges in FIG. 4B1-4B11. Having the first edge be parallel and opposite the second edge provides improved visual feedback to the user (e.g., allowing the user to view and interact with a second view of a second application). Providing improved visual feedback enhances the operability of the device and makes the user-device interface more efficient, which, additionally, reduces power usage and improves battery life of the device by enabling the user to use the device more quickly and efficiently.

In some embodiments, the device detects (6026) a second input selecting a first selectable user interface object (e.g., a representation of an application affordance of a third application or a representation of content, for example 4260 in FIG. 4B13), followed by a movement of the selection to an edge of the display region (e.g., the first edge or the second edge of the display region) (e.g., as shown by the arrow in FIG. 4B13). While detecting the second input: the device displays, via the display generation component, an a graphical indication of a drop target indicator (e.g., 4264, 4266 in FIGS. 4B14 and 4B15); after displaying the drop target indicator, the device detects an end of the second input; and in response to detecting an end of the second input, and in accordance with a determination that the second input ended while directed to the drop target indicator, the device displays a user interface corresponding to the first selectable user interface object overlaid on the first view of the first application (e.g., while the first view of the first application is maintained at a respective size) (e.g., as shown in FIG. 4B16). See also, FIGS. 4B13-4B22. Displaying the drop target indicator and making a determination whether an input ended while directed to the drop target indicator provides improved visual feedback to the user (e.g., allowing the user to view and interact with a first selectable user interface object). Providing improved visual feedback enhances the operability of the device and makes the user-device interface more efficient, which, additionally, reduces power usage and improves battery life of the device by enabling the user to use the device more quickly and efficiently.

In some embodiments, in response to detecting the end of the second input, and in accordance with a determination that the second input ended while directed to a location away from the drop target indicator, the device performs (6028) an operation corresponding to the first selectable user interface object without displaying a user interface corresponding to the first selectable user interface object overlaid on the first view of the first application. (e.g., displaying a view of the first application side by side with a view of content corresponding to the first selectable user interface object or dropping content corresponding to the first selectable user interface object in the view of the first application). Performing an operation corresponding to the first selectable user interface object without displaying a user interface corresponding to the first selectable user interface object overlaid on the first view of the first application provides improved visual feedback to the user (e.g., allowing the user to view and interact with a first selectable user interface object in different ways depending on where the second input ended). Providing improved visual feedback enhances the operability of the device and makes the user-device interface more efficient, which, additionally, reduces power usage and improves battery life of the device by enabling the user to use the device more quickly and efficiently.

In some embodiments, the movement in the first direction is towards the first edge (6030). This is best illustrated by the arrow in FIGS. 4B6, for example. Displaying movement of a second view out of the first direction based on a determination that the movement is in a first direction, provides additional control options without cluttering the UI with additional displayed controls (e.g., performing an operation based on a direction of the input), and enhances the operability of the device, which, additionally, reduces power usage and improves battery life of the device by enabling the user to use the device more quickly and efficiently.

FIGS. 7A-7F are a flowchart representation of a method 7000 of displaying content in a respective concurrent-display configuration with a currently displayed application, in accordance with some embodiments. FIGS. 4A1-4A27, 4B1-4B22, 4C1-4C14, 4D1-4D11, and 4E1-4E12 are used to illustrate the methods and/or processes of FIGS. 7A-7F. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D.

In some embodiments, the method 7000 is performed by an electronic device (e.g., portable multifunction device 100, FIG. 1A and/or one or more components of the electronic device (e.g., I/O subsystem 106, operating system 126, etc.). In some embodiments, the method 7000 is governed by instructions that are stored in a non-transitory computer-readable storage medium and that are executed by one or more processors of a device, such as the one or more processors 122 of device 100 (FIG. 1A). For ease of explanation, the following describes method 7000 as performed by the device 100. In some embodiments, with reference to FIG. 1A, the operations of method 7000 are performed by or use, at least in part, a multitasking module (e.g., multitasking module 180) and the components thereof, a contact/motion module (e.g., contact/motion module 130), a graphics module (e.g., graphics module 132), and a touch-sensitive display (e.g., touch-sensitive display system 112). Some operations in method 7000 are, optionally, combined and/or the order of some operations is, optionally, changed.

As described below, the method 7000 provides an intuitive way to interact with multiple application views. The method reduces the number of inputs required from a user to interact with multiple application views and, thereby, ensures that battery life of an electronic device implementing the method 7000 is extended, since less power is required to process the fewer number of inputs (and this savings will be realized over and over again as users become increasingly familiar with the more intuitive and simple gesture). As is also explained in detail below, the operations of method 7000 help to ensure that users are able to engage in sustained interactions (e.g., they do not need to frequency undo behaviors, which interrupts their interactions with their devices) and the operations of method 7000 help to produce more efficient human-machine interfaces.

A method 7000 is performed at an electronic device including a display generation component (e.g., a display, a projector, a heads-up display, etc.) and one or more input devices (e.g., a keyboard, a remote controller, a camera, a touch-sensitive surface that is coupled to a separate display, or a touch-screen display that serves both as the display and the touch-sensitive surface). The device displays (7002), via the display generation component, an application-selection user interface that includes representations of a plurality of recently used applications, including concurrently displaying, in the application-selection user interface: at a first location, a first set of one or more representations of applications that were last used in a first display mode on the electronic device; and (e.g., first display mode having a first size and the other display modes are a second smaller size) at a second location, a second set of one or more representations of applications that were last used in a second display mode on the electronic device that is different from the first display mode (e.g., where the second region is different than the first region; where the second display mode is different than the first display mode). For example, FIGS. 4C1-4D1 show such an application-selection user interface. While displaying the application-selection user interface, the device detects (7004) a first input, in response to detecting the first input, the device moves (7006) (e.g., from the first location towards the second location) a representation of a respective view of a first application in the application-selection user interface that was last used in the first view display mode (where the representation is a dynamic representation that changes in appearance from a first appearance when the view is in the first location to a second appearance when the view is in the second location). This can be seen, for example, in FIGS. 4C4, 4C8, and 4C10. After moving the representation of the respective view in the application-selection user interface, the device detects (7008) a second input corresponding to a request to switch from displaying the application-selection user interface to displaying the respective view without displaying the application-selection user interface. This can be seen, for example, in FIGS. 4D1 and 4D2. In response to detecting the second input, in accordance with a determination that the first input included movement (e.g., movement of a representation of the application) to the second location in the application-selection user interface that is associated with the second display mode, (e.g., a region or a representation of a view of an application in the second display mode), the device displays (7010) the first application in the second display mode. Displaying a first application in a second display mode in accordance with a determination that a first input included movement to the second location in the application-selection user interface that is associated with the second display mode, reduces the number of inputs needed to perform an operation (e.g., the user can switch between different display modes by moving representations of applications), and enhances the operability of the device, which, additionally, reduces power usage and improves battery life of the device by enabling the user to use the device more quickly and efficiently.

In some embodiments, the representation of the first application is a dynamic representation that changes in appearance from a first appearance when in the first location to a second appearance when in the second location (e.g., each representation of the one or more first and second sets of representations are dynamic representations that have a first appearance when representing an application in a first display mode and a second appearance when representing an application in the second display mode) (e.g., the dynamic representations have different appearances depending on whether they are at the first location or the second location) (7012). This is illustrated in FIG. 4C4, for example. Displaying representation of the first application as a dynamic representation that changes in appearance from a first appearance when in the first location to a second appearance when in the second location provides improved visual feedback to the user (e.g., allowing the user to determine that the current location of the selectable representation is the first location). Providing improved visual feedback enhances the operability of the device and makes the user-device interface more efficient, which, additionally, reduces power usage and improves battery life of the device by enabling the user to use the device more quickly and efficiently.

In some embodiments, while displaying the application-selection user interface, detecting (7014) a third input; in response to detecting the third input, moving (e.g., from the second location towards the first location) a representation of a respective view of a second application in the application-selection user interface that was last used in the second view display mode (where the representation is a dynamic representation that changes in appearance from a first appearance when the view is in the first location to a second appearance when the view is in the second location); after moving the representation of the respective view of the second application in the application-selection user interface, detecting a fourth input corresponding to a request to switch from displaying the application-selection user interface to displaying the respective view of the second application without displaying the application-selection user interface; and in response to detecting the fourth input, in accordance with a determination that the third input included movement (e.g., movement of a representation of the application) to the first location in the application-selection user interface that is associated with the first display mode, (e.g., a region or a representation of a view of an application in the first display mode) displaying the second application in the first display mode. This is illustrated in FIGS. 4C10-4C11, for example. Displaying the second application in the first display mode in accordance with a determination that a third input included movement to the first location in the application-selection user interface that is associated with the first display mode provides improved visual feedback to the user (e.g., allowing the user to determine that the current location of the selectable representation is the second location). Providing improved visual feedback enhances the operability of the device and makes the user-device interface more efficient, which, additionally, reduces power usage and improves battery life of the device by enabling the user to use the device more quickly and efficiently.

In some embodiments, in accordance with a determination (7016) that the first input included movement (e.g., movement of a representation of the application) to a different position within the first location in the application-selection user interface that is associated with the first display mode, (e.g., a region or a representation of a view of an application in the first display mode) displaying the first application in the first display mode. Moving a representation to a different position within the same location is illustrated in FIG. 4C6, for example. Displaying the first application in the first display mode provides improved visual feedback to the user (e.g., allowing the user to determine that the current location of the selectable representation is the first location). Providing improved visual feedback enhances the operability of the device and makes the user-device interface more efficient, which, additionally, reduces power usage and improves battery life of the device by enabling the user to use the device more quickly and efficiently.

In some embodiments, in accordance with a determination (7017) that the first input included movement (e.g., movement of a representation of the application) to a different position within the first location in the application-selection user interface that is associated with the first display mode, and the different position coincides with a representation of a respective view of a third application, displaying the first application and the third application in a third display mode. This is illustrated in FIGS. 4C3-4C4, for example. Displaying the first application and the third application in a third display mode provides improved visual feedback to the user (e.g., allowing the user to determine the current location of the selectable representation is at a first location that allows for split-mode display). Providing improved visual feedback enhances the operability of the device and makes the user-device interface more efficient, which, additionally, reduces power usage and improves battery life of the device by enabling the user to use the device more quickly and efficiently.

In some embodiments, while displaying the application-selection user interface, detecting (7018) a third input; in response to detecting the third input, moving (e.g., from the second location to a different position within the second location) a representation of a respective view of a second application in the application-selection user interface that was last used in the second view display mode (where the representation is a dynamic representation that changes in appearance from a first appearance when the view is in the first location to a second appearance when the view is in the second location) after moving the representation of the respective view of the second application in the application-selection user interface, detecting a fourth input corresponding to a request to switch from displaying the application-selection user interface to displaying the respective view of the second application without displaying the application-selection user interface; and in response to detecting the fourth input, in accordance with a determination that the third input included movement (e.g., movement of a representation of the application) to the second location in the application-selection user interface that is associated with the second display mode, (e.g., a region or a representation of a view of an application in the second display mode) displaying the second application in the second display mode (e.g., the representation 4316 being moved to a different location (e.g., to the left of the representation 4314) in the slide-over region). Displaying the second application in the second display mode in accordance with a determination that a third input included movement to the second location in the application-selection user interface that is associated with the second display mode provides improved visual feedback to the user (e.g., allowing the user to determine how the application would be displayed). Providing improved visual feedback enhances the operability of the device and makes the user-device interface more efficient (e.g., give an example), which, additionally, reduces power usage and improves battery life of the device by enabling the user to use the device more quickly and efficiently.

In some embodiments, the first display mode is one of a full screen display mode (e.g., 4312 in FIG. 4C7) or a split-screen display mode (e.g., 4332 in FIG. 4C7), and the second display mode is an overlaid display mode in which an overlaid view (e.g., 4314 in FIG. 4C7) is layered on top of one or more other views (e.g., when viewed not in the application-selection user interface) (7020). Displaying a first display mode that is one of a full screen display mode or a split-screen display mode, and/or displaying a second display mode that is an overlaid display mode in which an overlaid view is layered on top of one or more other views provides improved visual feedback to the user (e.g., allowing the user to determine the display mode of a selectable representation). Providing improved visual feedback enhances the operability of the device and makes the user-device interface more efficient (e.g., give an example), which, additionally, reduces power usage and improves battery life of the device by enabling the user to use the device more quickly and efficiently.

In some embodiments, the device displays (7022), in the first region of the application-selection user interface, a third set of one or more representations of applications that were last used in a third display mode on the electronic device, the third display mode being a split-screen display mode, wherein the third set of one or more representation of applications in the split-screen display mode includes a combined representation of a third application and a fourth application. This is illustrated in FIG. 4C6, for example. Displaying a split-screen display mode that includes a combined representation of a third application and a fourth application provides improved visual feedback to the user (e.g., allowing the user to determine how the selectable representation user interface will behave after an input is terminated). Providing improved visual feedback enhances the operability of the device and makes the user-device interface more efficient, which, additionally, reduces power usage and improves battery life of the device by enabling the user to use the device more quickly and efficiently.

In some embodiments, while displaying (7024) the combined representation of the third application and the fourth application: the device detects a third input at a location of the combined representation corresponding to the third application, the first portion continuing to a second portion in an upward movement; and in response to detecting the third input: ceasing to display the joint representation of the third application and the fourth application; and displays a representation of the fourth application in a full screen display mode. For example, converting a split-view display mode representation into two full-screen display mode representations is illustrated in FIGS. 4C6 and 4C7. Ceasing to display the joint representation of the third application and the fourth application; and displaying a representation of the fourth application in a full screen display mode provides improved visual feedback to the user (e.g., allowing the user to determine how the selectable representation user interface will behave after an input is terminated). Providing improved visual feedback enhances the operability of the device and makes the user-device interface more efficient, which, additionally, reduces power usage and improves battery life of the device by enabling the user to use the device more quickly and efficiently.

In some embodiments, when an application represented in the first set is moved from the first set to the second set, a display mode of the application changes (7028) from a full screen display mode to a slide-over display mode. This is illustrated in FIGS. 4C8 and 4C9, for example. Changing a display mode of an application from a full screen display mode to a slide-over display mode provides improved visual feedback to the user (e.g., allowing the user to determine the location of the selectable representation). Providing improved visual feedback enhances the operability of the device and makes the user-device interface more efficient, which, additionally, reduces power usage and improves battery life of the device by enabling the user to use the device more quickly and efficiently.

In some embodiments, when an application represented in the second set is moved from the second set to the first set, a display mode of the application changes (7030) from a slide-over display mode to a full screen display mode. This is illustrated in FIGS. 4C10-4C11, for example. Changing a display mode of an application from a slide-over display mode to a full screen display mode reduces the number of inputs needed to perform an operation (e.g., the same input causes different actions on the user interface depending on the location of its termination). Reducing the number of inputs needed to perform an operation enhances the operability of the device, and makes the user-device interface more efficient, which, additionally, reduces power usage and improves battery life of the device by enabling the user to use the device more quickly and efficiently.

In some embodiments, when a third application represented in the second set is moved from the second set to the first set, a display mode of the third application changes from a slide-over display mode to a split-screen mode. This is illustrated in FIGS. 4C4-4C5, for example. Changing a display mode of an application from a slide-over display mode to a split-screen display mode provides improved visual feedback to the user (e.g., allowing the user to change a display mode of an application based on a location of a representation of the application). Providing improved visual feedback enhances the operability of the device and makes the user-device interface more efficient (e.g., give an example), which, additionally, reduces power usage and improves battery life of the device by enabling the user to use the device more quickly and efficiently.

In some embodiments, while displaying the application-selection user interface, the device detects (7032) a third input; in response to detecting the third input, the device displays a multitasking view that includes an indication that shows a number of views of a third application that were recently open. This is illustrated by 4342 in FIGS. 4C12, for example. Displaying an indication that shows a number of views of a third application that were recently open provides improved visual feedback to the user (e.g., allowing the user to get a visual reminder of the number of recently open views). Providing improved visual feedback enhances the operability of the device and makes the user-device interface more efficient, which, additionally, reduces power usage and improves battery life of the device by enabling the user to use the device more quickly and efficiently.

In some embodiments, while displaying the multitasking view that includes the indication, the device detects (7034) a fourth input directed to the indication; in response to detecting the fourth input (e.g., 4344 in FIG. 4C12), the device displays representations of all recently opened views for the third application (e.g., as shown in FIG. 4C13). Displaying representations of all recently opened views for the third application provides improved visual feedback to the user (e.g., allowing the user to access all recently open views of the third application). Providing improved visual feedback enhances the operability of the device and makes the user-device interface more efficient, which, additionally, reduces power usage and improves battery life of the device by enabling the user to use the device more quickly and efficiently.

In some embodiments, switching the application between different display modes includes entering (7036) a multitasking view (e.g., shown in FIG. 4C12). This is illustrated in FIGS. 4C11-4C13, for example. Switching the application between different display modes includes entering a multitasking view that reduces the number of inputs needed to perform an operation (e.g., the operation to enter a multitasking view). Reducing the number of inputs needed to perform an operation enhances the operability of the device, and makes the user-device interface more efficient, which, additionally, reduces power usage and improves battery life of the device by enabling the user to use the device more quickly and efficiently.

In some embodiments, the first display mode includes (7038) a plurality of views for applications that have a first size (e.g., and does not contain views for applications that have the second size) and the second display mode includes a plurality of views for applications that have a second smaller size (e.g., and does not contain views for applications that have the first size). This is illustrated in FIGS. 4C1-4C14, for example. Displaying a second display mode includes displaying a plurality of views for applications that has a second smaller size, provides improved visual feedback to the user (e.g., helping the user to distinguish between the different views). Providing improved visual feedback enhances the operability of the device and makes the user-device interface more efficient, which, additionally, reduces power usage and improves battery life of the device by enabling the user to use the device more quickly and efficiently.

In some embodiments, aspects/operations of methods 5000, 6000, 7000, and 8000 may be interchanged, substituted, and/or added between these methods. For brevity, these details are not repeated here.

FIGS. 8A-8F are a flowchart representation of a method 8000 of displaying an application in a respective concurrent-display configuration with a currently displayed application, in accordance with some embodiments. FIGS. 4A1-4A27, 4B1-4B22, 4C1-4C14, 4D1-4D11, and 4E1-4E12 are used to illustrate the methods and/or processes of FIGS. 8A-8F. Although some of the examples which follow will be given with reference to inputs on a touch-sensitive display (in which a touch-sensitive surface and a display are combined), in some embodiments, the device detects inputs on a touch-sensitive surface 195 that is separate from the display 194, as shown in FIG. 1D.

In some embodiments, the method 8000 is performed by an electronic device (e.g., portable multifunction device 100, FIG. 1A and/or one or more components of the electronic device (e.g., I/O subsystem 106, operating system 126, etc.). In some embodiments, the method 8000 is governed by instructions that are stored in a non-transitory computer-readable storage medium and that are executed by one or more processors of a device, such as the one or more processors 122 of device 100 (FIG. 1A). For ease of explanation, the following describes method 8000 as performed by the device 100. In some embodiments, with reference to FIG. 1A, the operations of method 8000 are performed by or use, at least in part, a multitasking module (e.g., multitasking module 180) and the components thereof, a contact/motion module (e.g., contact/motion module 130), a graphics module (e.g., graphics module 132), and a touch-sensitive display (e.g., touch-sensitive display system 112). Some operations in method 8000 are, optionally, combined and/or the order of some operations is, optionally, changed.

As described below, the method 8000 provides an intuitive way to interact with multiple application views. The method reduces the number of inputs required from a user to interact with multiple application views and, thereby, ensures that battery life of an electronic device implementing the method 8000 is extended, since less power is required to process the fewer number of inputs (and this savings will be realized over and over again as users become increasingly familiar with the more intuitive and simple gesture). As is also explained in detail below, the operations of method 8000 help to ensure that users are able to engage in sustained interactions (e.g., they do not need to frequency undo behaviors, which interrupts their interactions with their devices) and the operations of method 8000 help to produce more efficient human-machine interfaces.

In some embodiments, method 8000 is performed at an electronic device that includes a display generation component (e.g., a display, a projector, a heads-up display, etc.) and one or more input devices (e.g., a camera, a remote controller, a pointing device, a camera, a touch-sensitive surface that is coupled to a separate display, or a touch-screen display that serves both as the display and the touch-sensitive surface). The device, while displaying a first user interface (e.g., a home screen user interface, like that shown, for example, in FIG. 4A1, a user interface for a second application, an app library user interface), detects (8002), an input corresponding to a request to display a view of a first application, wherein the first user interface does not include a view of the first application. In response to detecting the input corresponding to the request to display the view of the first application, the device ceases (8004) to display the first user interface and displays a first view of the first application, including in accordance with a determination that there are one or more other views of the first application with a saved state, the device displays (8006) representations of the one or more other views of the first application with the saved state concurrently with the first view of the first application, wherein the representations of the one or more other views of the first application are overlaid on the view of the first application (e.g., 4422, 4424, 4426, and 4428 of FIG. 4D2). In accordance with a determination that there are no other views of the first application with a saved state, the device displays (8008) the first view of the first application without displaying representations of any other views of the first application (e.g., as shown in FIG. 4A2). Displaying representations of the one or more other views of the first application with the saved state concurrently with the first view of the first application, wherein the representations of the one or more other views of the first application are overlaid on the view of the first application reduces the number of inputs needed to perform an operation (e.g., allowing the user to select different views of a first application with a saved state). Reducing the number of inputs needed to perform an operation enhances the operability of the device, and makes the user-device interface more efficient, which, additionally, reduces power usage and improves battery life of the device by enabling the user to use the device more quickly and efficiently.

In some embodiments, the first user interface includes a home screen user interface, the home screen user interface includes multiple application affordances (e.g., application affordances (e.g., application icons) and/or widgets organized by a user of the device) (8012). This is illustrated in FIG. 4A1, 4A4 and FIG. 4D1, for example. home screen user interface, the home screen user interface includes multiple application affordances (e.g., application affordances (e.g., application icons) and/or widgets organized by a user of the device) reduces the number of inputs needed to perform an operation (e.g., allowing the user to select different applications from the home screen). Reducing the number of inputs needed to perform an operation enhances the operability of the device, and makes the user-device interface more efficient, which, additionally, reduces power usage and improves battery life of the device by enabling the user to use the device more quickly and efficiently.

In some embodiments, the first user interface includes one of a user interface of a second application, or a user interface of an application library (8014). This is illustrated in FIGS. 4D1-4D9, for example. Displaying a first user interface includes one of a user interface of a second application, or a user interface of an application library provides improved visual feedback to the user (e.g., allowing the user to view and interact with multiple views via different types user interfaces). Providing improved visual feedback enhances the operability of the device and makes the user-device interface more efficient, which, additionally, reduces power usage and improves battery life of the device by enabling the user to use the device more quickly and efficiently.

In some embodiments, the representations of the one or more other views of the first application with the saved state further includes a selector for the first application, the selector comprising selectable affordances selected from a group consisting of: a full screen mode, a split-screen mode, and a slide-over display mode (8016). This is illustrated by 4422, 4424, 44265, and 4428 in FIG. 4D2. Also see FIGS. 4D5, 4D7, and 4D10, for example. Displaying representations of the one or more other views of the first application with the saved state includes displaying a selector for the first application provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, the selectable affordance further includes an option to create a new view for the first application (8018). This is illustrated by the plus affordance 4680 in FIGS. 4E12, for example. Displaying an option to create a new view for the first application reduces the number of inputs needed to perform an operation (e.g., allowing the user to create a new view for the first application from the selector). Reducing the number of inputs needed to perform an operation enhances the operability of the device, and makes the user-device interface more efficient, which, additionally, reduces power usage and improves battery life of the device by enabling the user to use the device more quickly and efficiently.

In some embodiments, the selector further includes a representation of a third view of the first application (8020), the third view is a view of the application that is displayed in a content creation display mode that is different from the full screen display mode, the split-screen display mode, and the slide-over display mode (e.g., a mode in which a content creation user interface is overlaid on a full screen or split screen view of an application but the full screen or split screen view of the application is visually deemphasized relative to the third view, the third view is an email draft creation view or a document draft creation view). This is illustrated in FIGS. 4D15-4D17, for example. Displaying a content creation display mode that is different from the full screen display mode, the split-screen display mode, and the slide-over display mode provides improved visual feedback to the user (e.g., allowing the user to view and interact with a content creation display mode in a user interface). Providing improved visual feedback enhances the operability of the device and makes the user-device interface more efficient, which, additionally, reduces power usage and improves battery life of the device by enabling the user to use the device more quickly and efficiently.

In some embodiments, while displaying representations of the one or more other views of the first application with the saved state concurrently with the first view of the first application (e.g., 4418 shown in FIG. 4D2): the device detects (8022) a second input in a region outside the representations of the one or more other views of the first application (e.g., a location outside 4418 in FIG. 4D2); and in response to detecting the second input, ceasing to display the representations of the one or more other views of the first application (e.g., as shown in FIG. 4A2). Detecting a second input in a region outside the representations of the one or more other views of the first application; and in response to detecting the second input, ceasing to display the representations of the one or more other views of the first application provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, while displaying representations of the one or more other views of the first application with the saved state concurrently with the first view of the first application (e.g., the representations 4422, 4424, 4426, and 4428, displayed concurrently with the background view 4420 as shown in FIG. 4D7): the device detects (8024) a second input directed to the representations of the one or more other views of the first application, wherein the second input includes movement (e.g., downward movement on 4418); and in response to detecting the second input, ceasing to display the representations of the one or more other views of the first application (e.g., as shown in FIG. 4A2). Ceasing to display the representations of the one or more other views of the first application in response to detecting the second input provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, while displaying representations of the one or more other views of the first application with the saved state concurrently with the first view of the first application (e.g., e.g., the representations 4422, 4424, 4426, and 4428, displayed concurrently with the background view 4420 as shown in FIG. 4D7): the device detects (8026) a second input that corresponds to a request for the first application to perform an operation; and (e.g., a request to activate an affordance in the application, insert content in the application, delete content in the application, scroll content in the application, and/or resize content in the application, etc.) in response to detecting the second input, ceasing to display the representations of the one or more other views of the first application (e.g., as shown in FIG. 4A2). Ceasing to display the representations of the one or more other views of the first application in response to detecting the second input provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, the device ceases (8032) to display the representations of the one or more other views of the first application after a first predetermined time period (e.g., as shown in FIGS. 4D7 changing to 4A2). Ceasing to display the representations of the one or more other views of the first application after a first predetermined time period provides additional control options without cluttering the UI with additional displayed controls (e.g., allowing the user to new other views without the concurrent display of the representation of the one or more other views of the first application), and enhances the operability of the device, which, additionally, reduces power usage and improves battery life of the device by enabling the user to use the device more quickly and efficiently.

In some embodiments, while displaying the first view of the first application: the device detects (8034) a second input directed to a respective representation of the one or more other views of the first application, wherein the second input includes movement (e.g., an upward movement or swipe up on the representation 4424 in the view-selector shelf 4418 shown in FIG. 4D7); in response to detecting the second input, ceasing to display the respective representation of the one or more other views of the first application (e.g., removing the representation 4424 from the view-selector shelf 4418 shown in FIG. 4D7 and closing the application associated with the representation 4424). Ceasing to display the respective representation of the one or more other views of the first application in response to detecting the second input provides additional control options without cluttering the UI with additional displayed controls enhances the operability of the device (e.g., allowing the user to dismiss application views), which, additionally, reduces power usage and improves battery life of the device by enabling the user to use the device more quickly and efficiently.

In some embodiments, the device automatically selects (8036) a respective representation of the one or more other views of the first application in response to detecting the input corresponding to the request to display the view of the first application (e.g., as shown in FIG. 4D1 changing to FIG. 4A2). Automatically selects a respective representation of the one or more other views of the first application provides additional control options without cluttering the UI with additional displayed controls enhances the operability of the device (e.g., automatically selecting a view to represent to the user), which, additionally, reduces power usage and improves battery life of the device by enabling the user to use the device more quickly and efficiently.

In some embodiments, the respective representation of the one or more other views of the first application includes a most recently used instance of the first application (e.g., the respective representations of the one or more other view of the first application are arranged in order from most recently used to least recently used) (8038) (e.g., as shown in FIG. 4D1 changing to FIG. 4A2). Displaying a the respective representation of the one or more other views of the first application includes a most recently used instance of the first application provides additional control options without cluttering the UI with additional displayed controls enhances the operability of the device (e.g., automatically selecting a view to represent to the user), which, additionally, reduces power usage and improves battery life of the device by enabling the user to use the device more quickly and efficiently.

In some embodiments, the device detects (8040) a third input on an application affordance of the first application, the third input persisting for at least a first time threshold (e.g., as shown in FIG. 4E1); and in response to detecting the third input, displaying an option to create a new view for the first application (e.g., menu 4602 as shown in FIG. 4E2). This is illustrated in FIGS. 4D9, 4E2, 4E6, for example. Displaying an option to create a new view for the first application provides additional control options without cluttering the UI with additional displayed controls enhances the operability of the device (e.g., allowing a user to create a new view), which, additionally, reduces power usage and improves battery life of the device by enabling the user to use the device more quickly and efficiently.

In some embodiments, prior to replacing the display of the first user interface with a first view of the first application, the device detects (8042) a third input on an application affordance of the first application, the third input persisting for at least a first time threshold (e.g., as shown in FIG. 4D8) and in response to detecting the third input, displaying an option to show a plurality of other views of the first application (e.g., menu 4452 as shown in FIG. 4D9); and in response to detecting a selection of the option, displaying representations of the one or more other views of the first application with the saved state concurrently with the first user interface (e.g., as shown in FIG. 4D10). This is illustrated in FIGS. 4D1-4D11, for example. Displaying representations of the one or more other views of the first application with the saved state concurrently with the first user interface provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, while displaying the first view of the first application, the device detects (8044) a second input corresponding to a second request to display a second view of the first application; and in response to detecting the second input, the device displays the second view of the first application, wherein the representations of the one or more other views of the first application is concurrently displayed with both the first view of the first application and the second view of the first application (e.g., the view-selector shelf 4458 shown in FIG. 4D10 is displayed while the full-screen view 4457 is switched to the view associated with the representation 4462, the view-selector shelf continues to be displayed when switching between different views of an application). Displaying the representations of the one or more other views of the first application is concurrently displayed with both the first view of the first application and the second view of the first application provides improved visual feedback to the user (e.g., allowing the user to view and interact with multiple views in a user interface). Providing improved visual feedback enhances the operability of the device and makes the user-device interface more efficient, which, additionally, reduces power usage and improves battery life of the device by enabling the user to use the device more quickly and efficiently.

In some embodiments, the request to display a view of the first application includes a request to display a user interface of the first applications, is distinct from a static screenshot or representation of the first application (e.g. actual user interfaces of the first application, as opposed to static screen shots or representations of the first application) (8046) (e.g., as shown in FIG. 4D1, input 4414 is a request to display the browser application associated with the representation 4408). This is illustrated in FIGS. 4D1-4D11, for example. Detecting a request to display a user interface of the first applications provides additional control options without cluttering the UI with additional displayed controls enhances the operability of the device (e.g., allowing a user to view different views), which, additionally, reduces power usage and improves battery life of the device by enabling the user to use the device more quickly and efficiently.

In some embodiments, the view of the first application on which the representations of the one or more other views of the first application are overlaid includes user interface of the first application, distinct from a static screenshot or representation of the first application (8048) (e.g., as shown in FIG. 4D2, the background view 4420 is a user interface that allows web browsing). This is illustrated in FIGS. 4D1-4D11, for example. Detecting a request to display a user interface of the first applications provides additional control options without cluttering the UI with additional displayed controls enhances the operability of the device (e.g., allowing a user to view different views), which, additionally, reduces power usage and improves battery life of the device by enabling the user to use the device more quickly and efficiently.

In some embodiments, aspects/operations of methods 5000, 6000, 7000, and 8000 may be interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for displaying multiple views of one or more applications, comprising:
at an electronic device including a display generation component and one or more input devices:
concurrently displaying, via the display generation component:
a first view of a first application in a first display mode; and
a display mode affordance;
while displaying the first view of the first application, receiving a sequence of one or more inputs including a first input selecting the display mode affordance; and
in response to detecting the sequence of one or more inputs:
ceasing to display at least a portion of the first view of the first application while maintaining display of a representation of the first application; and
displaying, via the display generation component, at least a portion of a home screen that includes multiple application affordances,
while continuing to display the representation of the first application and after displaying the portion of the home screen, receiving a second input selecting an application affordance associated with a second application; and
in response to receiving the second input, concurrently displaying, via the display generation component:
a second view of the first application and
a first view of the second application.

2. The method of claim 1, further comprising, in response to receiving the first input, displaying, via the display generation component, a selection panel comprising a plurality of display mode options, including a first display mode option corresponding to a full screen display mode.

3. The method of claim 2, wherein the display generation component includes a display screen, and wherein the first display mode is the full screen display mode where the first view of the first application occupies substantially an entire display area of the display screen.

4. The method of claim 3, wherein a respective display mode option of the plurality of display mode options that corresponds to a currently selected display mode is visually distinguished from one or more other display mode options in the plurality of display mode options.

5. The method of claim 1, wherein the display mode affordance comprises a plurality of display mode options each representing a different option for arranging views of one or more applications.

6. The method of claim 1, wherein the representation of the first application displayed while displaying the portion of the home screen comprises displaying a portion of the first view at an edge of the home screen.

7. The method of claim 1, wherein the home screen includes multiple affordances including a first affordance for invoking a first application and a second affordance for invoking a second application that is different from the first application.

8. The method of claim 1, wherein the first view of the first application occupies a majority of a display area; and the representation of the first application occupies a minority of the display area.

9. The method of claim 1, wherein the second view of the first application and the first view of the second application comprise (i) a side-by-side display of the second view of the first application and the first view of the second application, or (ii) one of the second view of the first application and the first view of the second application overlaid over the other.

10. The method of claim 1, wherein the second view of the first application is (i) a smaller view of the first application, or (ii) a view of the first application that is the same size as the first view of the first application.

11. The method of claim 1, wherein the second view of the first application and the first view of the second application occupy substantially an entire display area.

12. The method of claim 1, wherein the second input selecting an application affordance associated with the second application comprises selecting an application affordance in a dock portion of a display, and in response to detecting the second input, displaying the second view of the first application and the first view of the second application side-by-side in a split screen mode.

13. The method of claim 1, further comprising: while maintaining display of the representation of the first application, navigating through a system user interface prior to receiving a selection of the application affordance associated with the second application.

14. The method of claim 13, wherein navigating through the system user interface comprises searching for the second application in a search user interface prior to receiving a selection of the application affordance associated with the second application.

15. The method of claim 13, wherein navigating through the system user interface comprises opening a folder that includes the application affordance associated with the second application prior to receiving a selection of the application affordance associated with the second application.

16. The method of claim 1, further comprising: while maintaining display of the representation of the first application, navigating between home screen pages to display a home screen page that includes the application affordance associated with the second application prior to receiving a selection of the application affordance associated with the second application.

17. The method of claim 1, further comprising, after receiving the second input:
while concurrently displaying the second view of the first application and the first view of the second application, receiving a second sequence of one or more inputs including a third input selecting the display mode affordance; and
in response to detecting the second sequence of one or more inputs:
displaying, via the display generation component, at least a portion of the home screen that includes multiple application affordances to provide an application selection mode for selecting an application affordance associated with a third application;
receiving a fourth input to edit the home screen,
in response to receiving the fourth input, terminating the application selection mode.

18. The method of claim 17, further comprising:
concurrently displaying, via the display generation component:
the first view of the second application; and
a second display mode affordance associated with the second application; and
in response to detecting a fourth input selecting the second display mode affordance followed by a movement of the selection, ceasing to display the first view of the second application and displaying the representation of the first application.

19. The method of claim 18, wherein the movement of the selection includes moving the selection to a bottom edge of a display and/or moving the selection downward at a speed that exceeds a speed threshold.

20. The method of claim 1, further comprising:
concurrently displaying, via the display generation component:
the second view of the first application;
the first view of the second application;
a second display mode affordance associated with the first view of the second application; and
a third display mode affordance associated with the second view of the first application; and
detecting a sequence of one or more inputs including a fourth input; and
in response to detecting the sequence of one or more inputs including the fourth input that selects the second display mode affordance, ceasing to display the first view of the second application and displaying the first view of the first application, and ceasing to display the second view of the first application.

21. The method of claim 1, further comprising: concurrently displaying, via the display generation component:
the second view of the first application;
the first view of the second application; and
an affordance for repositioning the second view of the first application, an affordance for repositioning the first view of the second application, or affordances for repositioning the second view of the first application and for repositioning the first view of the second application.

22. The method of claim 1, further comprising:
concurrently displaying, via the display generation component:
a first view of a third application displayed over one or more of: the second view of the first application and the first view of the second application, and
a second display mode affordance associated with the first view of the third application;
while concurrently displaying the first view of the third application and the second display mode affordance, detecting a fifth input selecting the second display mode affordance to enter a split view mode;
in response to detecting a sequence of one or more inputs including the fifth input selecting the second display mode affordance to enter a split view mode:
providing an affordance for obtaining a disambiguation of whether to replace the second view of the first application or the first view of the second application with a second view of the third application.

23. The method of claim 1, wherein the display mode affordance includes one or more of a split-screen view affordance, a full-screen view affordance, and an overlay view affordance.

24. The method of claim 1, wherein the electronic device includes a display with a screen, and the second view of the first application and the first view of the second application together occupy substantially the entire screen.

25. An electronic device, the electronic device comprising:
a display generation component;
one or more processors; and
memory storing one or more programs for execution by the one or more processors,
the one or more programs including instructions for:
concurrently displaying, via the display generation component:
a first view of a first application in a first display mode; and
a display mode affordance;
while displaying the first view of the first application, receiving a sequence of one or more inputs including a first input selecting the display mode affordance; and
in response to detecting the sequence of one or more inputs:
ceasing to display at least a portion of the first view of the first application while maintaining display of a representation of the first application; and
displaying, via the display generation component, at least a portion of a home screen that includes multiple application affordances,
while continuing to display the representation of the first application and after displaying the portion of the home screen, receiving a second input selecting an application affordance associated with a second application; and
in response to receiving the second input, concurrently displaying, via the display generation component:
a second view of the first application and
a first view of the second application.

26. A computer readable storage medium, storing one or more programs, which, when executed by one or more processors of an electronic device with a display generation component, cause the electronic device to:
concurrently display, via the display generation component:
a first view of a first application in a first display mode; and
a display mode affordance;
while displaying the first view of the first application, receive a sequence of one or more inputs including a first input selecting the display mode affordance; and
in response to detecting the sequence of one or more inputs:
cease to display at least a portion of the first view of the first application while maintaining display of a representation of the first application; and
display, via the display generation component, at least a portion of a home screen that includes multiple application affordances,
while continuing to display the representation of the first application and after displaying the portion of the home screen, receive a second input selecting an application affordance associated with a second application; and
in response to receiving the second input, concurrently display, via the display generation component:
a second view of the first application and
a first view of the second application.
